(19) United States
(12) Patent Application Publication
(10) Pub. No.: US 2009/0306361 A1
(43) Pub. Date: Dec. 10, 2009

(54) PROCESS FOR PRODUCING CELLULOSE ESTER FILM, CELLULOSE ESTER FILM, POLARIZATION PLATE AND DISPLAY UNIT

(75) Inventors: Satomi Kawabe, Tokyo (JP); Kazuto Kiyohara, Tokyo (JP); Akihiko Takeda, Kanagawa (JP); Takayuki Suzuki, Tokyo (JP); Kazuaki Nakamura, Tokyo (JP); Takashi Konishi, Kanagawa (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA OPTO, INC., Tokyo (JP)

(21) Appl. No.: 12/096,564

(22) PCT Filed: Dec. 4, 2006
(86) PCT No.: PCT/JP2006/324175

§ 371 Date: Jun. 6, 2008

(30) Foreign Application Priority Data
Dec. 12, 2005 (JP) 2005357808

(51) Int. Cl. C08B 3/00

(52) U.S. Cl. 536/63; 536/124

(57) ABSTRACT

A process for producing a cellulose ester film that is produced by a melt casting method using no solvent at film formation, and that attains reduction of bright spot foreign matter, excelling in planarity, and that attains reduction of staining, excelling in dimensional stability. It is also intended to provide such a cellulose ester film, a polarizing plate and a liquid crystal display unit. There is provided a process for producing a cellulose ester film, characterized by forming into a film a material containing a cellulose ester and an ester compound of 1 to 7.5 distribution coefficient obtained by condensation of a polyhydric alcohol and an organic acid of the general formula: (1) according to a melt casting method.

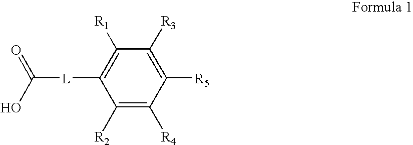

### TECHNICAL FIELD

This invention relates to a process for producing cellulose ester film, a cellulose ester film produced by the process for producing cellulose ester film, a polarization plate and a liquid crystal display unit using the cellulose ester film.

### BACKGROUND ART

Cellulose ester film have been used as the support of photographic negative film and protective film for the polarization plate to be used in liquid crystal display unit because of high transparency, low double refractive property and easily pasting ability with the polarization plate thereof.

Recently, the producing amount and the demand of the liquid crystal display are rapidly grown because of thinness of the depth and light weight thereof. Large size televisions which cannot be produced by using Brawn tube are produced by utilizing the features of the liquid crystal of thin and light. Accompanied with the production of the large size display, large sizing of the polarization element and the protective film for polarization element is required.

However, the large sized polarization element tends to be influenced by variation in the environmental condition such as temperature and humidity. Therefore, problems tend to be newly caused that the edge portion of the polarization element is degraded and black image is lighted so as to lower the contrast. It is thought that such the degradation of the polarization element is caused by shrinkage and dimension variation of the polarization element protective film and the improvement in the dimension stability of the cellulose ester film is demanded.

Hitherto, the cellulose ester film has been mainly produced by solution-casting method. The solution-casting method is a film forming method in which a solution prepared by dissolving cellulose ester in a solvent is cast into a film state and dried by evaporating the solvent to obtain film.

In such the film forming method, the film is shrunken on the occasion of drying the solvent. Therefore, it is necessary for holding flatness of the film to apply tension on the occasion of the drying. As a result of that, internal stress is leaved a little in the film and causes shrinkage during long period.

Moreover, it is a problem that large amount of solvent is necessary for the solution-casting method so that the environmental load is made higher. The cellulose ester film is produced by using a halogenized type solvent for dissolving the cellulose ester which causes high environmental load. Accordingly, reduction on the using amount of the solvent is required so that the production amount of the cellulose ester film by the solution-casting method is difficultly increased.

Recently, production of the cellulose ester film by melt-casting method is tried for silver halide photographic material, cf. Patent Publication 1, or polarization element protection film, cf. Patent Publication 2. However, the cellulose ester is a polymer having very high viscosity in melted state and the leveling of the melted cellulose ester extruded through a die onto a cooling belt or a cooling drum is difficultly carried out and the melted cellulose ester is solidified in short duration. As a result of that, the obtained film has a problem that the flatness and the luminescent spot foreign material are not good.

It is known that addition of a plasticizer is effective for lowering the viscosity in the melted state and the glass transition temperature of organic polymer such as the cellulose ester.

A phosphate type plasticizer such as triphenyl phosphate and phenylene-bis-diphenyl phosphate is used in Patent Publications 1 and 2.

As a result of investigation by the inventors, it is found that such the phosphate type plasticizer has a problem that the phosphate is decomposed by moisture or heat to form phosphoric acid and the phosphoric acid causes degradation and coloration of the film. Furthermore, the cellulose ester is degraded and colored by heat on the occasion of the melting. Accordingly, it is desirable that the melting condition is controlled, such as to lower the melting temperature, so as to inhibit the degradation of the cellulose ester as lower as possible. However, it is found that the compatibility of the cellulose ester and the plasticizer is lowered under such the condition and the flatness of the film is degraded.

Patent Publication 1: JP A H6-501040

Patent Publication 2: JP A 2000-352620

### DISCLOSURE OF THE INVENTION

### Problems to be Solved by the Invention

This invention is attained on the above described base and an object of the invention is to provide a process for producing cellulose ester film which is produced by a melt-casting method and reduced in the number of lighting foreign material, excellent in the flatness, reduced in the coloration and excellent in the dimensional stability, cellulose ester film, a polarization plate and a liquid crystal display.

### Means for Solving the Problems

The above object of the invention can be obtained by the following constitution.

1. A process for producing cellulose ester film wherein a film forming material containing a cellulose ester and an ester compound formed by condensation of an organic acid represented by the following Formula 1 and a polyhydric alcohol and having a distribution coefficient of from 1 to 7.5 is melted and cast into a state of film.

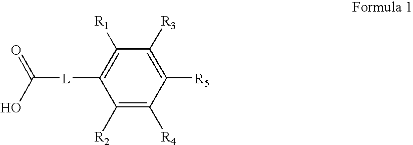

In the above formula, R₁ to R₅ are each a hydrogen atom, an alkyl group, a cycloalkyl group, an aryl group, an aralkyl group, an alkoxy group, a cycloalkoxy group, an aryloxy group, an aralkyloxy group, an acyl group, a carbonyloxy group, an oxycarbonyl group or an oxycarbonyloxy group; they may further have a substituent. L is a bonding group of an unsubstituted or unsubstituted alkylene group, an oxygen atom or a direct bond.

2. The process for producing cellulose ester film described in the above 1, wherein the bonding group L of the organic acid represented by Formula 1 is the direct bond.

3. The process for producing cellulose ester film described in the above 1 or 2, wherein the polyhydric alcohol has 2 to 4 hydroxyl groups.

4. The process for producing cellulose ester film described in any one of the above 1 to 3, wherein the molecular weight of the ester compound formed by condensation of the organic acid represented by Formula 1 and the polyhydric alcohol is from 300 to 1500.

5. The process for producing cellulose ester film described in any one of the above 1 to 4, wherein at least one of R₁, R₂ and R₅ of the organic acid represented by Formula 1 is an alkoxy group, an acyl group, an oxycarbonyl group, a carbonyloxy group or an oxycarbonyl group.

6. The process for producing cellulose ester film described in any one of the above 1 to 5, wherein the film forming material contains at least one kind of polyester selected from aliphatic polyester and aliphatic-aromatic copolyester.

7. The process for producing cellulose ester film described in the above 5, wherein the aliphatic polyester has at least one repeating unit selected from the following Repeating Unit (a) and Repeating Unit (b).

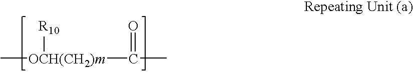

In the above formula, m is an integer of from 0 to 10, R₁₀ is a hydrogen atom, an unsubstituted alkyl group having 1 to 12 carbon atoms, an alkyl group having 1 to 12 carbon atoms substituted by at least one substituent selected from an aryl group having 6 to 10 carbon atoms and an alkoxy group having 1 to 4 carbon atoms, an unsubstituted cycloalkyl group having 5 to 10 carbon atoms, and a cycloalkyl group having 5 to 10 carbon atoms substituted by at least one substituent selected from an aryl group having 6 to 10 carbon atoms and an alkoxy group having 1 to 4 carbon atoms.

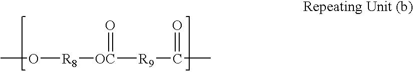

In the above formula, R₈ is a group selected from the group consisting of an unsubstituted alkylene group having 2 to 12 carbon atoms, an alkylene group having 2 to 12 carbon atoms substituted by at least on substituent selected from an alkyl group having 1 to 4 carbon atoms and an alkoxy group having 1 to 4 carbon atoms, an unsubstituted oxyalkylene group, an oxyalkylene group substituted by at least one substituent selected from an aryl group having 6 to 10 carbon group and an alkoxy group having 1 to 4 carbon atoms, an unsubstituted cycloalkylene group having 5 to 10 carbon atoms, and a cycloalkylene group having 5 to 10 carbon atoms substituted by at least one substituent selected from an aryl group having 6 to 10 carbon atoms and an alkoxy group having 1 to 4 carbon atoms; R₉ is at least one kind of group selected from the group consisting of an unsubstituted alkylene group having 2 to 12 carbon atoms, an alkylene group having 2 to 12 carbon atoms substituted by at least one substituent selected from an aryl group having 6 to 10 carbon atoms and an alkoxy group having 1 to 4 carbon atoms, an unsubstituted oxyalkylene group having 2 to 12 carbon atoms, an oxyalkylene group having 2 to 12 carbon atoms substituted by at least one substituent selected from an aryl group having 6 to 10 carbon atoms and an alkoxy group having 1 to 4 carbon atoms, an unsubstituted cycloalkylene group having 5 to 10 carbon atoms, and an cycloalkylene group having 5 to 10 carbon atoms substituted by at least one substituent selected from an aryl group having 6 to 10 carbon atoms and an alkoxy group having 1 to 4 carbon atoms.

8. The process for producing cellulose ester film described in any one of the above 6 or 7, wherein the aliphatic polyester is prepared from at least one kind of polyester formable substance selected from (i) a hydroxyl acid and a polyester formable derivative thereof, (ii) a dicarboxylic acid and a derivative thereof and (iii) a diol.

9. The process for producing cellulose ester film described in the above 6, wherein the aliphatic-aromatic copolyester has the following Repeating Unit (c),

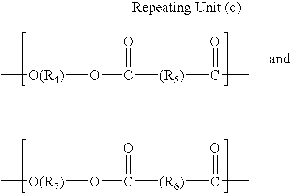

In the above formula, R₄ and R₇, are each a group selected from the group consisting of an unsubstituted alkylene group having 2 to 12 carbon atoms, an alkylene group having 2 to 12 carbon atoms substituted by at least one substituent selected from an aryl group having 6 to 10 carbon atoms, an alkyl group having 1 to 4 carbon atoms and an alkoxy group having 1 to 4 carbon atoms, an unsubstituted oxyalkylene group having 2 to 12 carbon atoms, an oxyalkylene group having 1 to 4 carbon atoms substituted by at least one substituent selected from an aryl group having 6 to 10 carbon atoms and an alkoxy group having 1 to 4 carbon atoms, an unsubstituted cycloalkylene group having 5 to 10 carbon atoms, and an cycloalkylene group having 5 to 10 carbon atoms substituted by at least one substituent selected from an aryl group having 6 to 10 carbon atoms and an alkoxy group having 1 to 4 carbon atoms; R₅ is a group selected from the group consisting of an unsubstituted alkylene group having 1 to 12 carbon atoms, an alkylene group having 1 to 12 carbon atoms substituted by at least one substituent selected from an aryl group having 6 to 10 carbon atoms, an alkyl group having 1 to 4 carbon atoms and an alkoxy group having 1 to 4 carbon atoms, an unsubstituted oxyalkylene group having 2 to 12 carbon atoms, an oxyalkylene group having 2 to 12 carbon atoms substituted by at least one substituent selected from an aryl group having 6 to 10 carbon atoms and an alkoxy group having 1 to 4 carbon atoms, an unsubstituted cycloalkylene group having 5 to 10 carbon atoms, and an cycloalkylene group having 5 to 10 carbon atoms substituted by at least one substituent selected from an aryl group having 6 to 10 carbon atoms and an alkoxy group having 1 to 4 carbon atoms; and R₆ is an unsubstituted arylene group having 6 to 10 carbon atoms or an arylene group having 6 to 10 carbon atoms substituted by at least one substituent selected from an alkyl group having 1 to 4 carbon atoms and an alkoxy group having 1 to 4 carbon atoms.

10. The process for producing cellulose ester film described in the above 6 or 9, wherein the aliphatic-aromatic copolyester is produced from at least one polyester formable compound selected from (i) dicarboxylic acid and its derivative and (ii) a diol.

11. The process for producing cellulose ester film described in any one of the above 1 or 10, wherein the film forming material contains at least one kind of antioxidant.

12. The process for producing cellulose ester film described in the above 11, wherein at least one kind of hindered phenol type antioxidant or at least one kind of phosphor type antioxidant is contained.

13. The process for producing cellulose ester film described in the above 12, wherein the phosphor type antioxidant is phosphonite type.

14. The process for producing cellulose ester film described in the above 11, wherein at least one kind of anti-thermal processing stabilizer.

15, The process for producing cellulose ester film described in the above 14, wherein the anti-thermal processing stabilizer is a compound represented by Formula E or F.

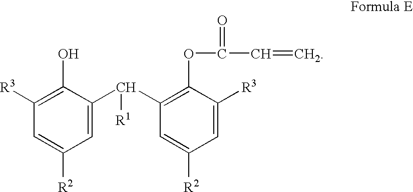

In the above formula, R¹ is an alkyl group having 1 to 100 carbon atoms and R² and R³ are each independently an alkyl group having 1 to 8 carbon atoms.

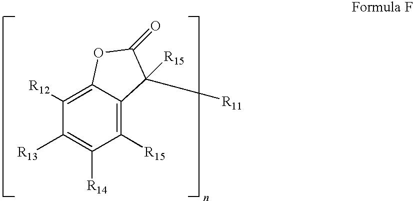

In the above formula, R₁₂ to R₁₅ are each independently a hydrogen atom or a substituent, R₁₆ is a hydrogen atom or a substituent and n is an integer of 1 or 2. R₁₁ is a substituent when n is 1, and R₁₁ is a di-valent bonding group when n is 2.

16. The process for producing cellulose ester film described in the above 11, wherein at least one kind of the hindered phenol type antioxidant, at least one kind of the phosphor type antioxidant and at least one kind of the anti-thermal processing stabilizer are contained.

17. The process for producing cellulose ester film described in the above 11, wherein the anti-thermal processing stabilizer is an antioxidant having a hindered phenol moiety and a hindered amine moiety.

18. The process for producing cellulose ester film described in the above 11, wherein the compound having the phenol moiety and the hindered amine moiety is a hydroxybenzylmalonate derivative represented by the following Formula I or its acid additional salt.

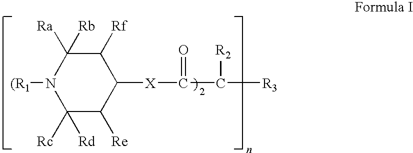

In the above formula, n is an integer of 1 or 2, Ra, Rb and Rd are each an alkyl group having 1 to 6 carbon atoms, Rc is an alkyl group having 1 to 9 carbon atoms, Re is a hydrogen atom or an alkyl group having 1 to 5 carbon atoms and Rf is a hydrogen atom or an alkyl group having 1 to 5 carbon atoms. Provided that Re and Rf are exchangeable each other. X is an —O— or an —NR— group in which R is a hydrogen atom or an alkyl group and R₁ is a hydrogen atom, an —O— atom, an alkyl group having 1 to 12 carbon atoms, an alkenyl group having 3 or 4 carbon atoms or an A-CO— group in which A is an alkyl group having 1 to 12 carbon atoms.

R₂ is a hydroxybenzyl group represented by the following Formula II.

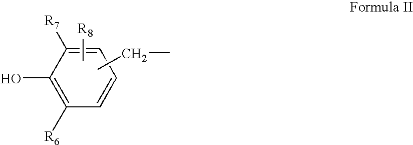

In the above formula, R₆ and R₇ are each an alkyl group having 1 to 9 carbon atoms and R₈ is a hydrogen atom or a methyl group.

When n is 1, R₃ is an unsubstituted alkyl group having 1 to 20 carbon atoms, a —COOR₁₂ group, an —OCOR₁₃ or a —P(O)(OR₁₄)₂ group, in which R₁₂ is an alkyl group having 1 to 18 carbon atoms or an alkyl group having 1 to 10 carbon atoms substituted by a group represented by the following Formula III, R₃ is an alkenyl group having 3 to 18 carbon atoms, an aralkyl group having 7 to 19 carbon atoms or a phenyl group, R₁₃ is a phenyl group which may be substituted by an unsubstituted alkyl group having 1 to 4 carbon atoms or a hydroxyl group and R₁₄ is an alkyl group having 1 to 8 carbon atoms.

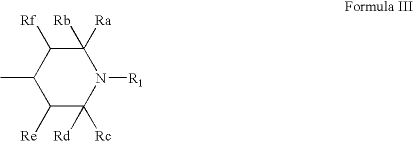

In the above formula, R₁, Ra, Rb, Rc, Rd, Re and Rf are each the same as those in Formula I, respectively.

R₃ is an —OCOR₁₆ group, in which R₁₅ is a phenyl group which may be substituted by an alkyl group having 1 to 12 carbon atoms, two alkyl groups each having 1 to 4 carbon atoms or a hydroxyl group, or an —NHCOR₁₆—, in which R₄ is an alkyl group having 1 to 12 carbon atoms, and R₃ is a bonding hand or an alkylene group having 1 to 20 carbon atoms when n is 2.

19. A cellulose ester film which is produced by the process for producing cellulose ester film described in any one of the above 1 to 18.

20. A polarization plate having the cellulose ester film described in the above 19.

21. A liquid crystal display using a polarization plate described in the above 20.

### EFFECTS OF THE INVENTION

The process for producing cellulose ester film, the cellulose ester film, the polarization plate and the liquid crystal display of the invention are produced by the melt-casting method without use of any solvent on the occasion of the film formation, which are reduced in the luminescent spot foreign material, excellent in the flatness, reduced in the coloration and excellent dimension stability.

### BRIEF DESCRIPTION OF THE DRAWINGS

FIG. 1 is a schematic flow-sheet showing on embodiment of equipment for carrying out the process for producing cellulose ester film of the invention.

FIG. 2 shows an enlarged flow-sheet of the main portion of the equipment in FIG. 1.

FIG. 3(a) shows the external appearance of main portion of the casting die, and FIG. 3(b) shows a cross section of the main portion of the die.

FIG. 4 shows a cross section of first embodiment of nipping and pressing rotator.

FIG. 5 shows across section of second embodiment of nipping and pressing rotator at a plane perpendicular to the rotating axis.

FIG. 6 shows across section of second embodiment of nipping and pressing rotator at a plane including the rotating axis.

### THE BEST MODE FOR CARRYING OUT THE INVENTION

The Best mode for carrying out the invention is described in detail below but the invention is not limited to the description.

The invention is attained for obtaining the method for forming cellulose ester film by the thermally melt-casting method. As a result of the investigation by the inventors, it is found that the bright spot caused by foreign matter and the coloration can be improved by a cellulose ester film produced by melt-casting a film forming material containing an ester compound which is prepared by condensation of an organic acid represented by Formula 1 and a polyhydric alcohol and has a distribution coefficient of from 1 to 7.5 and cellulose ester. Moreover, it is surprisingly found that cellulose ester film excellent in the flatness and dimensional stability can be obtained by the combination of the above film forming material and the melt-casting method, and the invention can be accomplished. The ester compound which is represented by condensation of the organic acid represented Formula 1 and the polyhydric alcohol and has a distribution coefficient of from 1 to 7.5 is used as a plasticizer in the cellulose ester film of the invention.

### <Ester Compound Formed by Condensation of the Organic Acid and the Polyhydric Alcohol>

In the foregoing Formula 1, R₁ to R₅ are each a hydrogen atom, a cycloalkyl group, an aralkyl group, an alkoxy group, a cycloalkoxy group, an aryloxy group, an aralkyloxy group, an acyl group, a carbonyloxy group, an oxycarbonyl group or an oxycarbonyloxy group. L is a bonding group such as an unsubstituted or unsubstituted alkylene group, an oxygen atom or a direct bond.

As the cycloalkyl groups each represented by R₁ to R₅ are any preferably a cycloalkyl group having 3 to 8 carbon atoms. These groups may have a substituent. As the substituent, a halogen atom such as a chlorine atom, a bromine atom and a fluorine atom, a hydroxyl group, an alkyl group, an alkoxy group, a cycloalkoxy group, an aralkyl group (the phenyl group of which may have a substituent such as an alkyl group or a halide atom), an alkenyl group such as a vinyl group and an allyl group, a phenyl group which may have a substituent such as an alkyl group or a halide atom, an phenoxy group (the phenyl group of which may have a substituent such as an alkyl group or a halide atom), an acyl group having 2 to 8 carbon atoms such as an acetyl group and a propionyl group and a carbonyloxy group having 2 to 8 carbon group such as an acetyloxy group and a propionyloxy group are preferable.

The aralkyl group represented by R₁ to R₅ includes a benzyl group, a phenetyl group and a γ-phenylpropyl group, they may have a substituent. As the substituent, the groups the same as the groups cited as the substituent of the foregoing cycloalkyl group can be cited.

As the alkoxy group represented by R₁ to R₅, an alkoxy group having 1 to 8 carbon atoms, concretely a methoxy group, an ethoxy group, an n-propoxy group, an n-butoxy group, an n-octyloxy group, an isopropoxy group, an isobutoxy group, a 2-ethylhexyl group and a t-butoxy group, is cited. The above groups each may have a substituent. As the preferable substituent, a halogen atom such as a chlorine atom, a bromine atom and a fluorine atom, a hydroxyl group, an alkoxy group, a cycloalkoxy group, an aralkyl group (the phenyl group of which may have a substituent such as an alkyl group or a halide atom), an alkenyl group, a phenyl group which may has a substituent such as an alkyl group or a halide atom, an aryloxy group such as phenoxy group (the phenyl group of which may have a substituent such as an alkyl group or a halide atom), an acyl group such as an acetyl group and a propionyl group, an unsubstituted acyloxy group having 2 to 8 such as an acetyloxy group and a propionyloxy group and an arylcarbonyloxy group such as an acyloxy group and a benzoyloxy group are cited.

As the cycloalkoxy group represented by R₁ to R₅, an unsubstituted cycloalkoxy group having 1 to 8 carbon atoms such as a cyclopropyloxy group, a cyclopentyloxy group and a cyclohexyloxy group are cited. These groups may have a substituent. As the preferable substituent, the groups substitutable to the foregoing cycloalkyl group can be cited.

As the aryloxy group represented by R₁ to R₅, a phenoxy group can be cited and the phenyl group of which may be substituted by the group substitutable the foregoing cycloalkyl group such as a halogen atom.

As the aralkyloxy group represented by R₁ to R₅, a benzoyloxy group and a phenethyloxy group are cited. These groups may have a substituent. As the preferable substituent, the groups substitutable to the foregoing cycloalkyl group can be cited.

As the acyl group represented by R₁ to R₅, an unsubstituted acyl group having 2 to 8 carbon atoms (as the hydrocarbon group of the acyl group includes an alkyl group, an alkenyl group and an alkynyl group). These groups may have a substituent. As the preferable substituent, the groups substitutable to the foregoing cycloalkyl group can be cited.

As the carbonyloxy group represented by R₁ to R₅, an unsubstituted acyloxy group having 2 to 8 carbon atoms (as the hydrocarbon group of the acyl group includes an alkyl group, an alkenyl group and an alkynyl group) such as an acetyloxy group and a propionyloxy group and an arylcarbonyloxy group such as a benzoyloxy group are cited. These groups may be substituted by the groups substitutable to the foregoing cycloalkyl group.

As the oxycarbonyl group represented by R₁ to R₅, an alkoxycarbonyl group such as a methoxycarbonyl group, an ethoxycarbonyl group and a propyloxycarbonyl group, and an aryloxycarbonyl group such as a phenoxycarbonyl group are cited. These groups may be substituted by the groups substitutable to the foregoing cycloalkyl group.

As the oxycarbonyloxy group represented by R₁ to R₅, an oxycarbonyloxy group having 1 to 8 carbon atoms such as a methoxycarbonyloxy group is cited, this may be substituted by a substituent. As the preferable substituent, the groups the same as those substitutable to the foregoing cycloalkyl group can be cited.

The bonding group represented by L is a substituted or unsubstituted alkylene group, an oxygen atom or a direct bond. The alkylene group includes a methylene group, an ethylene group and a butylene group. These groups may be substituted by the groups cited as the groups substitutable to the groups represented by R₁ to R₅.

Among them, the particularly preferable bonding group represented by L is the direct bond and the aromatic carboxylic acid.

As the organic acid of the foregoing Formula 1 constituting the ester compound to be used as the plasticizer, ones in which R₁ to R₅ are each a hydrogen atom or ones in which at least one of R₁ to R₅ has the alkoxy group, acyl group, oxycarbonyl group, carbonyloxy group or oxycarbonyloxy group are preferable. Ones in which at least two, preferably at least three, of R₁ to R₅ have the alkoxy group, acyl group, oxycarbonyl group, carbonyloxy group or oxycarbonyloxy group are more preferable. Ones in which at least one of R₁, R₂ and R₅ is the alkoxy group, acyl group, oxycarbonyl group, carbonyloxy group or oxycarbonyloxy group are preferable.

In the invention, the organic acid substituting the hydroxyl group of the polyhydric alcohol may be single kind or plural kinds.

In the invention, as the two- or more-valent alcohol compound capable of forming the poly-valent ester compound by reacting with the organic acid represented by Formula 1 is preferably a two- to 20-valent aliphatic alcohol and the two- or more-valent alcohols represented by the following Formula 2 is preferred.

R′—(OH)ₘ Formula 2

In the above formula, R′ is an m-valent organic group, m is an integer of 2 or more and OH is an alcoholic hydroxyl group. Polyhydric alcohols in which m is from 2 to 4 are particularly preferred.

Examples of the preferable alcohol include adonitol, arabitol, 1,2,4-butanetriol, 1,2,3-hexanetriol, 1,2,6-hexanetriol, glycerol, diglycerol, erythritol, pentaerythritol, dipentaerythritol, tripentaerythritol, galactitol, glucose, cellobiose, inositol, mannitol, 3-methylpentane-1,3,5-triol, pinacol, sorbitol, trimethylolpropane, trimethylolethane and xylitol. Glycerol, trimethylolethane, trimethylolpropane and pentaerythritol are particularly preferable.

The ester of the organic acid represented by Formula 1 and the polyhydric alcohol can be synthesized by a known method. The typical synthesizing example is described in Example. For instance, a method in which the organic acid represented by Formula 1 and the polyhydric alcohol are condensed in the presence of an acid, a method in which the organic acid is previously converted into the acid chloride or acid anhydride and made react with the polyhydric alcohol and a method in which a phenyl ester of the organic acid is made react with the polyhydric alcohol are cited. The synthesizing method giving high yield can be suitably selected from the above-described according to the objective ester.

The molecular weight of thus obtained polyhydric alcohol ester is preferably from 300 to 1,500, more preferably from 400 to 1,000, though the molecular weight is not specifically limited. The higher molecular weight is preferable since one having high molecular weight is difficultly volatized.

The adding amount is preferably from 0.1 to 30, more preferably from 1 to 25, and further preferably from 5 to 20, parts by weight to the cellulose ester.

The ester compound formed by condensation of the organic acid represented by Formula 1 and the polyhydric alcohol is a compound having a distribution coefficient of from 1 to 7.5. The distribution coefficient in the invention is octanol-water distribution coefficient (log P value) which is determined by Crippen's fragmentation method (J. Chem. Inf. Comput. Sci., 27, 21 (1987)). A compound having a log P value exceeding 7.5 is inferior in the compatibility with the cellulose ester and mixing on the occasion of melting is made insufficient so that the bright spots causing foreign matter tends to be formed and white turbid and powdering of the formed film also tend to be caused. A compound having a log P value of less than 1 sometimes lowers water resistivity of the cellulose ester film since such the compound is highly hydrophilic. More preferable range of the log P value is from 4.0 to 6.5 and particularly preferable range is from 5.0 to 6.3.

The measurement of octanol-water distribution coefficient can be performed by the flask shaking method described in JIS Z 7260-107 (2000). The octanol-water distribution coefficient (log P value) can be estimated by a computational chemical method or an experimental method in stead of the actual measurement. As the computational method, Crippen's fragmentation method (J. Chem. Inf. Comput. Sci., 27, 21 (1987)), Viswanadhan's fragmentation method (J. Chem. Inf. Comput. Sci., 29, 163 (1989)) and Broto's fragmentation method (Eur. J. Med. Chem.-Chim. Theor., 19, 71 (1984) are preferably applicable, and Crippen's fragmentation method (J. Chem. Inf. Comput. Sci., 27, 21 (1987)) is more preferable. When the log P vale of one compound is varied depending on the computational method, it is preferably judged by the Crippen's fragmentation method that the compound is within the range of the invention or not.

The log P values described in this description are calculated from the structural formula of the compound according to the Crippen's fragmentation method (J. Chem. Inf. Comput. Sci., 27, 21 (1987)) using CS ChemProp of Chem Draw Ultra ver. 0.1 manufactured by CambridgeSoft Corp.

Examples of the ester compound relating to the invention are listed below but the invention is not limited to them. The values attached to each of the structural formulas are the distribution coefficient and the molecular weight.

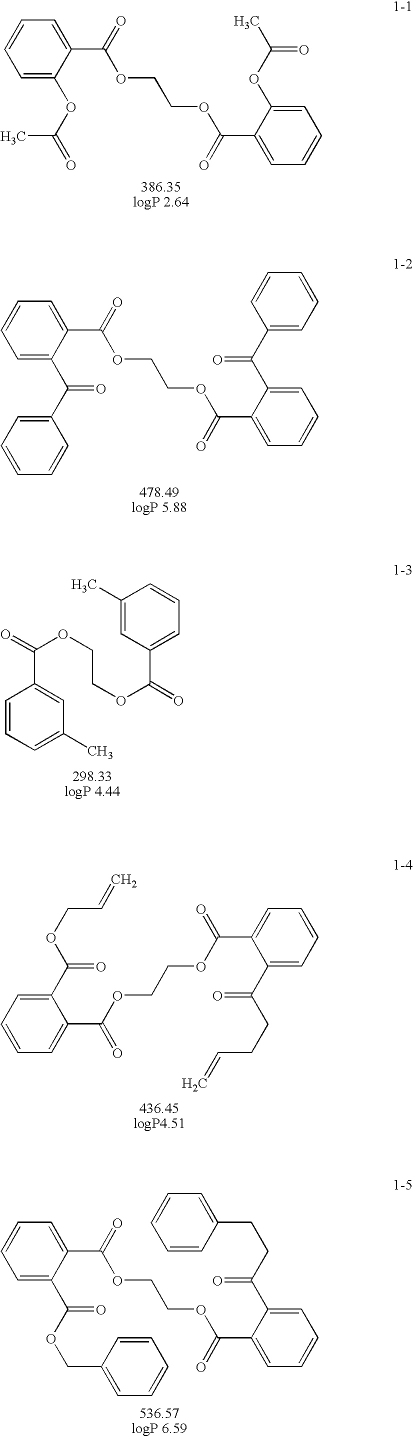

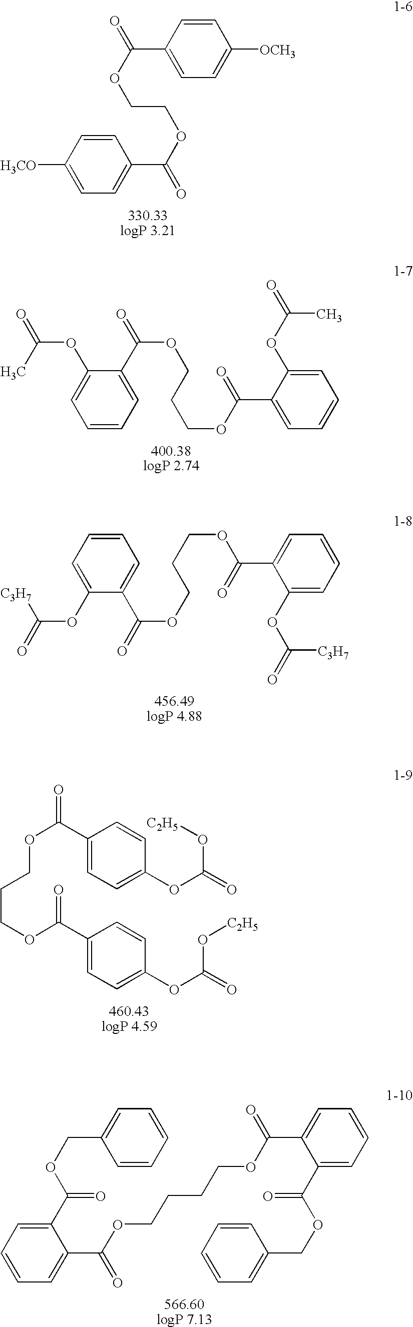

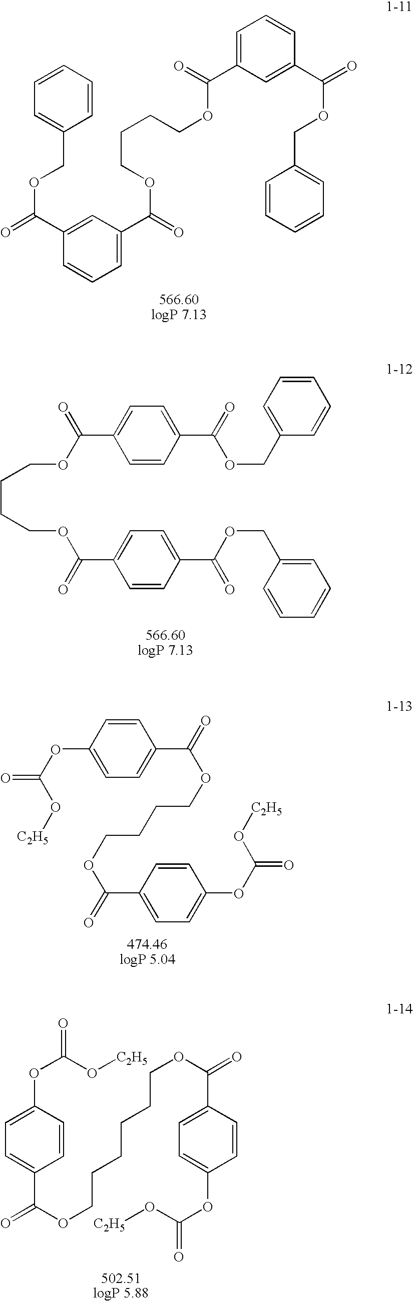

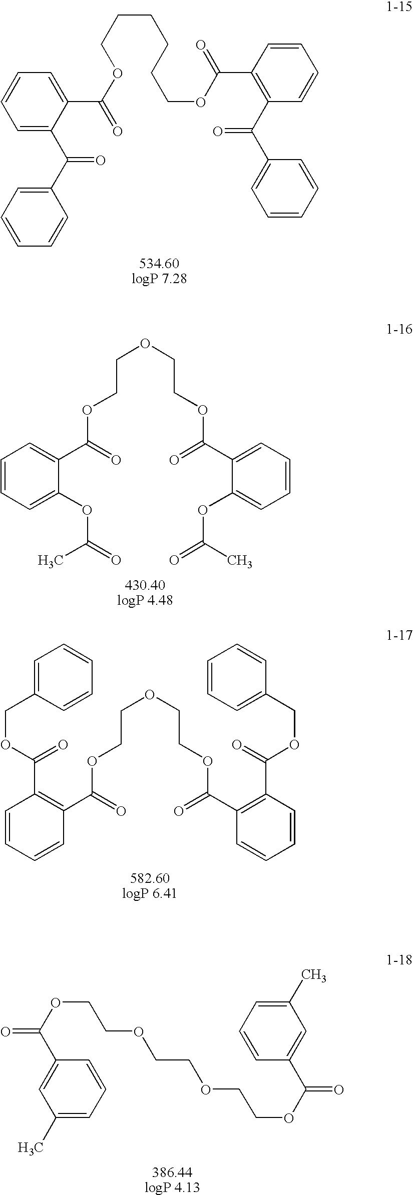

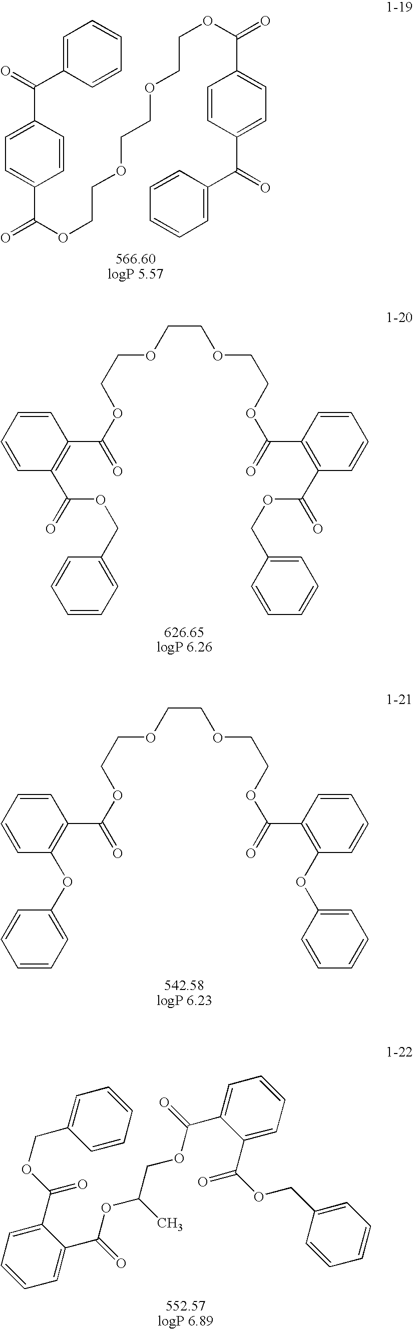

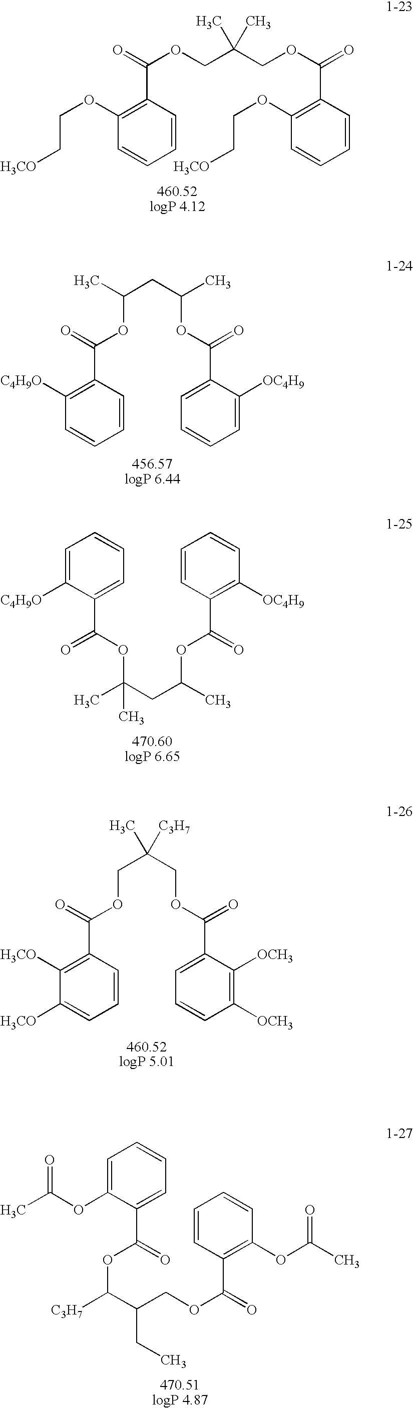

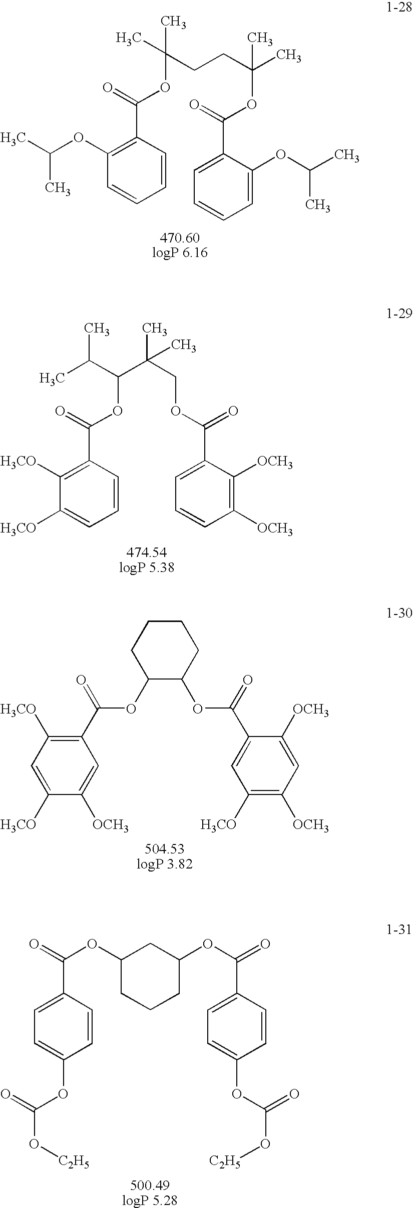

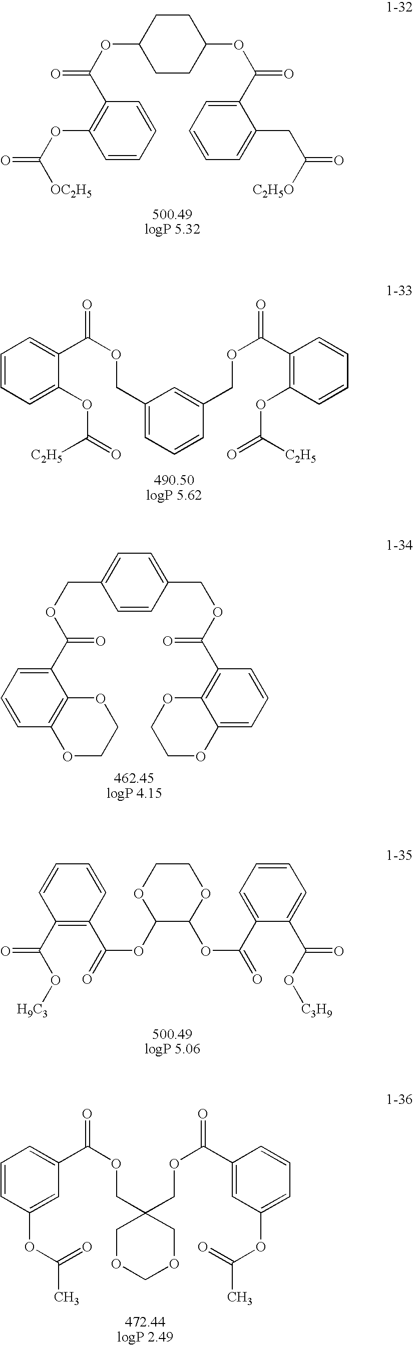

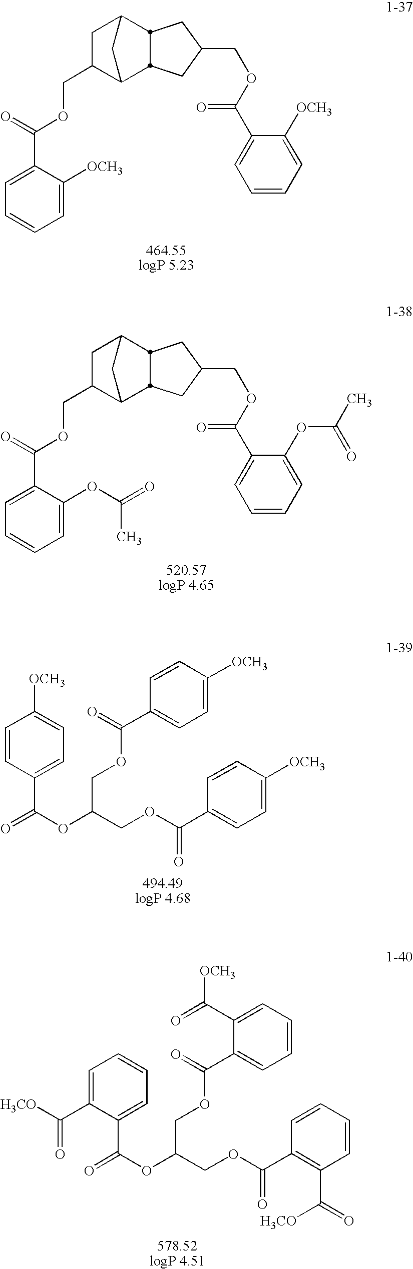

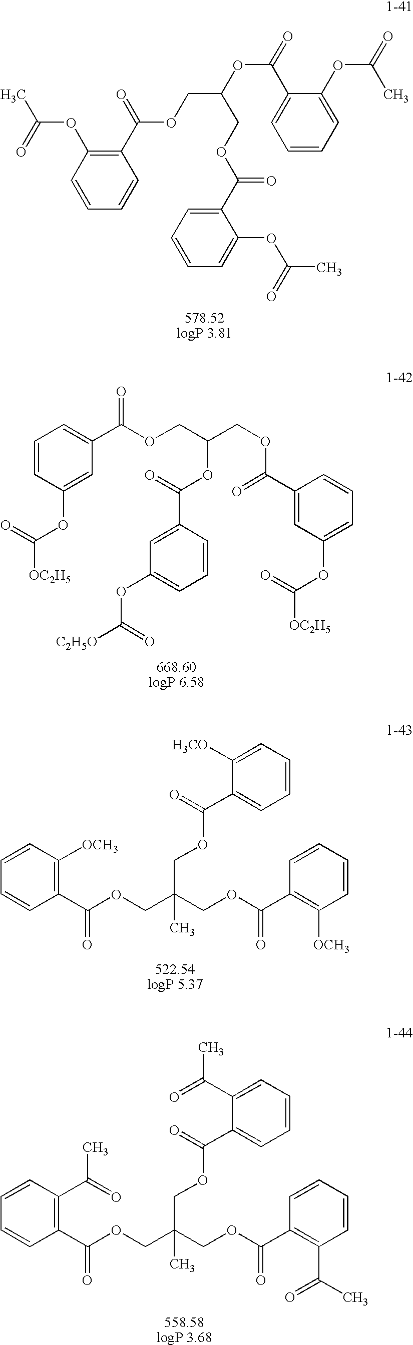

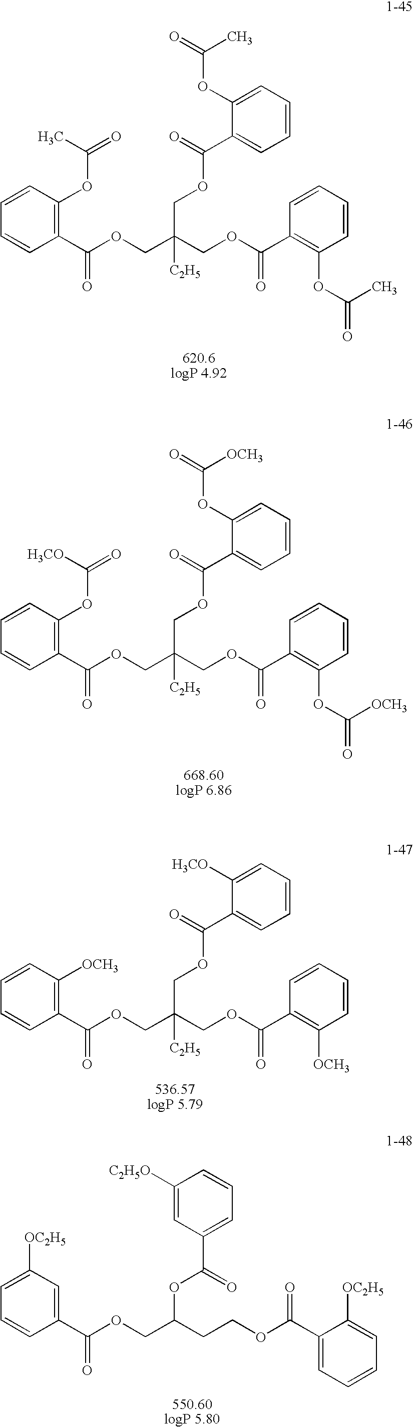

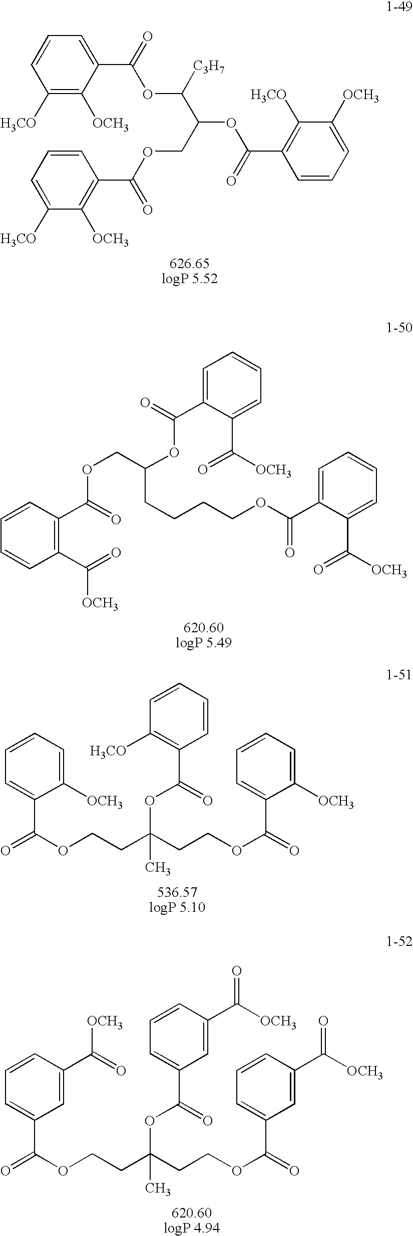

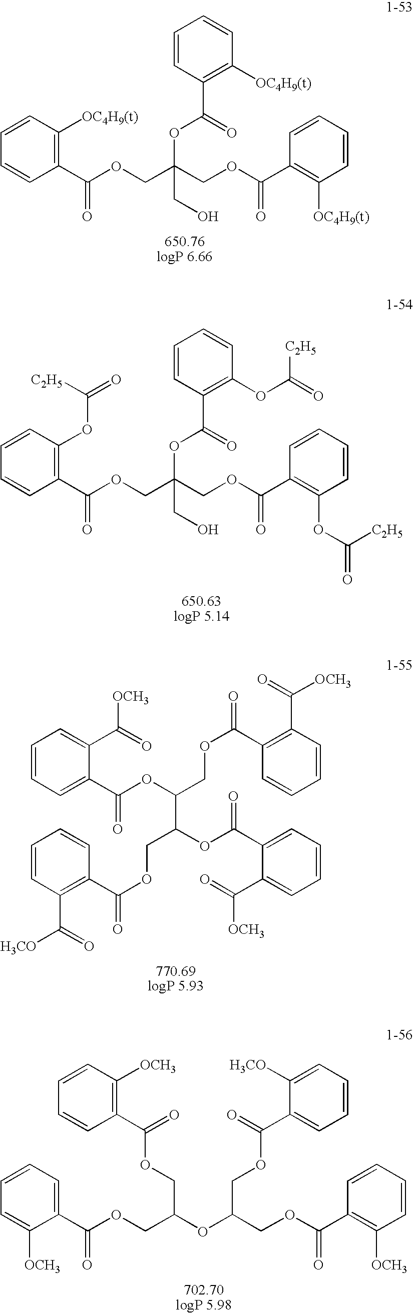

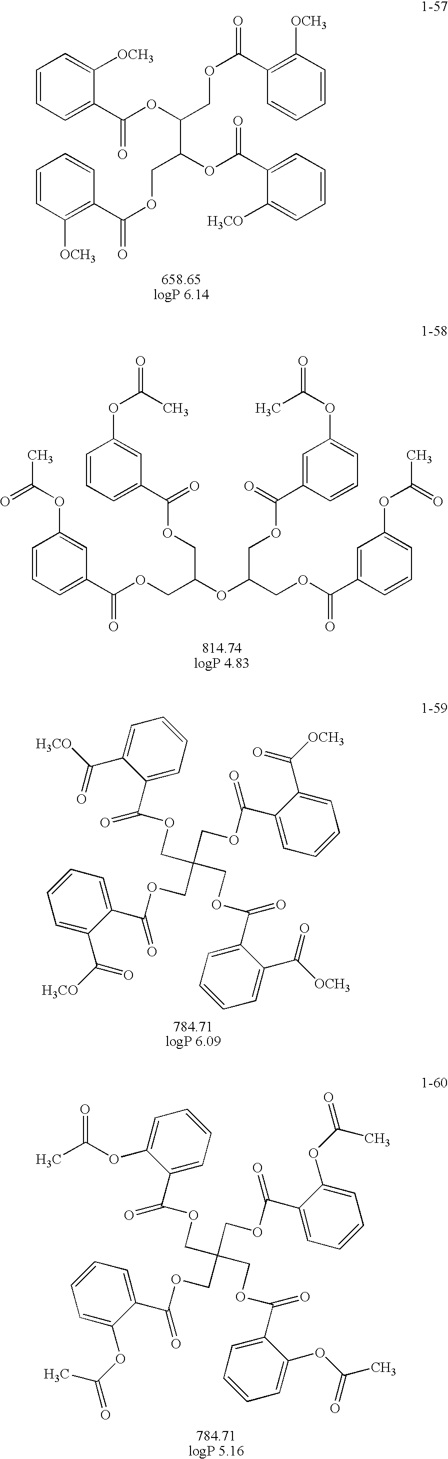

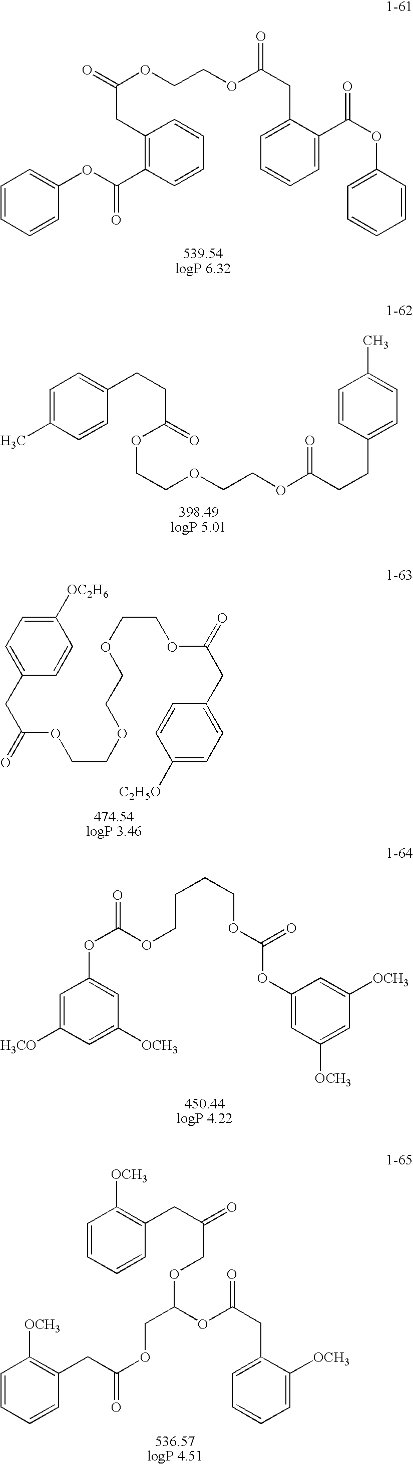

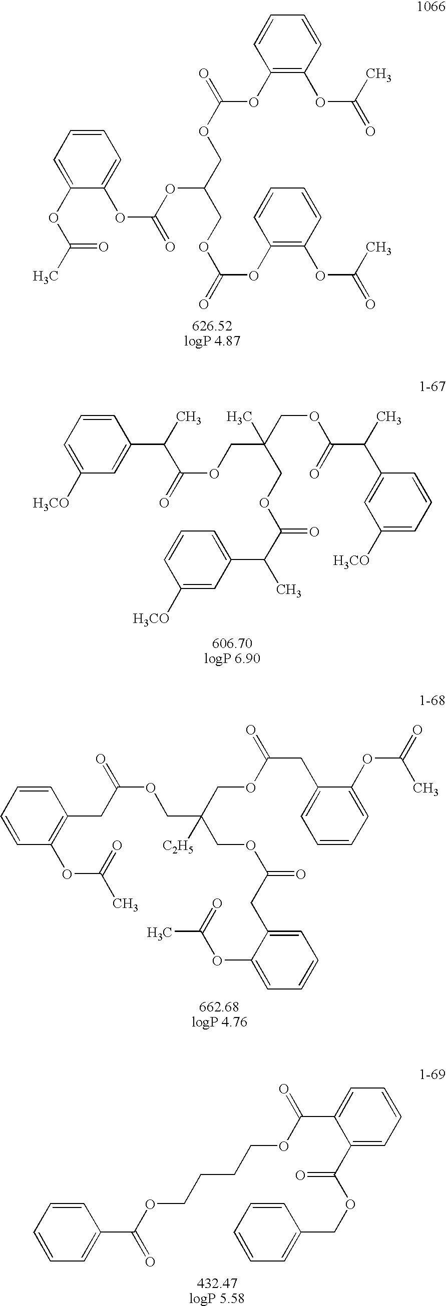

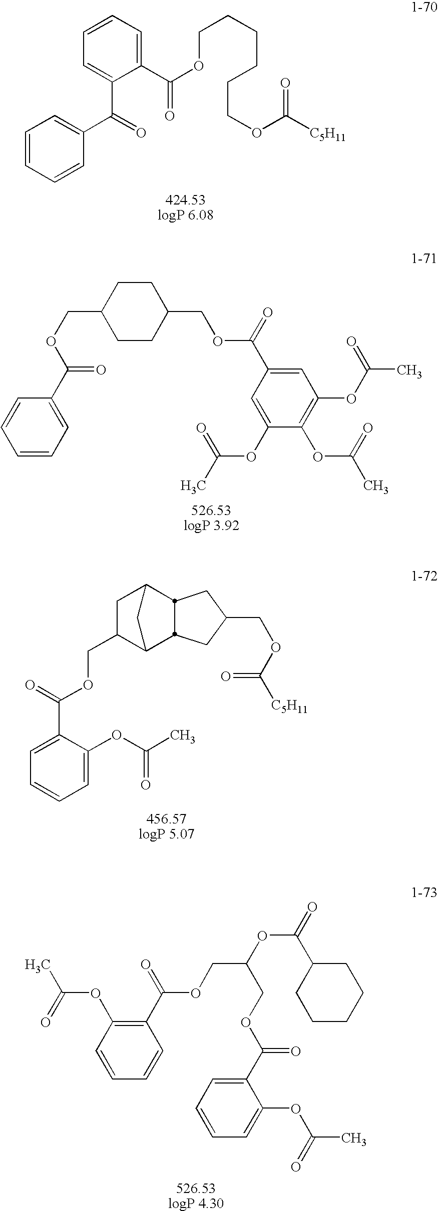

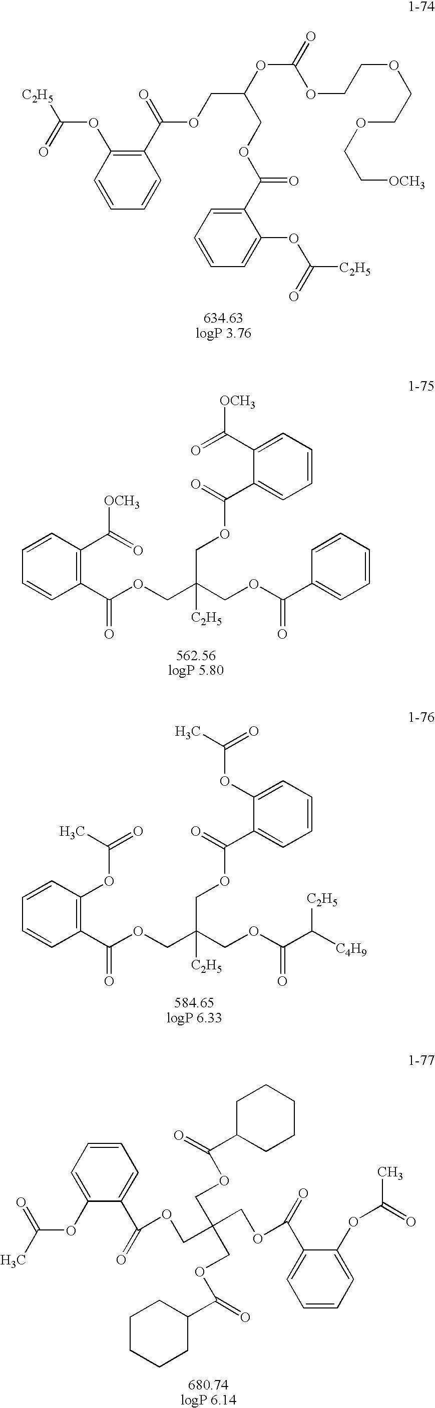

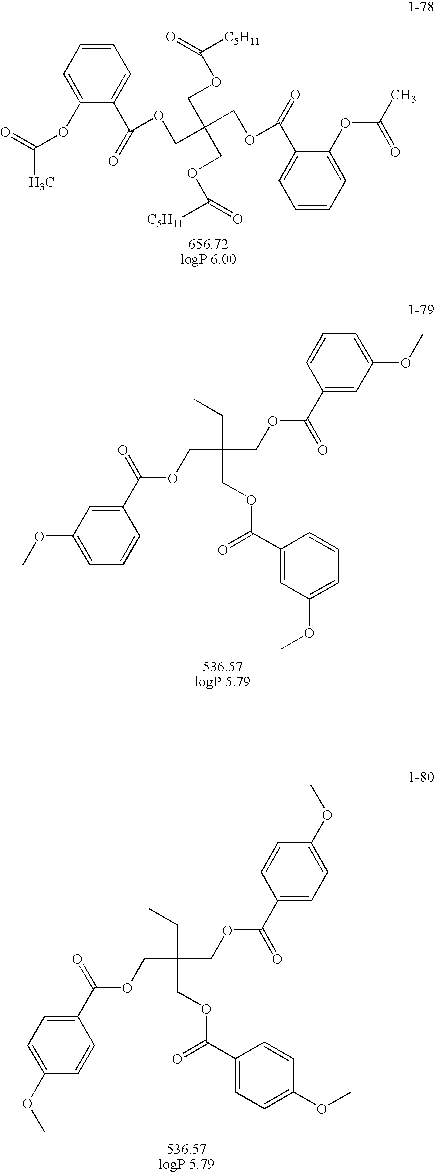

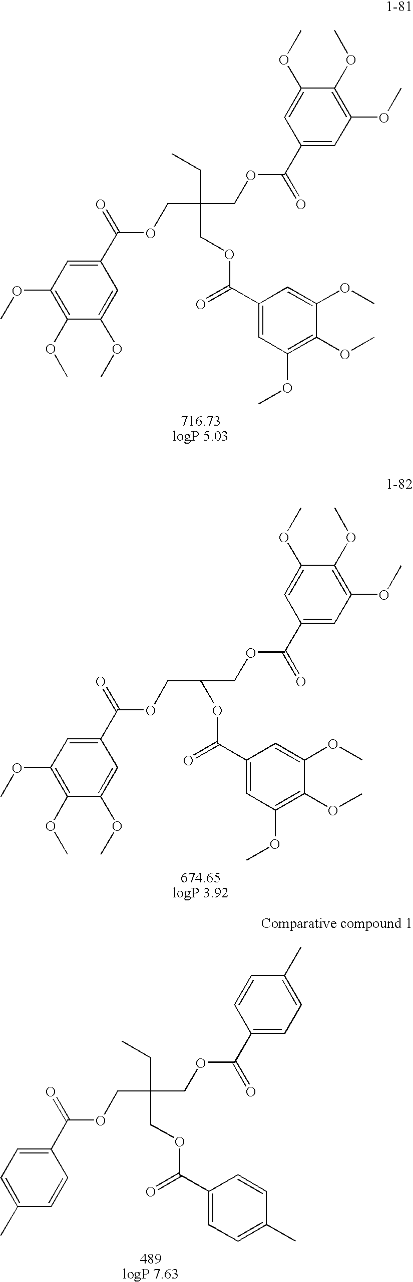

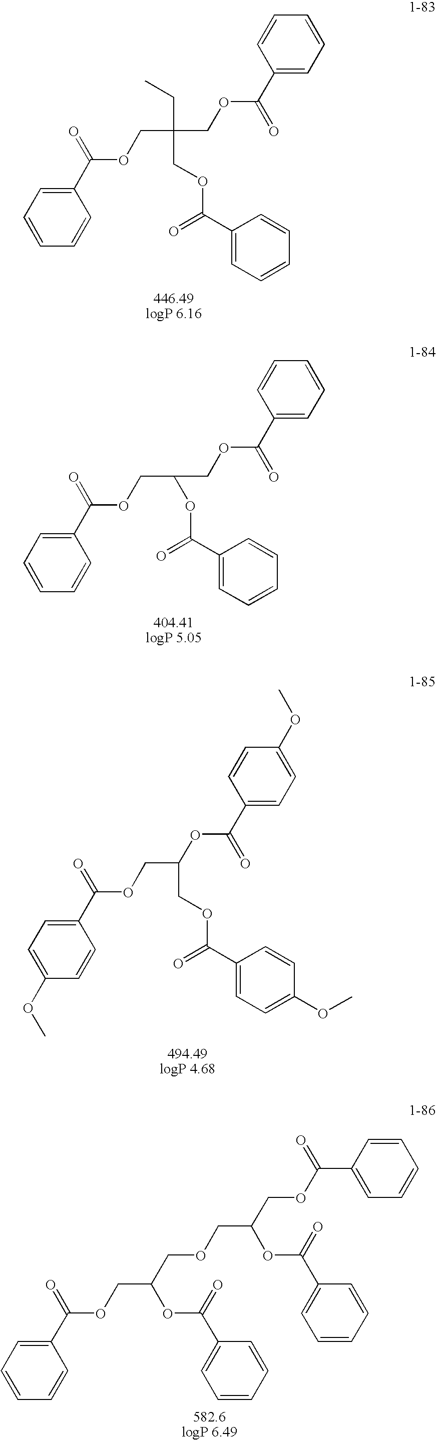

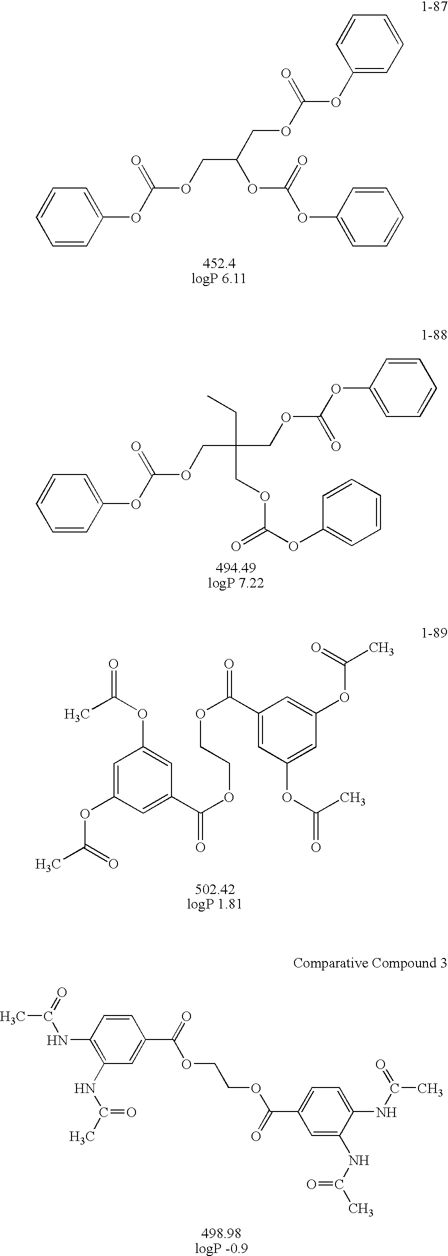

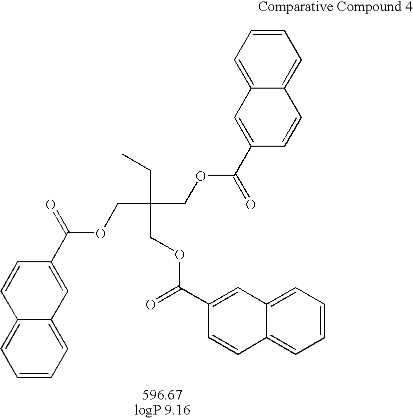

### <Aliphatic Polyester>

One type of aliphatic polyester useful in the invention contains at least one kind of repeating unit selected from the foregoing repeating units (a) and (b).

In the repeating unit (a), m is an integer of 0 to 10, R₁₀ is an alkyl group substituted by a group selected from a hydrogen atom, an unsubstituted alkyl group having 1 to 12 carbon atoms, an aryl group having 6 to 10 carbon atoms and an alkoxyl group having 1 to 4 carbon atoms, or a cycloalkyl group having 5 to 10 carbon atoms substituted by a group selected from an unsubstituted by a group selected from a cycloalkyl group having 5 to 10 carbon atoms, an aryl group having 6 to 10 carbon atoms and an alkyl group having 1 to 4 carbon atoms.

The other type of repeating unit is a polyhydroxy-alkanoate constituted by the repeating unit (b).

In the repeating unit (b), R₈ is an alkylene group substituted by a group selected from an unsubstituted alkylene group having 2 to 12 carbon atoms, an aryl group having 6 to 10 carbon atoms, an alkyl group having 1 to 4 carbon atoms and an alkoxy group having 1 to 4 carbon atoms, an oxyalkylene group substituted by a group selected from an unsubstituted oxyalkylene group having 2 to 12 carbon atoms, an aryl group having 6 to 10 carbon atoms and an alkoxy group having 1 to 4 carbon atoms, or an cycloalkylene group substituted by a group selected from an unsubstituted cycloalkylene group having 5 to 10 carbon atoms, an aryl group having 6 to 10 carbon atoms and an alkoxy group having 1 to 4 carbon atoms, R₉ is an alkylene group substituted by a group selected from an unsubstituted alkylene group having 2 to 12 carbon atoms, an aryl group having 6 to 10 carbon atoms and an alkoxy group having 1 to 4 carbon atoms, an oxyalkylene group having 2 to 12 carbon atoms substituted by a group selected from an unsubstituted oxyalkylene group having 2 to 12 carbon atoms, an aryl group having 6 to 10 carbon atoms, an alkyl group having 1 to 4 carbon atoms and an alkoxy group having 1 to 4 carbon atoms, or a cycloalkylene group substituted by a group selected from an unsubstituted cycloalkylene group having 5 to 10 carbon atoms, an aryl group having 6 to 10 carbon atoms and an alkoxy group having 1 to 4 carbon atoms.

In the invention, it is preferable that the aliphatic polyester is prepared by a polyester formable material selected from (i) a hydroxyl acid or its ester formable derivative, (ii) dicarboxylic acid or its ester formable derivative and (iii) a diol.

The hydroxyl acid is selected from the group consisting of, for example, 4-(hydroxymethyl)cyclohexanecarboxylic acid, hydroxytrimethylacetic acid, 6-hydroxycaploic acid, glycolic acid, lactic acid, ester formable derivatives thereof and combinations thereof. The dicarboxylic acid is selected from the group consisting of, for example, malonic acid, succinic acid, glutaric acid, adipic acid, pimelic acid, azelaic acid, sebacic acid, fumaric acid, 2,2-dimethylglutaric acid, suberic acid, 1,3-cyclopentanedicarboxylic acid, 1,4-cyclohexane-dicarboxylic acid, 1,3-cyclohexanedicarboxylic acid, diglycolic acid, itaconic acid, maleic acid and 2,5-norbornanedicarboxylic acid, ester formable derivatives thereof and combinations thereof.

The diol is selected from the group consisting of, for example, ethylene glycol, propyleneglycol, 1,3-propanediol, 2,2-dimethyl-1,3-propanediol, 1,3-butanediol, 1,4-butanediol, 1,5-pentanediol, 1,6-hexanediol, 2,2,4-trimethyl-1,6-hexanediol, thiodiethanol, 1,3-cyclohexanedimethanol, 1,4-cyclohexanedimethanol, 2,2,4,4-tetramethyl-1,3-cyclobutane-diol, diethylene glycol, triethylene glycol, tetraethylene glycol and combinations thereof.

Preferable concrete examples of the aliphatic polyester include polyhydroxybutylate, copolymer of polyhydroxybutylate and polyhydroxyvalerate, poly(hexamethylene glutarate), poly(hexamethylene adipate), poly(ethylene sebacate), poly(tetramethylene glutarate), poly(tetramethylene adipate), poly(tetramethylene sebacate), poly(ethylene glutarate), poly(ethylene succinate), poly(tetramethylene succinate and poly(ethylene succinate).

### <Aliphatic-Aromatic Copolyester>

The aliphatic-aromatic copolyester useful in the invention is a random copolymer and is preferably composed of the repeating unit represented by Formula (c).

In the repeating unit (c), R₄ and R₇ are each a group selected from an alkylene group substituted by a group selected from an unsubstituted alkylene group having 2 to 12 carbon atoms, an aryl group having 6 to 10 carbon atoms and an alkoxy group having 1 to 4 carbon atoms, an oxyalkylnen group having 2 to 12 carbon atoms substituted by a group selected from an unsubstituted oxyalkylene group having 2 to 12 carbon atoms, an aryl group having 6 to 10 carbon atoms and an alkoxy group having 1 to 4 carbon atoms or an cycloalkylene group having 5 to 10 carbon atoms substituted by a group selected from an unsubstituted cycloalkylene group having 5 to 10 carbon atoms, an aryl group having 6 to 10 carbon atoms and an alkoxy group having 1 to 4 carbon atoms, R₅ is a an alkylene group having 2 to 12 carbon atoms substituted by a group selected from an unsubstituted alkylene group having 1 to 12 carbon atoms, a aryl group having 6 to 10 carbon atoms, an alkyl group having 1 to 4 carbon atoms and an alkoxy group having 1 to 4 carbon atoms, an oxyalkylene group having 2 to 12 carbon atoms substituted by a group selected from an unsubstituted oxyalkylene group having 2 to 12 carbon atoms, an aryl group having 6 to 10 carbon atoms and an alkoxy group having 1 to 4 carbon atoms or a cycloalkylene group having 6 to 10 carbon atoms substituted by a group selected from an unsubstituted cycloalkylene group having 6 to 10 carbon atoms, an aryl group having 6 to 10 carbon atoms and an alkoxy group having 1 to 4 carbon atoms, and R₆ is an arylene group having 6 to carbon atoms substituted by a group selected from an unsubstituted arylene group having 6 to 10 carbon atoms, an alkyl group having 1 to 4 carbon atoms and an alkoxy group having 1 to 4 carbon atoms.

The aliphatic-aromatic copolyester represented by Formula 4 is prepared by an arbitrary combination of a dicarboxylic acid or its ester formable derivative and a diol.

The above dicarboxylic acid is selected from the group consisting of, for example, a pyro-acid such as malonic acid, succinic acid, glutaric acid, adipic acid, pimelic acid, azelaic acid, sebacic acid, fumaric acid, 2,2-dimethylglutaric acid, suberic acid, 1,3-cyclopentanedicarboxylic acid, 1,4-cyclohexane dicarboxylic acid, 1,3-cyclohexane-dicarboxylic acid, diglycolic acid, itaconic acid, maleic acid, 2,5-norbornanedicarboxylic acid, 1,4-terephthalic acid, 1,3-terephthalic acid, phthalic acid, 2,6-naphthoic acid, 1,5-naphthoic acid and ester formable derivatives thereof and combinations of them. The above diol is selected from the group consisting of, for example, ethylene glycol, diethylene glycol, propylene glycol, 1,3-propanediol, 2,2-dimethyl-1,3-propanediol, 1,3-butanediol, 1,4-butanediol, 1,5-pentanediol, 1,6-hexandiol, 2,2,4-trimethyl-1,6-hexanediol, thiodiethanol, 1,3-cyclohexanedimethanol, 1,4-cyclohexanedimethanol, 2,2,4,4-tetramethyl-1,3-cyclobutanediol, triethylene glycol, tetraethylene glycol and combination thereof.

Preferable compounds are ones produced from the following diols and dicarboxylic acid or its ester formable derivative in the following mole ratio:

(1) Glutaric acid (30 to 65%); diglycolic acid (0 to 10 mole-%); terephthalic acid (25 to 60%); 4-butanediol (100 mole-%)

(2) Succinic acid (30 to 85%); diglycolic acid (0 to 10%); terephthalic acid (5 to 60%): 1,4-butanediol (100 Mole-%)

(3) Adipic acid (30 to 65%); diglycolic acid (0 to 10%); terephthalic acid (25 to 60%); 1,4-butanediol (100 mole-%)

(4) Succinic acid (30 to 95%); terephthalic acid (5 to 60%); ethylene glycol (70 to 100%); diethylene glycol (0 to 30%)

(5) Succinic acid (30 to 100%); diglycolic acid (0 to 70%); ethylene glycol (30 to 100%); 1,4-butanediol (0 to 70%)

The aliphatic polyester and the aliphatic-aromatic copolyester containing the diol having an average carbon number of from 2 to 3.5 and the dicarboxylic acid having an average carbon number of from 4 to 5.5 are preferred.

In the invention, the adding amount of the polyester compound of the invention is from 0.1 to 30, preferably from 1 to 25, and more preferably from 5 to 20, parts by weight to the cellulose ester.

The ester compound formed from the organic acid represented by Formula 1 and the polyol as the plasticizer of the invention has a feature that the compatibility with the cellulose ester is high and the adding amount can be increased. Therefore, bleed out is not caused even when the compound is used together with another plasticizer and additive and another kind of plasticizer and additive can be easily used with together.

As the other kind of plasticizer, an aliphatic carboxylic acid-polyol type plasticizer; an unsubstituted aromatic carboxylic acid- or cycloalkyl-polyol type plasticizer such as those described in JP A 2003-12823, paragraphs 30 to 33; poly-valent carboxylate type plasticizers including dioctyl adipate, dicyclohexyl adipate, diphenyl succinate, di2-naphthyl 1,4-cyclohexanedicarboxylate, tricyclohexyl tricarbarate, tetra-3-methylphenyltetrahydrofuran-2,3,4,5-tetracarboxylate, tetrabutyl-1,2,3,4-cyclopentane-tetracarboxylate, triphenyl-1,3,5-cyclohexyltricarboxylate, triphenylbenzene-1,3,5-tetracarboxylate, a phthalic acid type plasticizer such as diethyl phthalate, dimethoxyethyl phthalate, dimethyl phthalate, dioctyl phthalate, dibutyl phthalate, di-2-ethylhexyl phthalate, dioctyl phthalate, dicyclohexyl phthalate, dicyclohexyl terephthalate, methylphthalylmethyl glycolate, ethylphthalylethyl glycolate, propylphthalylpropyl glycolate and butylphthalybutyl glycolate, and a citric acid type plasticizer such as acetyltrimethyl citrate acetyltriethyl citrate and acetyltributyl citrate; a phosphoric acid type plasticizer such as triphenyl phosphate, biphenyldiphenyl phosphate, butylenebis(diethyl phosphate), ethylenebis(diphenyl phosphate), phenylenebis(dibutyl phosphate), phenylenebis(diphenyl phosphate) (ADECASTAB PFR manufactured by ADEKA Corp.), phenylenebis(dixylenyl phosphate) (ADECASTAB FP500 manufactured by ADEKA Corp.) and bisphenol A diphenyl phosphate (ADECASTAB FP600 manufactured by ADEKA Corp.); a polymer plasticizer and a carbohydrate ester type plasticizer are cited.

The carbohydrate ester type plasticizer is described below. The carbohydrate means monosaccharide, disaccharide and trisaccharide in which sugar is in a state of pyranose or furanose (six-member or five-member ring). Non-limitative examples of the carbohydrate include glucose, sucrose, lactose, cellobiose, mannose, xylose, ribose, galactose, arabinose, fructose, sorbose, cellotriose and raffinose. The carbohydrate ester is an ester compound formed by dehydration condensation of the hydroxyl group of a carbohydrate and a carboxylic acid, and means in detail an aliphatic carboxylate or an aromatic carboxylate of carbohydrate. As the aliphatic carboxylic acid, acetic acid and propionic acid are cited and as the aromatic carboxylic acid, benzoic acid, toluic acid and anisic acid are cited for example. The carbohydrate has various number of hydroxyl groups according to the kind thereof and a part or the entire of the hydroxyl groups may be made react with the acid to form the ester compound. In the invention, it is preferred that the entire hydroxyl groups react with the acid to form the ester compound.

As concrete examples of the carbohydrate type plasticizer, glucose pentaacetate, glucose pentapropionate, glucose pentabutylate, sucrose octaacetate and sucrose octabenzoate can be preferably cited. Among them, sucrose octaacetate is more preferable.

As the polymer plasticizer, an aliphatic hydrocarbon type polymer, an alicyclic hydrocarbon type polymer, an acryl type polymer such as poly(ethyl acetate), poly(methyl methacrylate), a copolymer of methyl methacrylate and 2-hydroxyethyl methacrylate and a copolymer of acrylic acid, methyl methacrylate and 2-hydroxyethyl methacrylate, a vinyl type polymer such as poly(vinyl isobutyl ether) and poly(N-vinylpyrrolidone), a styrene type polymer such as polystyrene and poly-4-hydroxystyrene, a polyether such as poly(ethylene oxide) and poly(propylene oxide), polyamide, polyurethane and polyurea are cited.

The phthalate type plasticizer, poly-valent carboxylate type plasticizer, citrate type plasticizer, carbohydrate ester type plasticizer and acrylic acid polymer are preferably used since the phosphate type plasticizer tends to cause coloring of the cellulose ester when it is used for melt-casting the film.

### (Cellulose Ester)

The cellulose ester to be used in the invention is described in detail below.

The cellulose ester film of the invention is produced by the melt-casting method. By the melt-casting method, the film largely improved in the environmental suitability can be obtained compared to usual solution-casting method using a lot of organic solvent.

The melt-casting method in the invention is a method for forming film by using the cellulose ester melted by heating until the cellulose ester displays fluidity substantially without use of any solvent, for example, a method for forming film by extruding the fluid cellulose ester through a die. A solvent may be used in a part of the process for preparing the melted cellulose ester but any solvent is not used in the casting process for forming the film.

The cellulose ester for constituting the optical film is preferably the single- or mixed-acid ester of cellulose containing at least one of aliphatic acyl group or substituted or unsubstituted aromatic acyl group though the cellulose ester is not specifically limited as long as which is capable of being formed film by the melt-casting method.

Examples of the benzene ring substituent group when the aromatic ring in the aromatic acyl group is a benzene ring include, a halogen atom, a cyano group, an alkyl group, an alkoxy group, aryl group, an aryloxy group, an acyl group, a carbonamide group, a sulfonamide group, a ureido group, an aralkyl group, a nitro group, an alkoxy carbonyl group, an aryloxy carbonyl group, an aralkyloxy carbonyl group, a carbamoyl group, a sulfamoyl group, an acyloxy group, an alkenyl group, an alkinyl group, an alkyl sulfonyl group, an aryl sulfonyl group, an alkyloxy sulfonyl group, an aryloxy sulfonyl group, an alkyl sulfonyloxy group, and an aryloxy sulfonyl group, —S—R, —NH—CO—OR, —PH—R, —P(—R)₂, —PH—O—R, —P(—R) (—O—R), —P(—O—R)₂, —PH(═O)—R—P(═O) (—R)₂, —PH(═O)—O—R, —P(═O)(—R)(—O—R), —P(—O)(—O—R)₂, —O—PH(═O)—R, —O—P(═O) (—R)₂—O—PH(═O)—O—R, —O—P(═O) (—R) (—O—R), —O—P(═O) (—O—R)₂, —NH—PH(═O)—R, —NH—P(═O) (—R) (—O—R), —NH—P(═O) (—O—R)₂, —SiH₂—R, —SiH(—R)₂, —Si(—R)₃, —O—SiH₂—R, —O—SiH(—R)₂ and —O—Si(—R)₃. R above is a fatty acid group, an aromatic group, or a heterocyclic group. The number of substituent groups is preferably between 1 and 5, more preferably between 1 and 4 and still more preferably between 1 and 3, and most preferably either 1 or 2. Examples of the substituent group preferably include a halogen atom, cyano, an alkyl group, an alkoxy group, an aryl group, an aryloxy group, an acyl group, a carbonamide group, a sulfonamide group, and a ureido group, and more preferably, a halogen atom, cyano, an alkyl group, an alkoxy group, an aryloxy group, an acyl group, and a carbonamide group, and still more preferably, a halogen atom, cyano, an alkyl group, an alkoxy group, and an aryloxy group, and most preferably, a halogen atom, an alkyl group, and an alkoxy group.

Examples of the halogen atom include a fluorine atom, a chlorine atom, a bromine atom, and an iodine atom. The alkyl group may have ring structure or may be branched. The number of carbon atoms in the alkyl group is preferably 1-20, more preferably 1-12, still more preferably 1-6, and most preferably 1-4. Examples of the alkyl group include methyl, ethyl, propyl, isopropyl, butyl, t-butyl, hexyl, cyclohexyl, octyl and 2-ethyl hexyl. The alkoxy group may have ring structure or may be branched. The number of carbon atoms in the alkoxy group is preferably 1-20, more preferably 1-12, still more preferably 1-6, and most preferably 1-4. The alkoxy group may be further substituted with another alkoxy group. Examples of the alkoxy group include a methoxy, ethoxy, 2-methoxyethoxy, 2-methoxy-2-ethoxyethoxy, butyloxy, hexyloxy and octyloxy.

The number of carbon atoms in the aryl group is preferably 6-20, and more preferably 6-12. Examples of the aryl group include phenyl and naphthyl. The number of carbon atoms in the aryloxy group is preferably 6-20, and more preferably 6-12. Examples of the aryloxy group include phenoxy and naphthoxy. The number of carbon atoms in the acyl group is preferably 1-20, and more preferably 1-12. Examples of the acyl group include formyl, acetyl, and benzoyl. The number of carbon atoms in the carbonamide group is preferably 1-20, and more preferably 1-12. Examples of the carbonamide include acetamide and benzamide. The number of carbon atoms in the sulfonamide group is preferably 1-20, and more preferably 1-12. Examples of the sulfonamide include methane sulfonamide, benzene sulfonamide, and p-toluene sulfonamide. The number of carbon atoms in the ureido group is preferably 1-20, and more preferably 1-12. Examples of the ureido group include (unsubstituted) ureido.

The number of carbon atoms in the aralkyl group is preferably 7-20, and more preferably 7-12. Examples of the aralkyl group include benzyl, phenethyl, and naphthyl methyl. The number of carbon atoms in the alkoxycarbonyl group is preferably 1-20, and more preferably 2-12. Examples of the alkoxycarbonyl group include methoxy carbonyl. The number of carbon atoms in the aryloxy carbonyl group is preferably 7-20, and more preferably 7-12. Examples of the aryloxy carbonyl group include phenoxy carbonyl. The number of carbon atoms in the aralkyloxycarbonyl is preferably 8-20, and more preferably 8-12. Examples of the aralkyloxycarbonyl include benzyloxycarbonyl. The number of carbon atoms in the carbamoyl group is preferably 1-20, and more preferably 1-12. Examples of the carbamoyl group include (unsubstituted) carbamoyl and N-methyl carbamoyl. The number of carbon atoms in the sulfamoyl group is preferably no greater than 20, and more preferably no greater than 12. Examples of the sulfamoyl group include (unsubstituted) sulfamoyl and N-methyl sulfamoyl. The number of carbon atoms in the acyloxy group is preferably 1-20, and more preferably 2-12. Examples of the acyloxy group include acetoxy and benzoyloxy.

The number of carbon atoms in the alkenyl group is preferably 2-20, and more preferably 2-12. Examples of the alkenyl group include vinyl, aryl and isopropenyl. The number of carbon atoms in the alkinyl group is preferably 2-20, and more preferably 2-12. Examples of the alkinyl group include thienyl. The number of carbon atoms in the alkyl sulfonyl group is preferably 1-20, and more preferably 1-12. The number of carbon atoms in the aryl sulfonyl group is preferably 6-20, and more preferably 6-12. The number of carbon atoms in the alkyloxy sulfonyl group is preferably 1-20, and more preferably 1-12. The number of carbon atoms in the aryloxy sulfonyl group is preferably 6-20, and more preferably 6-12. The number of carbon atoms in the alkyl sulfonyloxy group is preferably 1-20, and more preferably 1-12. The number of carbon atoms in the aryloxy sulfonyl is preferably 6-20, and more preferably 6-12.

In the cellulose ester of the invention, in the case where the hydrogen atom of the hydroxyl group portion of the cellulose is a fatty acid ester with a fatty acid acyl group, the number of carbon atoms in the fatty acid acyl group is 2-20, and specific examples thereof include acetyl, propionyl, butyryl, isobutyryl, valeryl, pivaloyl, hexanoyl, octanoyl, lauroyl, stearoyl and the like.

The aliphatic acyl group in the invention also refers to one which is further substituted, and examples of the substituent include those which when the aromatic ring in the aromatic acyl group described above is a benzene ring, are denoted in the substituents of the benzene ring.

When the ester group of cellulose ester has an aromatic ring, the number of the substituent groups X on the aromatic ring should be 0 or 1-5, preferably 1-3, and 1 or 2 is particularly preferable. In addition, when the number of substituent groups substituted on the aromatic ring is 2 or more, the substituent groups may be the same or different from each other, and they may also bond with each other to form a condensed polycyclic ring (such as naphthalene, indene, indane, phenanthrene, quinoline, isoquinoline, chromene, chroman, phthalazine, acridine, indole, indoline and the like).

In the invention, the cellulose ester has in the ester group a structure selected from at least one of a substituted or unsubstituted aliphatic acyl group or a substituted or unsubstituted aromatic acyl group, and this may be a single acid cellulose ester or a mixed acid cellulose ester, and two or more types of cellulose esters may be used in combination.

The cellulose ester used in the invention is preferably at least one type selected from cellulose acetate, cellulose propionate, cellulose butyrate, cellulose acetate propionate, cellulose acetate butyrate, cellulose acetate phthalate and cellulose phthalate. The mixed aliphatic acid ester, cellulose acetate propionate and cellulose acetate butyrate are more preferably and particularly cellulose acetate propionate is preferable.

Triacetyl cellulose which is commonly used in the solution casting method is difficult to use in a melt casting method, since the decomposition temperature of the triacetyl cellulose is lower than the melting temperature.

A degree of substitution of the lower aliphatic acid esters such as cellulose acetate propionate and cellulose acetate butyrate, which are preferred as the mixed aliphatic acid cellulose ester, have an acyl group having 2 to 4 carbon atoms as the substituent. The resin which satisfy both formula (1) and formula (2) below, are preferred.

2.5≦X+Y≦2.9 formula (1)

0.1≦X≦2.5 formula (2)

wherein X represents a degree of substitution of the acetyl group; and Y represents a degree of substitution of the propionyl group or the butyryl group.

Cellulose acetate propionate is preferably used herein, and of the cellulose acetate propionates, those that satisfy 1.2≦X≦2.1 and 0.1≦Y≦1.4 are particularly preferable. The portion of the acyl group that is not substituted is usually a hydroxyl group. These may be synthesized by a known method.

The degree of substitution of acyl group such as acetyl, propionyl and butyl group is measured by a method according to ASTM-D81796.

In the cellulose ester used in the invention, the ratio of the weight average molecular weight Mw/number average molecular weight Mn is preferably 1.5-5.5, while 1.7-5.0 is particularly preferable, and 2.0-3.0 is even more preferable.

The average molecular weight of cellulose ester and the distribution of the molecular weight can be measured by a high performance liquid chromatography according to the conventionally known method. This is used to calculate the number average molecular weight and weight average molecular weight.

GPC measuring requirements:
Solvent: Tetrahydrofuran
Apparatus: HLC-8220 (Manufactured by Tosoh Corp.)
Column: TSK gel Super HM-M (produced by Tosoh Corp.)
Column temperature: 40° C.
Sample temperature: 0.1% by weight
Injection amount: 10 μl
Flow rate: 0.6 ml/min
Calibration curve: Nine samples of Standard polystyrene PS-1 (Manufactured by Polymer Laboratories), the Mw being in the range of 580-2,560,000

The cellulose ester can be obtained, for example, by substituting the hydroxyl group of the material cellulose by the acetic anhydride, anhydrous propionic acid and/or anhydrous butyric acid according to the normal method in such a way that the acetyl group, propionyl group and/or butyl group are kept within the aforementioned range. There is no restriction to the method of synthesizing such a cellulose ester. For example, it can be synthesized by using the method disclosed in JP-A No. 10-45804, or Published Japanese Translation of PCT International Publication No. 6-501040.

A total residual acid amount including other residual acid, such as acetic acid, is preferably 1,000 ppm or less.

From the industrial viewpoint, cellulose ester is synthesized using sulfuric acid as a catalyst. This sulfuric acid is not completely removed, and the remaining sulfuric acid causes various forms of decomposition reaction at the time of melt casting film formation. This will affect the quality of the cellulose ester film to be obtained. Thus, the amount of the residual sulfuric acid contained in the cellulose ester used in this invention is 0.1 to 40 ppm in terms of the sulfur element. They are considered to be included as salts. The amount of the residual sulfuric acid contained therein of 40 ppm or less is preferable since the deposition on the die lip at the time of heat-melting is reduced and the film tends not to split off at the time of thermal stretching or slitting subsequent to thermal stretching. The amount of the residual sulfuric acid contained therein should be reduced as much as possible, but when it is to be reduced below 0.1, the load on the cellulose ester washing process will be excessive and the material tends to be damaged easily. This should be avoided. This may be because an increase in the frequency of washing affects the resin, but the details are not yet clarified. Further, the preferred amount is in the range of 0.1 through ppm. The amount of the residual sulfuric acid can be measured according to the ASTM-D817-96 in the similar manner.

The cellulose which is the raw material for the cellulose ester of the invention may be wood pulp or cotton linter, and the wood pulp may be that of a needle-leaf tree or a broad-leaf tree, but that of the broad-leaf tree is more preferable. Cotton linter is preferably used in view of peeling properties at the time of film formation. Cellulose esters made from these substances may be suitably blended or used alone.

For example, the proportion used of cellulose ester from cotton linter: cellulose ester from wood pulp (needle-leaf tree): cellulose ester from wood pulp (broad-leaf tree) may be 100:0:0, 90:10:0, 85:15:0, 50:50:0, 20:80:0, 10:90:0, 0:100:0, 0:0:100, 80:10:10, 85:0:15, and 40:30:30.

### <Antioxidant>

Coloring and strength lowering of the formed film caused by heat or deterioration by oxidation on the occasion of film formation can be prevented without lowering in the transparency and thermal resistivity by addition of an oxidant into the cellulose ester.

In the invention, any compounds capable of preventing the degradation of the film forming material can be usefully used as the antioxidant without any limitation. Among them, a phenol type antioxidant, a hindered amine type antioxidant, a phosphor type antioxidant, a sulfur type antioxidant, a heat-resistive processing stabilizer, an oxygen scavenger, an antioxidant having a phenol moiety represented by Formula I and a hindered amine moiety in the molecule thereof, a 3,4-dihydro-2H-1-benzopyrane type compound described in JP B H08-27508, a 3,3′-spirodi chroman type compound, a 1,1′-spiroindane type compound, morpholine, thiomorpholine, thiomorpholine oxide, thiomorpholine dioxide, a compound having a piperazine skeleton as a partial structure and a dialkoxybenzene type compound described in JP A H03-174150 are cited as useful antioxidant.

Among them, the phenol type antioxidant, heat-resistive processing stabilizer, and phosphor type antioxidant are particularly preferred.

In the invention, the oxidants having the phenol moiety represented by Formula I and the hindered amine moiety in the molecule thereof are preferably used.

In formula I, n is an integer of 1 or 2, Ra, Rb and Rd are each an alkyl group having 1 to 6 carbon atoms, Rc is an alkyl group having 1 to 9 carbon atoms, Re is a hydrogen atom or an alkyl group having 1 to 9 carbon atoms, Rf is a hydrogen atom or an alkyl group having 1 to 5 carbon atoms and Re and Rf can be exchanged with each other, X is an —O— or an —NR— group in which R is an alkyl group having 1 to 12 carbon atoms or an alkenyl group having 3 or 4 carbon atoms, R₁ is a hydrogen atom, an —O— atom, an alkyl group having 1 to 12 carbon atoms, an alkenyl group having 3 or 4 carbon atoms or an A-CO— group in which A is an alkyl group having 1 to 12 carbon atoms. R₂ is a hydroxybenzyl group represented by the foregoing Formula IT in which R₆ and R₇ are each independently an alkyl group having 1 to 9 carbon atoms and R₈ is a hydrogen atom or a methyl group. When n is 1, R₃ is an alkyl group having 1 to 10 carbon atoms which is substituted by one or more groups selected from an unsubstituted alkyl group having 1 to 20 carbon atoms, a —COOR₁₂ group, an —OCOR₁₃ group and a —P(O) (OR₁₄)₂ group in which R₁₂ is an alkyl group having 1 to 18 carbon atoms or a group represented by the foregoing Formula III (in Formula III, R₁, Ra, Rb, Rc, Rd, Re and Rf are each the same as those in Formula II, respectively) and R₁₃ is a phenyl group which may be substituted by an unsubstituted alkyl group having 1 to 4 carbon atoms or a hydroxyl group. R₃ also represents an alkenyl group having 3 to 18 carbon atoms, an aralkyl group having 7 to 19 carbon atoms or a —OCOR₁₆ in which R₁₆ is a phenyl group which may be substituted by an alkyl group having 1 to 12 carbon atoms or two alkyl groups having 1 to 4 carbon atoms and a hydroxyl group or an —NHCOR₁₆ in which R₁₆ is an alkyl group having 1 to 12 carbon atoms. When n is 2, R₃ further represents a direct bond or an alkylene group having 1 to 20 carbon atoms.

In Formula I, Ra, Rb and Rd are each a straight or branched chain alkyl group having 1 to 6 carbon atoms such as a methyl group, an ethyl group, a propyl group, a butyl group, an isobutyl group, an isopentyl group and an n-hexyl group. Rc is a straight or branched alkyl group having 1 to 9 carbon atoms such as a methyl group, an ethyl group, a propyl group, a butyl group, an isobutyl group, an isopentyl group, an n-hexyl group, a 2-ethylhexyl group, an n-nonyl group and an isononyl group. Re and Rf are each an alkyl group having not more than 5 carbon atoms and the number of carbon atom of Re is smaller by one than that of Rf and the positions of Re and Rf may be reciprocally exchanged.

Ra, Rb, Rc and Rd are each preferably a methyl group and Re and Rf are each preferably a hydrogen atom. The alkyl group having 1 to 12 carbon atoms represented by R₁, R₁₆ or A is a primary alkyl group such as a methyl group, an ethyl group, an n-propyl group, an n-hexyl group, an n-octyl group, an n-decyl group and an n-dodecyl group.

The alkenyl group represented by R₁ or R₁₆ is an allyl group, a methacryl group or butenyl group for instance. When R₁ is the A-CO— group, the group is a carboxyl group such as an acetyl group, a propionyl group, a butylyl group, a capronyl group, a capryloyl group and lauroyl group depending on the meaning of A. R₂ is a para- or meta-hydroxybenzyl group according to the definition in Formula 2. R₆ and R₇ of the benzyl group is a straight or branched chain alkyl group having 1 to 9 carbon atoms such as a methyl group, an ethyl group, an isopropyl group, a tert-butyl group, a 1,1,3,3-tetramethylbutyl group and a tert-nonyl group. R₆ and R₇ are each preferably an alkyl group having 1 to 4 carbon atoms and particularly preferably a methyl or a tert-butyl group.

R₃ is a mono- or di-valent organic group according to the value of n. The alkyl group represented by having 1 to carbon atoms is one of the alkyl groups given by the foregoing R₁ or a branched chain alkyl group such as an isopropyl group, an isopentyl group, a 2-ethylbutyl group, a 2-ethylhexyl group and a isononyl group or a higher alkyl group such as an n-hexadecyl group, an n-octadecyl group and an n-eicosyl group.

The substituted or discontinued alkyl group represented by R₃ is one of the following groups for example: a 2-fenoxyethyl group, a 2-benzoyloxyethyl group, a 2-p-trioxypropyl group, a cyclohexyloxymethyl group, a 2,3-di(phenoxy)propyl group, a 2-phenylthioethyl group, a 2-(4-t-butylphenylthio)ethyl group, a 2-acetylethyl group, a 2-isobutylylethyl group, a 2-(dodecylcarbonyl)ethyl group, a 2-cyanoethyl group, a cyanomethyl group, a 3-cyanopropyl group, a methoxy-carbonylmethyl group, a dodecyloxycarbonylmethyl group, a 2-ethoxycarbonylethyl group, a 1,2-di(methoxycarbonyl)propyl group, a 2,3-di(ethoxycarbonyl)ethyl group, a 2-(butylamino)ethyl group, a 2-(cyclohexylcarbonyl)ethyl group, a 2-(t-butyloxycarbonylethyl group, a 2-(octadecyloxy-carbonyl)propyl group, a 4-(propoxycarbonyl)butyl group, 2-acetoxyethyl group, 1,2-diacetoxyethyl group, a 2-(isooctanoyloxy)propyl group, a 2-(cyclopentylcarbonyl-oxy)-ethyl group, a 3-benzoyloxypropyl group, a 2-(t-butyl-benzoyloxy)ethyl group, a 2-salicyloyloxyethyl group, a 2-(3,5-di-t-butyl-4-hydroxybenzoyloxy)ethyl group, a 2-phenylacetyloxyethyl group, a 2-(3,5-di-t-butyl-4-hydroxy-phenylpropionyloxy)propyl group, a diethylphosphonomethyl group, a 2-dimethylphosphonoethyl group, a 2-(dioctyl-phosphono)ethyl group, a diphenylphosphonomethyl group, a 3-(diallylphosphono)propyl group, a methoxymethyl group, a 2-butoxyethyl group, a 2-octadecyloxyethyl group, an isopropoxymethyl group, a 3-butylthiopropyl group, a dodecylthioethyl group, a 2-(isohexylsulfinyl)ethyl group, a 2-octadecylsulfonylethyl group, a 2-ethylsulfonylpropyl group, a 2-(2,2,6,6-tetramethylpiperidine-4-yloxycarbonyl)ethyl group, a 2-(1,2,2,6,6-pentamethylpiperidine-4-yl-aminocarbonyl)ethyl group, a 2-(2,2,6,6-tetramethyl-piperidine-4-yloxycarbonyl)-2-(methoxycarbonyl)hexyl group and 2,2-bis(2,2,6,6-tetramethylpiperidine-4-yl-oxycarbonyl)hexyl group.

The alkenyl group represented by R₃ is, for example, an allyl group, a methacryl group, a 2-butene-1-yl group, a 3-hexene-1-yl group, an undecenyl group, or an oleyl group.

The aralkyl group represented by R₃ is, for example, a benzyl group, a 2-phenylpropyl group, a β-naphthylmethyl group, a 4-methylbenzyl group, a 4-t-butylbenzyl group or a 4-methylnaphthyl-1-methyl group.

The —OCOR₁₆ group or —NHCOR₁₆ represented by R₃ is, for example, an acetoxy group, a propoxy group, a butyloxy group, an octanoyloxy group, a dodecanoyloxy group, a benzoyloxy group, a 3,5-di-t-butyl-4-hydroxybenzoyloxy group, an acetoamino group, a butylylamino group or a decanoylamino group.

When n is 2, R₃ is a direct bond or a divalent organic group. Such the group is an alkylene group such as a methylene group, an ethylene group or a polymethylene group having 20 or less carbon atoms.

The compound is ones in which Ra to Rd are each a methyl group and Re and Rf are each a hydrogen atom or Rb Rd and Re are a methyl group and Rf is a hydrogen atom.

Compounds represented by Formula I are also preferable, in which X is an oxygen or an NH group, R₁ is a hydrogen atom, an —O— atom, an alkyl group having 1 to 4 carbon atoms, an allyl group, a propargyl group, an acetyl group, an acryloyl group or a crotonoyl group, R₂ is the following Formula IIa or IIb in which R₆ and R₇ are each independently an alkyl group having 1 to 4 carbon atoms, R₅ is a hydrogen atom or a methyl group, R₃ is an alkyl group having 1 to 4 carbon atoms substituted by one or two of an unsubstituted alkyl group having 1 to 18 carbon atoms, a —COOR₁₂ group, an —OCOR₃ group or a —P(O)(OR₁₄)₂ group (in the above formulas R₁₂ is an alkyl group having 1 to 4 carbon atoms or the foregoing Formula III, R₁₃ is a phenyl group and R₁₄ is an alkyl group having 1 to 4 carbon atoms), an alkenyl group having 3 to 6 carbon atoms, a phenyl group, an aralkyl group having 7 to 15 carbon atoms or an —OCOR₁₆ group (R₁₆ is an alkyl group having 1 to 12 carbon atoms, a phenyl group, a 3,5-di-t-butyl-4-hydroxyphenyl group or a 2-(3,5-di-t-butyl-4-hydroxyphenyl)ethyl group) and an —NHCOR₁₆ group (R₁₆ is an alkyl group having 1 to 12 carbon atoms) when n is 1, and R₃ is a direct bond or an alkyl group having 1 to 12 carbon atoms when n is 2.

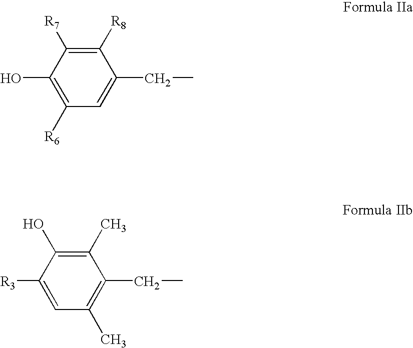

Compounds represented by Formula I are particularly preferable, in which n is 1 or 2, Ra, Rb, Rc and Rd are each a methyl group, Re and Rf are each a hydrogen atom, X is an oxygen atom, R₁ is an alkyl group having 1 to 4 carbon atoms, an allyl group or an acetyl group, R₁ is a hydroxybenzyl group represented by Formula IIa or lib in which R₆ is a tert-butyl group, R₇ is a methyl group or a tert-butyl group and R₈ is a hydrogen atom or a methyl group, and R₃ is an alkyl group having 1 to 18 carbon atoms substituted by one or two of —COOR₁₂ groups in which R₁₂ is an alkyl group having 1 to 4 carbon atoms or a group represented by the following Formula IIIa, a —P(O) (OR₁₄)₂ group, an allyl group, a benzyl group, a phenyl group, an alkylene group having 1 to 8 carbon atoms or a xylylene group.

The invention includes a salt of the compound represented by Formula I formed by addition of an acid in an amount of not more than the equivalent to the piperidine group. Such the acid is an inorganic acid such as sulfuric acid, hydrochloric acid and phosphoric acid, an organic carboxylic acid such as formic acid, acetic acid, oxalic acid, maleic acid, succinic acid and salicylic acid, an organic sulfonic acid such as m- or p-toluenesulfonic acid and methanesulfonic acid, and an organic phosphor-containing acid such as diphenylphosphoric acid and diphenylphosphinic acid.

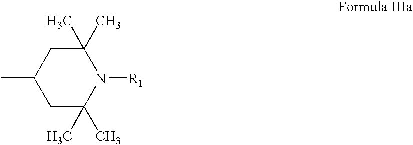

Concrete examples of the compound represented by Formula I are listed below but the invention is not limited to them.

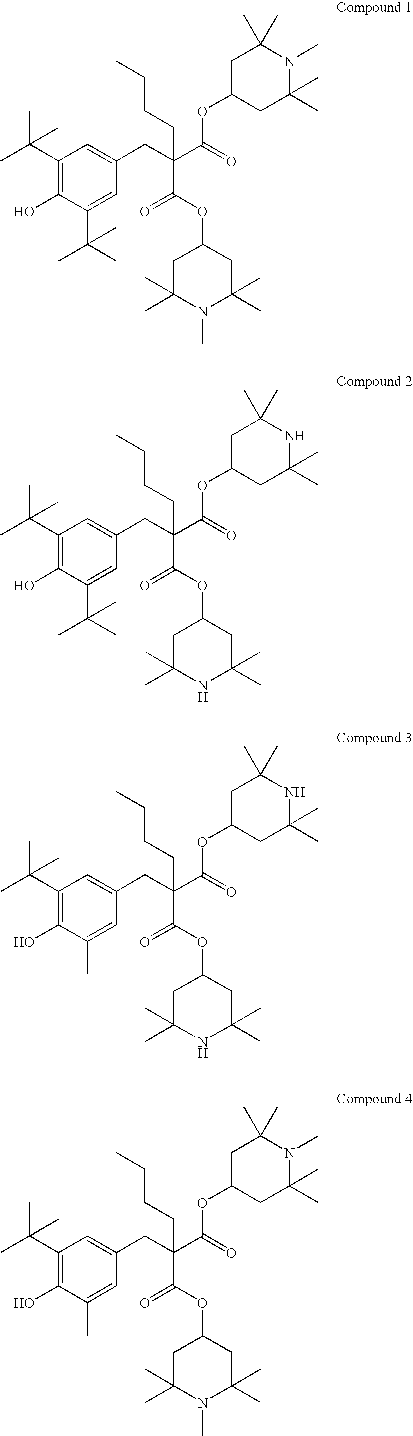

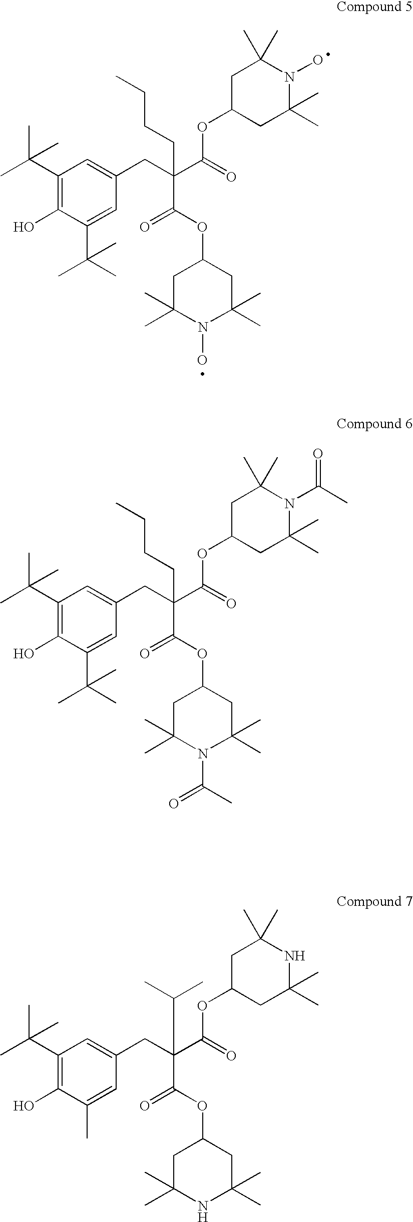

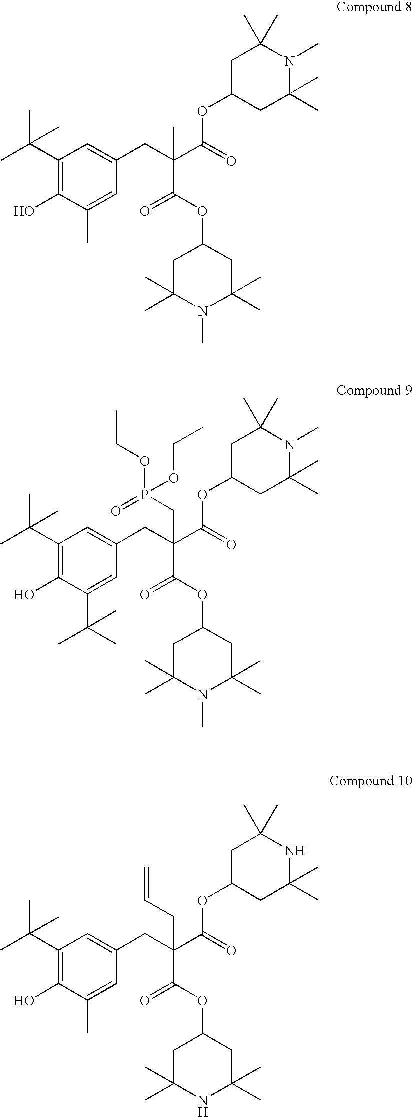

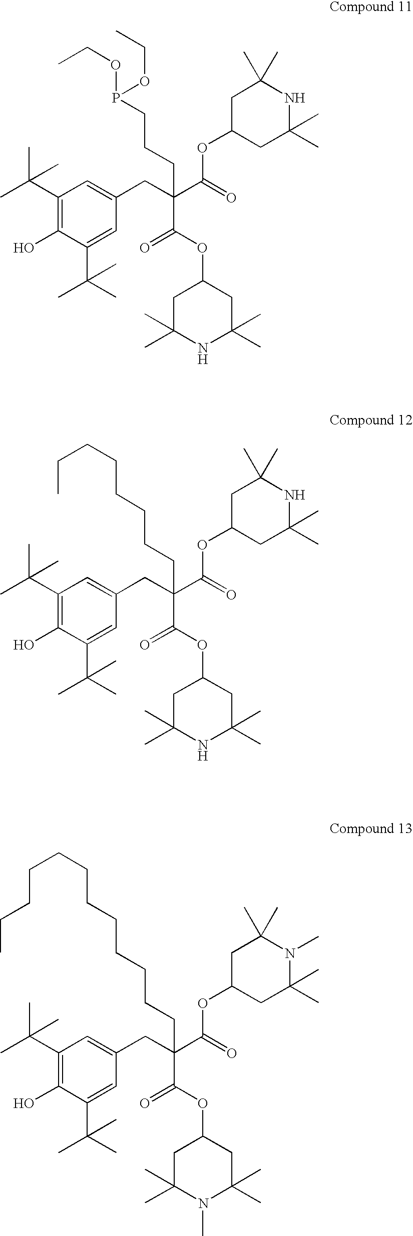

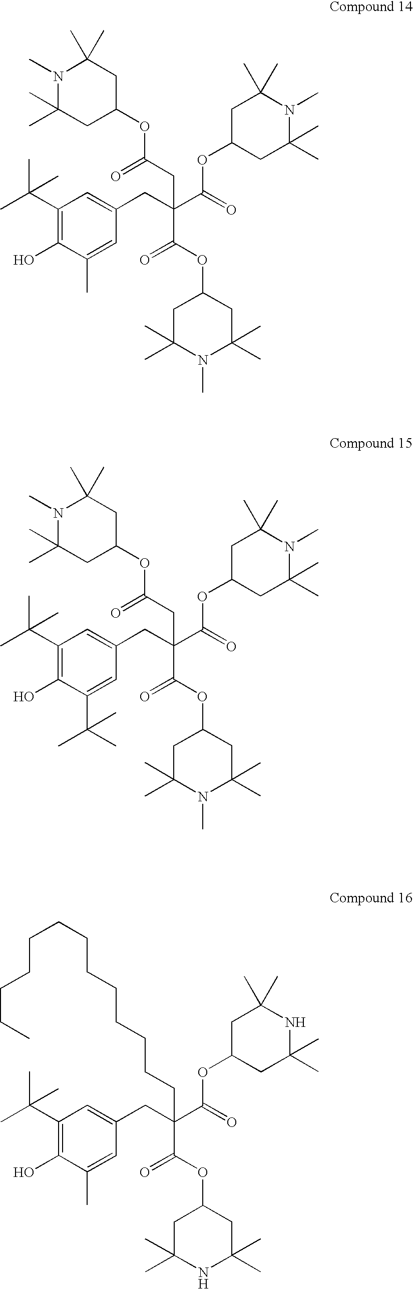

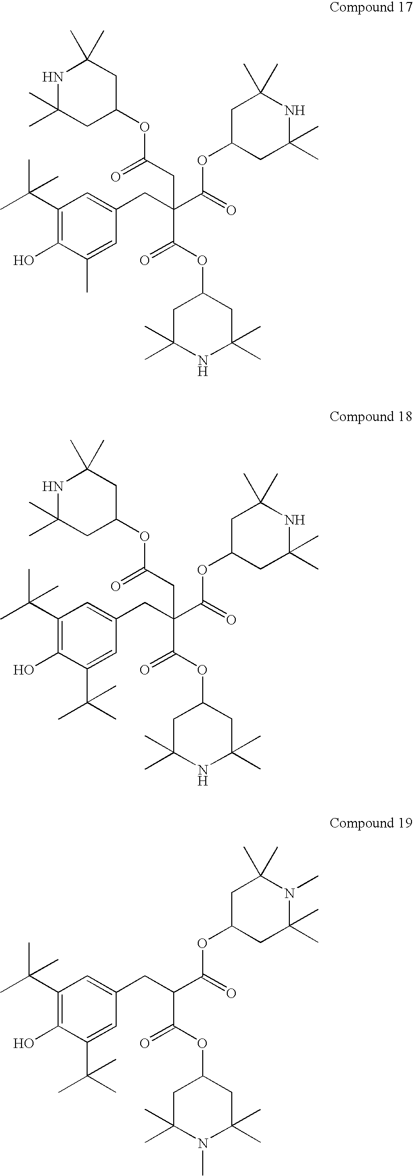

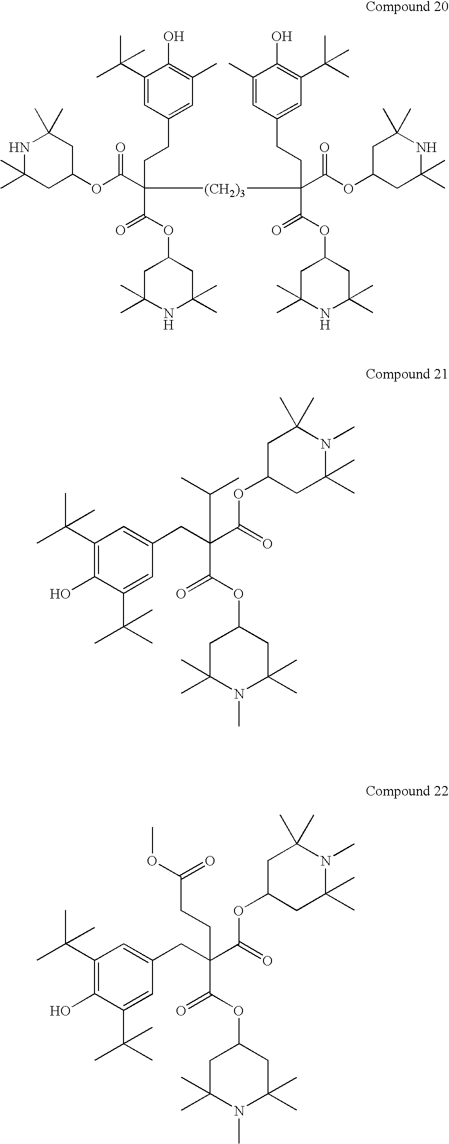

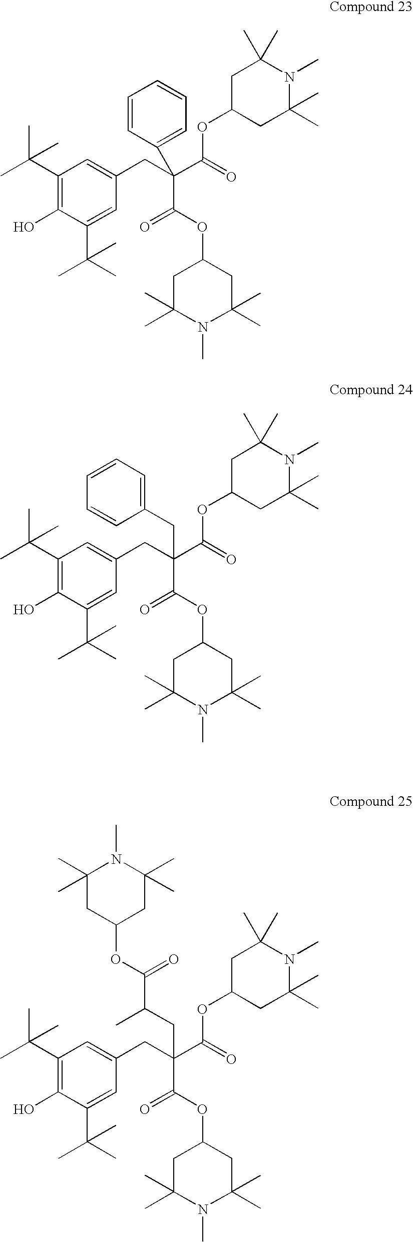

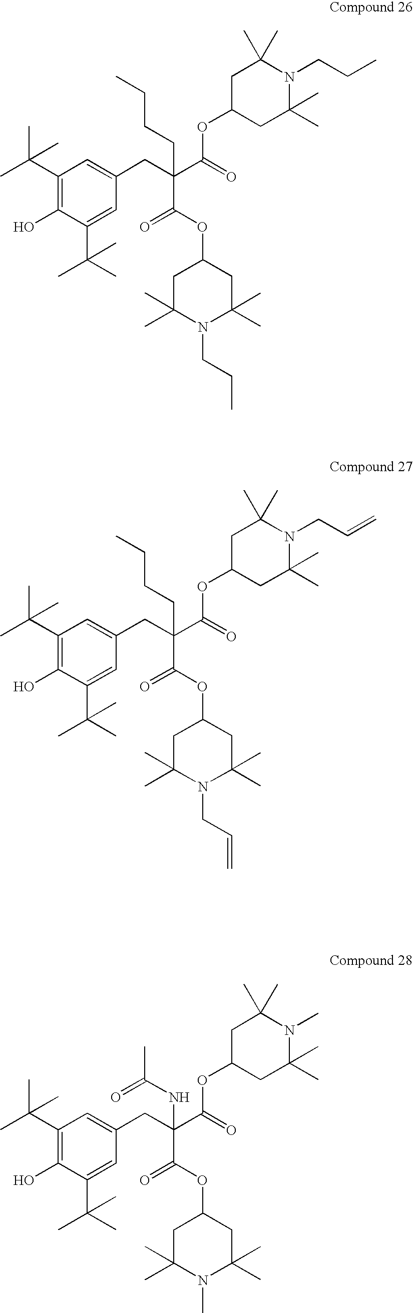

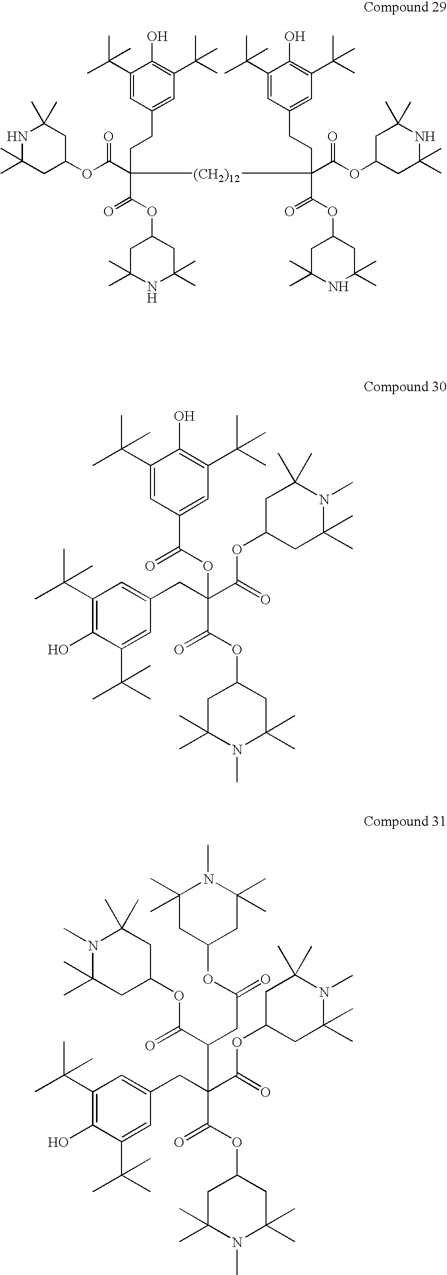

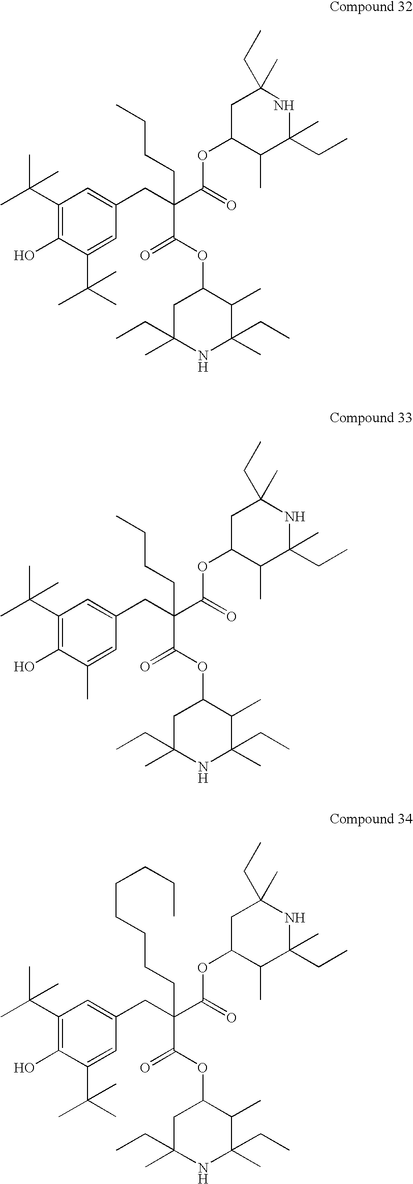

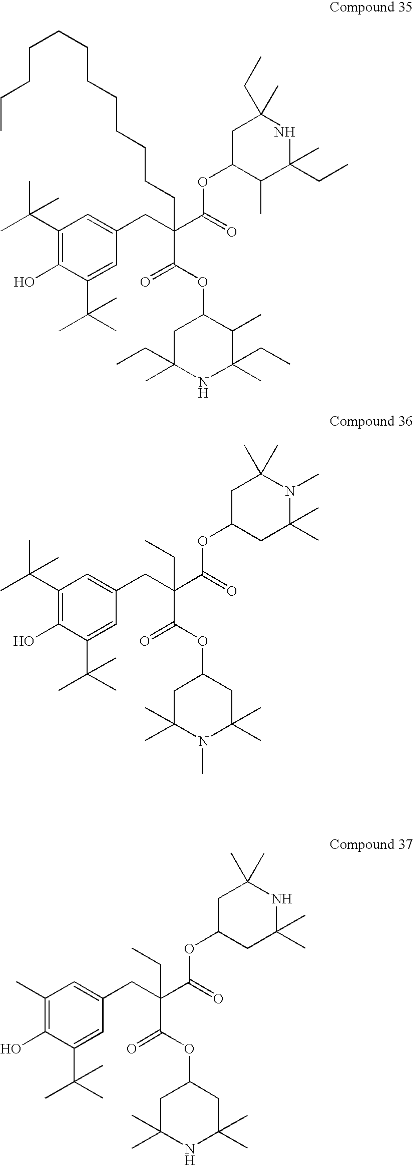

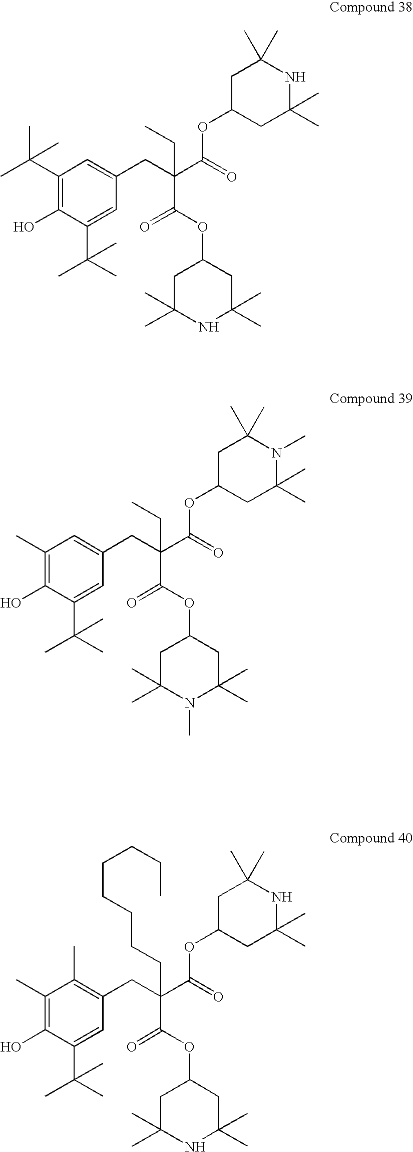

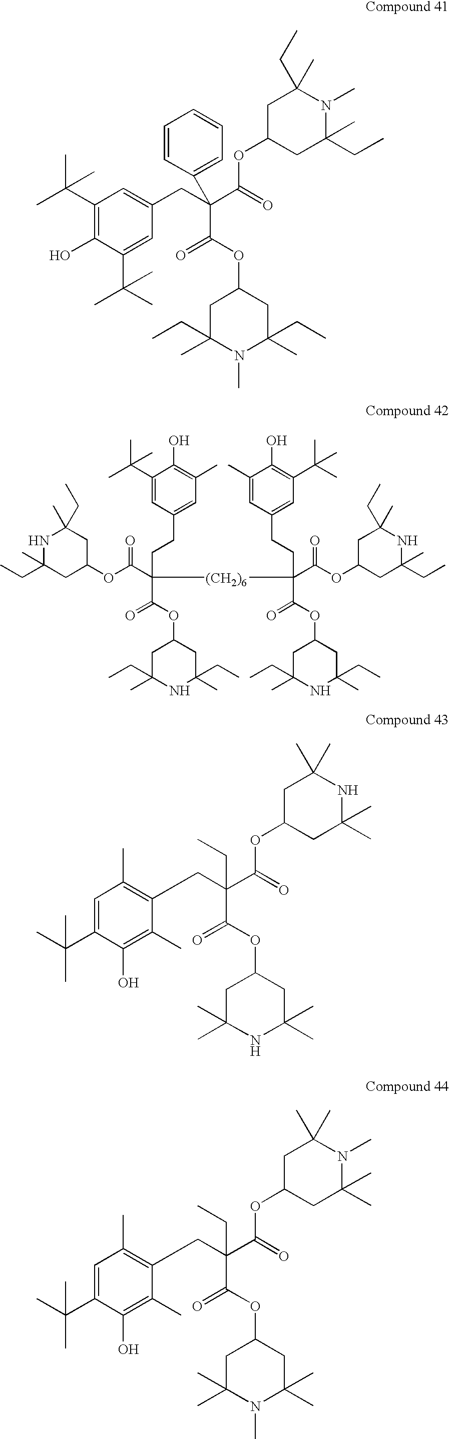

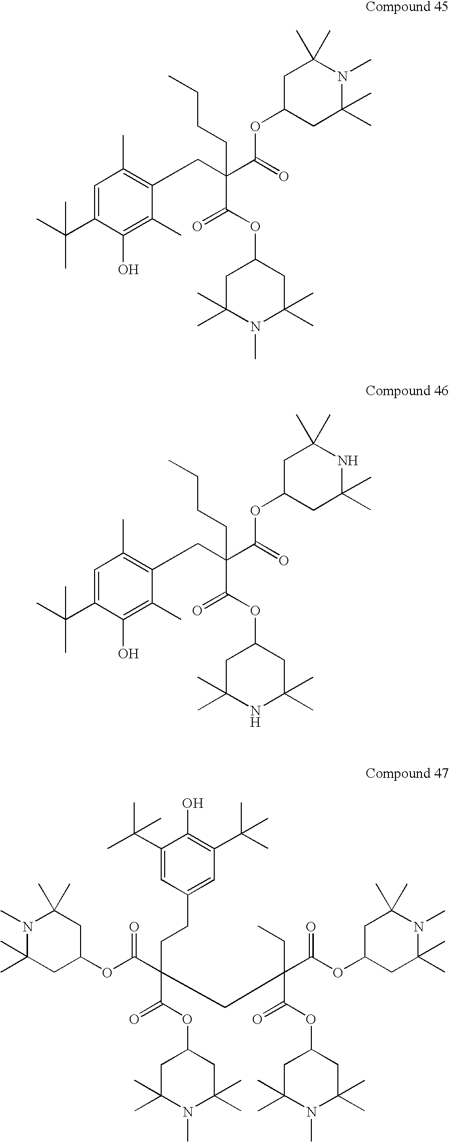

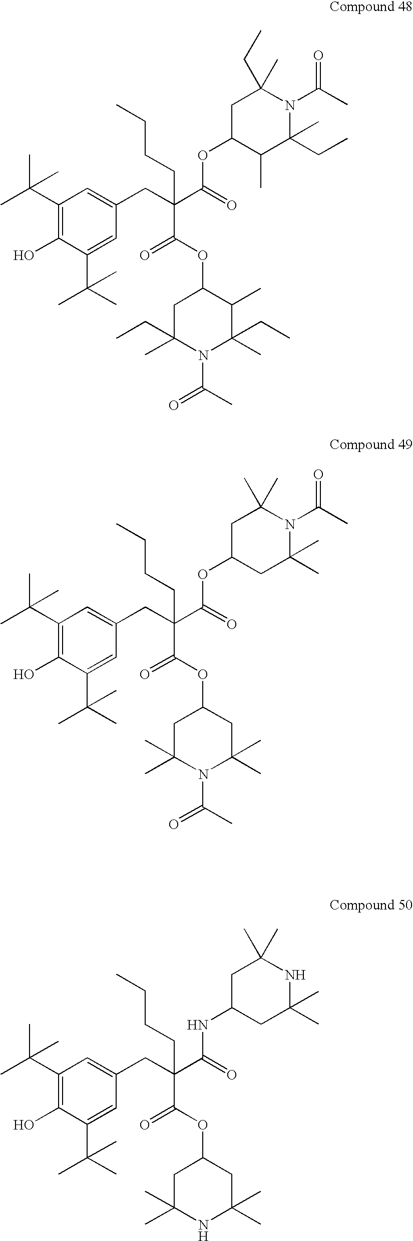

Synthesis of the compound represented by Formula I of the invention is started by converting a lower alkyl malonate such as diethyl malonate to a corresponding bispiperidinyl malonic acid derivative (V) by reaction with 4-piperidinol (IV) or 4-aminopiperidine. Introduction of R₁ can be carried out by usual N-alkylation or N-acylation method, for instance, a method in which the reaction is made in the presence of alkyl halide, an alkenyl halide or carboxylic acid chloride in an amount of not more than 1 mole of the base.

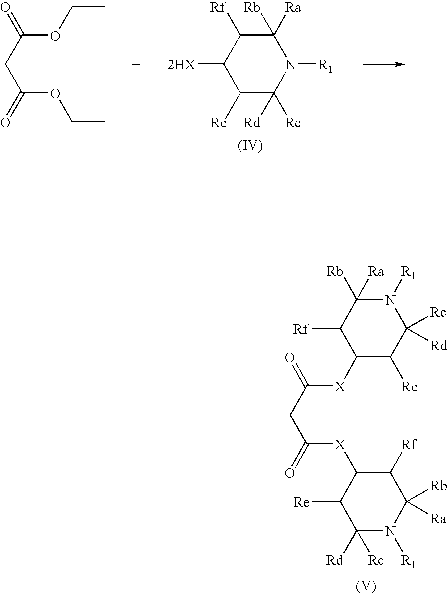

Introduction of the hydroxybenzyl group R₂ is carried out by reaction with a hydroxybenzyldithiocarbamate represented by R₂—S—CS—N(R)₂ in which R is an alkyl group having 1 to 4 carbon atoms or both of R are a morpholine, pyrrolidine or piperidine group together with the nitrogen atom. Such the dithiocarbamate is obtained by reaction of phenol with formaldehyde, carbon disulfide and a secondary amine.

The hydroxybenzyl group of R₂ can also be introduced by reaction with a hydroxybenzylamine R₂—N(R)₂. Such the amine can be obtained by reaction of phenol with formaldehyde and a secondary amine by so called Mannich reaction.

When X is an oxygen atom, R₂ is introduced by a molonate synthesizing method in which the ester (IV) is converted to the alkali compound (V) by reacting with an alkali metal, an alkali alcoholate, an alkaliamide, an alkali hydride or a similar alkali compound and then made react with 1 mole of hydroxybenzyl halide (R₂-Hal, Hal is Cl, Br or I) by an ordinary method.

A hydroxybenzyl malonic acid derivative represented by the following (VI) is prepared by one of the above three methods and then R₃ is introduced into thus obtained derivative.

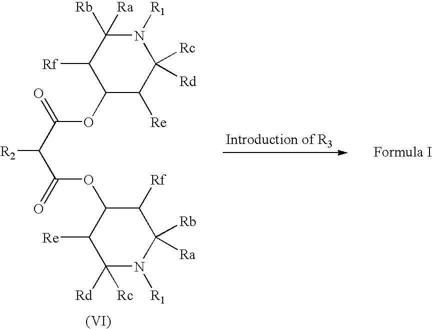

Introduction of R₃ is carried out by usual method for C-alkylation of the malonate in which VI is firstly converted to an alkali compound thereof and the compound is made react with a halogen compound R₃Hal or R₃Hal₂.

### SYNTHESIZING EXAMPLE

### Synthesis of Compound 31

In 200 ml of toluene, 23.3 g (0.05 moles) of his(1,2,2,6,6-pentamethyl-4-piperidinyl)butylmalonate and 13.2 g (0.05 moles) of N-(3,5-di-t-butyl-4-hydroxybenzyl)dimethylamine were dissolved and the mixture was refluxed for 4 hours. Then the mixture was cooled and neutralized by 1.5 ml of 1% acetic acid and organic phase was repeatedly washed by water. The solution was dried by Na₂SO₄ and concentrated under vacuum. Thus Compound 31 having a melting point of 140° C. was obtained.

Another exemplified compound can be obtained in similar manner.

The adding amount of the compound represented by Formula I to the cellulose ester is usually from 0.001 to 10, preferably from 0.01 to 5, and more preferably from 0.1 to 3.0, parts by weight per kind to 100 parts by weight of the cellulose ester.

### (Hindered Phenol Compound)

The cellulose ester film of the invention preferably contains a hindered phenol compound.

The hindered phenol anti-oxidants are known compounds and preferable example includes a 2,6-dialkylphenol compound as disclosed, for example, in columns 12 to 14 of U.S. Pat. No. 4,839,405). As the hindered phenol compound, there is a compound represented by the following formula A,

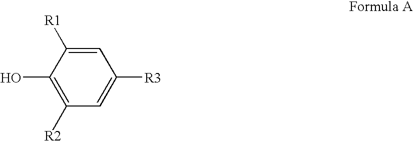

Wherein R₁, R₂ and R₃ independently represent a substituted or unsubstituted alkyl group.

Examples of the hindered phenol compound include n-octadecyl 3-(3,5-di-t-butyl-4-hydroxyphenyl)propionate, n-octadecyl 3-(3,5-di-t-butyl-4-hydroxyphenyl)acetate, n-octadecyl 3,5-di-t-butyl-4-hydroxybenzoate, n-hexyl 3,5-di-t-butyl-4-hydroxybenzoate, n-dodecyl 3,5-di-t-butyl-4-hydroxyohenylbenzoate, neo-dodecyl 3-(3,5-di-t-butyl-4-hydroxyphenyl)propionate, dodecyl β-(3,5-di-t-butyl-4-hydroxyphenyl)propionate, ethyl α-(4-hydroxy-3,5-di-t-butylphenyl)isobutyrate, octadecyl α-(4-hydroxy-3,5-di-t-butylphenyl)isobutyrate, octadecyl α-(4-hydroxy-3,5-di-t-butyl-4-hydroxyphenyl)propionate, 2-(n-octylthio)ethyl 3,5-di-t-butyl-4-hydroxybenzoate, 2-(n-octylthio)ethyl 3,5-di-t-butyl-4-hydroxyphenylacetate, 2-(n-octadecylthio)ethyl 3,5-di-t-butyl-4-hydroxyphenylacetate, 2-(n-octadecylthio)ethyl 3,5-di-t-butyl-4-hydroxybenzoate, 2-(2-hydroxyethylthio)ethyl 3,5-di-t-butyl-4-hydroxybenzoate, diethylglycol bis(3,5-di-t-butyl-4-hydroxyphenyl)propionate, 2-(n-octadecylthio)ethyl 3-(3,5-di-t-butyl-4-hydroxyphenyl)propionate, stealamide N,N-bis-[ethylene 3-(3,5-di-t-butyl-4-hydroxyphenyl)propionate], n-butylimino N,N-bis-[ethylene 3-(3,5-di-t-butyl-4-hydroxyphenyl)propionate], 2-(2-stearoyloxyethylthio)ethyl 3,5-di-t-butyl-4-hydroxybenzoate, 2-(2-stearoyloxyethylthio)ethyl 7-(3-methyl-5-t-butyl-4-hydroxyphenyl)heptanoate, 1,2-propylene glycol bis[3-(3,5-di-t-butyl-4-hydroxyphenyl)propionate], ethylene glycol bis[3-(3,5-di-t-butyl-4-hydroxyphenyl)propionate], neopentyl glycol bis[3-(3,5-di-t-butyl-4-hydroxyphenyl)propionate], ethylene glycol bis(3,5-di-t-butyl-4-hydroxyphenylacetate), glycerin-1-n-octadecanoate-2,3-bis(3,5-di-t-butyl-4-hydroxyphenylacetate), pentaerythritol tetrakis[3-(3′,5′-di-t-butyl-4′-hydroxyphenyl)propionate], 1,1,1-trimethylolethane tris[3-(3,5-di-t-butyl-4-hydroxyphenyl)propionate], sorbitol hexa[3-(3,5-di-t-butyl-4-hydroxyphenyl)propionate], 2-hydroxyethyl 7-(3-methyl-5-t-butyl-4-hydroxyphenyl)propionate, 2-stearoyloxyethyl 7-(3-methyl-5-t-butyl-4-hydroxyphenyl)heptanoate, 1,6-n-hexane diol-bis[(3′,5′-di-t-butyl-4′-hydroxyphenyl)propionate], pentaerythritol tetrakis(3,5-di-t-butyl-4-hydroxycinnamate).

As typical examples of the hindered phenol compound above, there are “IRGANOX 1076” and “IRGANOX 1010” available from Ciba Specialty Chemicals Co.

### (Phosphorus-Containing Compound)

The phosphorus-containing compound used in this invention, is preferably a compound having a partial substructure represented by following Formula (C-1), (C-2), (C-3), (C-4) or (C-5) in a molecule.

Particularly preferable is a compound having a partial substructure represented by following Formula (C-2) in a molecule.

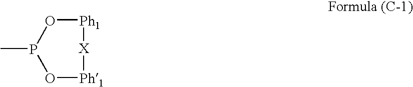

In the Formula, Ph₁ and Ph′₁ each represents a phenylene group, and the hydrogen atom of the phenylene group may be substituted with a phenyl group, an alkyl group having 1 to 8 carbon atoms, a cycloalkyl group having 5 to 8 carbon atoms, an alkylcycloalkyl group having 6 to 12 carbon atoms, or an aralkyl group having 7 to 12 carbon atoms. Ph₁ and Ph′₁ may be the same or different. X represents a single bond, a sulfur atom, or a —CHR₆— group. R₆ represents a hydrogen atom, an alkyl group having 1 to 8 carbon atoms, or a cycloalkyl group having 5 to 8 carbon atoms. These may be further substituted with a substituent represented by Ph₂ and Ph′₂ of the Formula C-2 mentioned below.

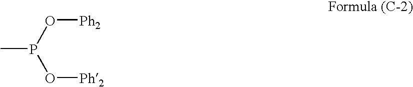

In the Formula, Ph₂ and Ph′₂ each represents a hydrogen atom or a substituent. Examples of the substituent include: a halogen atom (for example, a fluorine atom and a chlorine atom), an alkyl group (for example, a methyl group, an ethyl group, an isopropyl group, a hydroxyethyl group, a methoxy methyl group, a trifluoro methyl group and a t-butyl group), a cycloalkyl group (for example, a cyclopentyl group and a cyclohexyl group), an aralkyl group (for example, a benzyl group and a 2-phenethyl group), an aryl group (for example, a phenyl group, a naphthyl group, p-tolyl group and a p-chlorophenyl group), an alkoxy group (for example, a methoxy group, an ethoxy group, an isopropoxy group and a butoxy group), an aryloxy groups (for example, a phenoxy group), a cyano group, an acylamino group (for example, an acetylamino group and a propionylamino group), an alkylthio group (for example, a methylthio group, an ethylthio group and a butylthio group), an arylthio group (for example, a phenylthio group), a sulfonylamino group (for example, a methanesulfonylamino group and a benzene sulfonyl amino group), an ureido group (for example, a 3-methylureido group, a 3,3-dimethylureido group and a 1,3-dimethylureido group), a sulfamoylamino group (a dimethylsulfamoyl amino group), a carbamoyl group (for example, a methylcarbamoyl group, an ethylcarbamoyl group and a dimethylcarbamoyl group), a sulfamoyl group (for example, an ethylsulfamoyl group and a dimethylsulfamoyl group), an alkoxycarbonyl group (for example, a methoxycarbonyl group and an ethoxycarbonyl group), an aryloxycarbonyl group, (for example, a phenoxycarbonyl group), a sulfonyl group (for example, a methanesulfonyl group, a butane sulfonyl group and a phenylsulfonyl group), an acyl group (for example, an acetyl group, a propanoyl group and a butyroyl group), an amino group (a methylamino group, an ethylamino group and a dimethylamino group), a cyano group, a hydroxy group, a nitro group, a nitroso group, an amine oxide group (for example, a pyridine oxide group), an imide group (for example, a phthalimide group), disulfide group (for example, a benzene disulfide group and a benzothiazolyl-2-disulfide group), a carboxyl group, a sulfo group and a heterocycle group (for example, a pyrrole group, a pyrrolidyl group, a pyrazolyl group, an imidazolyl group, a pyridyl group, a benzimidazolyl group, a benzthiazolyl group and a benzoxazolyl group). These substituents may further be substituted. Ph₂ and Ph′₂ each are more preferably a phenyl group or a biphenyl group. The hydrogen atom of the phenyl group or the biphenyl group may be substituted with an alkyl group having 1 to 8 carbon atoms, a cycloalkyl group having 5 to 8 carbon atoms, an alkylcycloalkyl group having 6 to 12 carbon atoms, or an aralkyl group having 7 to 12 carbon atoms. Ph₂ and Ph′₂ may be mutually the same or may be different. These may be substituted with a substituent represented by above described Ph₂ and Ph′₂.

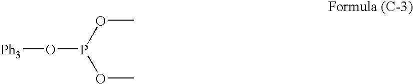

In the Formula, Ph₃ represents a substituent. The substituent is the same as the substituent represented by Ph₂ and Ph′₂. More preferably, Ph₃ represents a phenyl group or a biphenyl group. The hydrogen atom of the phenyl group or the biphenyl group may be substituted with an alkyl group having 1 to 8 carbon atoms, a cycloalkyl group having 5 to 8 carbon atoms, an alkylcycloalkyl group having 6 to 12 carbon atoms, or an aralkyl group having 7 to 12 carbon atoms. Ph₃ may further be substituted with a substituent which is the same as the substituent described for Ph₂ and Ph′₂.

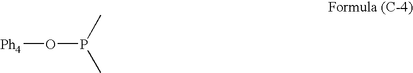

In the Formula, Ph₄ represents a substituent. The substituent is the same as the substituent described for a substituent Ph₂ and Ph′₂. More preferably, Ph₄ represents an alkyl group or a phenyl group each having 1 to 20 carbon atoms. The alkyl group or the phenyl group may be substituted with a substituent which is the same as the substituent described for Ph₂ and Ph′₂.

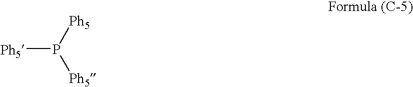

In the Formula, Ph₅, Ph′₅, and Ph″₅ each represent a substituent. The substituent is the same as the substituent described for Ph₂ and Ph′₂. More preferably, Ph₅, Ph′₅, and Ph″₅ each represent an alkyl group or a phenyl group each having 1 to 20 carbon atoms. The hydrogen atom of the alkyl group or the phenyl group may be replaced with a substituent which is the same as the substituent described for Ph₂ and Ph′₂.

Specific examples of a phosphorus-containing compound include: mono-phosphite compounds such as triphenyl phosphite, diphenylisodecyl phosphite, phenyldiisodecyl phosphite, tris(nonylphenyl) phosphite, tris(dinonylphenyl) phosphite, tris(2,4-di-t-butylphenyl) phosphite, 10-(3,5-di-t-butyl-4-hydroxybenzyl)-9,10-dihydro-9-oxa-10-phosphaphenanthrene-10-oxide, 6-[3-(3-t-butyl-4-hydroxy-5-methylphenyl)propoxy]-2,4,8,10-tetra-t-butyldibenz[d,f][1.3.2]dioxaphosphepine and tridecyl phosphite; diphosphite compounds such as 4,4′-butylidene-bis(3-methyl-6-t-butylphenyl-di-tridecyl phosphite) and 4,4′-isopropylidene-bis(phenyl-di-alkyl(C12-C15) phosphite); phosphonite compounds such as triphenyl phosphonite, tetrakis(2,4-di-tert-butylphenyl) [1,1-biphenyl]-4,4′-diylbisphosphonite and tetrakis(2,4-di-tert-butyl-5-methylphenyl) [1,1-biphenyl]-4,4′-diylbisphosphonite; phosphinite compounds such as triphenyl phosphinite and 2,6-dimethylphenyldiphenyl phosphinite; and phosphine compounds such as triphenyl phosphine and tris(2,6-dimethoxyphenyl) phosphine.

The phosphorus-containing compound listed above have been commercialized, for example, as “Sumilizer GP” from Sumitomo Chemical Co., Ltd., “ADK STAB PEP-24G” “ADK STAB PEP-36” “ADK STAB 3010” from ADEKA Corp., “IRGAFOS P-EPQ” from Ciba Specialty Chemicals, Inc., and “GSY-P101” from SAKAI CHEMICAL INDUSTRY CO., LTD.

The compounds shown below are further listed.

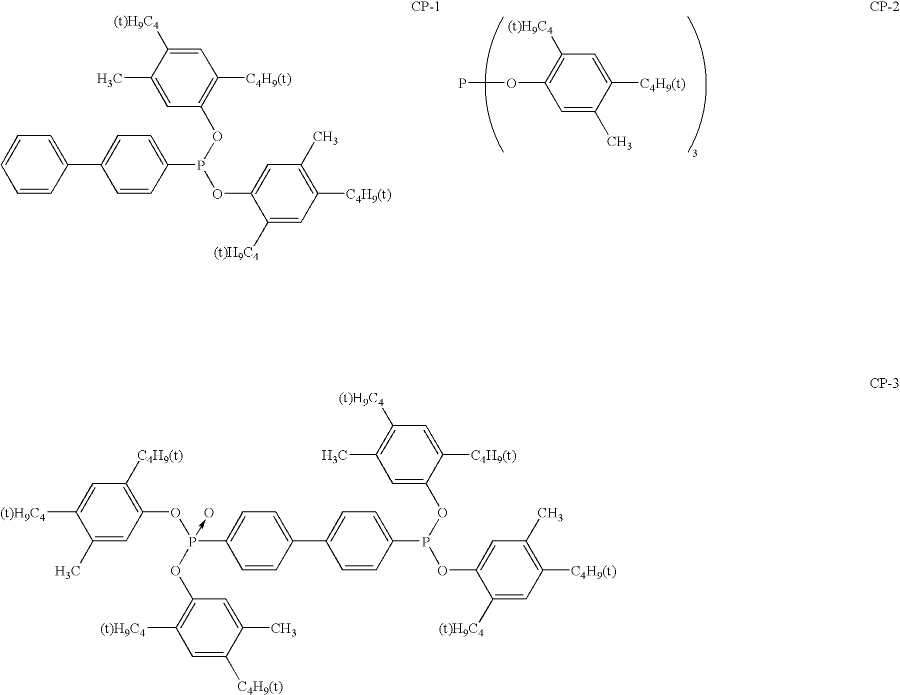

In this invention, a sulfur compound resented by Formula (D) may be used as an antioxidant.

R₃₁—S—R₃₂ Formula (D)

In the Formula (D), R₃₁ and R₃₂ each represent a hydrogen atom or a substituent. The substituent is the same as the substituent described for Ph₂ and Ph′₂. R₃₁ and R₃₂ each are preferably an alkyl group. The substituents may be substituted with a substituent described for Ph₂ and Ph′₂.

Examples of the sulfur-containing compound include dilauryl 3,3-thiodipropionate, dimyristyl 3,3′-thiodipropionate, distearyl 3,3-thiodipropionate, lauryl stearyl 3,3-thiodipropionate, pentaerythritol-tetrakis(β-lauryl-thiopropionate), and 3,9-bis(2-dodecythioethyl)-2,4,8,10-tetra-oxaspiro[5,5]undecane.

The sulfur-containing compounds listed above have been commercialized, for example, as “Sumilizer TPL-R” and “Sumilizer TP-D” from Sumitomo Chemical Co., Ltd.

### (Anti-Thermal Processing Stabilizer)

It is preferred to employ an anti-thermal processing stabilizer, particularly it is preferred to use a compound represented by the Formulas (E) and (F) in this invention.

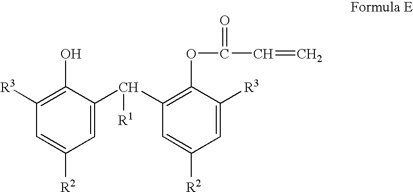

In formula E, R¹ represents a hydrogen atom or an alkyl group having a carbon atom number of from 1 to 10, and R² and R³ independently represent an alkyl group having a carbon atom number of from 1 to 8.

In formula E, R¹ represents a hydrogen atom or an alkyl group having a carbon atom number of from 1 to 10, preferably a hydrogen atom or an alkyl group having a carbon atom number of from 1 to 4, and more preferably a hydrogen atom or a methyl group.

R² and R³ independently represent an alkyl group having a carbon atom number of from 1 to 8, and the alkyl may be straight-chained, branched or cyclic. R² and R³ are preferably a quaternary carbon atom containing group represented by the following formula,

*—C(CH₃)₂—R′

wherein * represents the site bonding the aromatic (benzene) ring and R′ represents an alkyl group having a carbon atom number of from 1 to 5.

R² is preferably a tert-butyl group, a tert-amyl group, or a tert-octyl group. R³ is preferably a tert-butyl group, or a tert-amyl group.

Typical examples of compounds represented by formula E include “SUMILIZER GM” (trade name), “SUMILIZER GS” (trade name), each being available from Sumitomo Chemical Co., Ltd.

Examples of the carbon radical trapping agent E-1 to E-18 will be listed below, but the invention is not limited thereto.

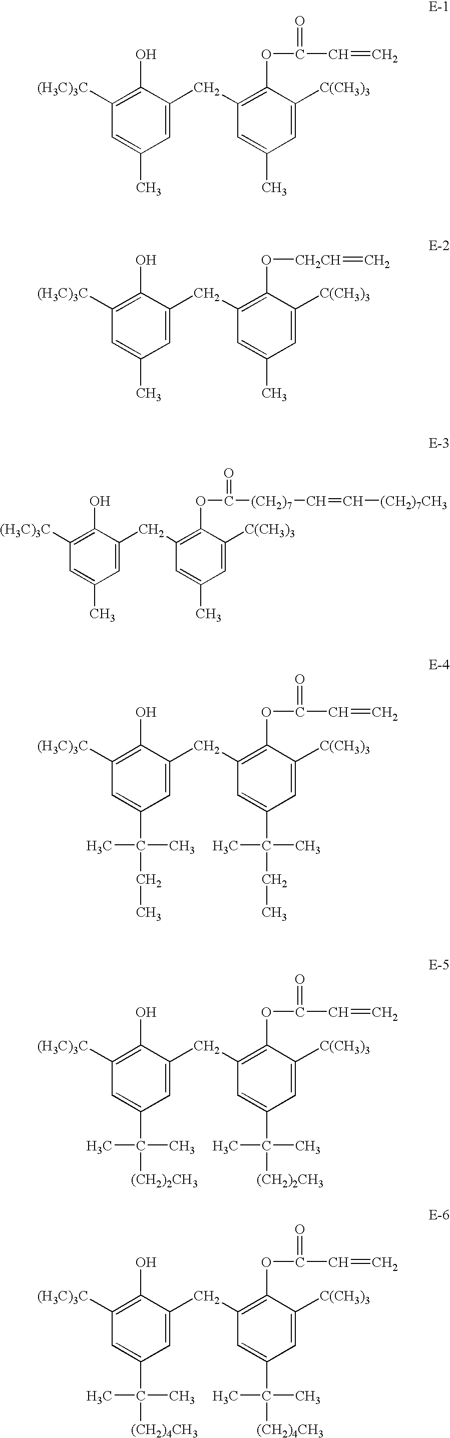

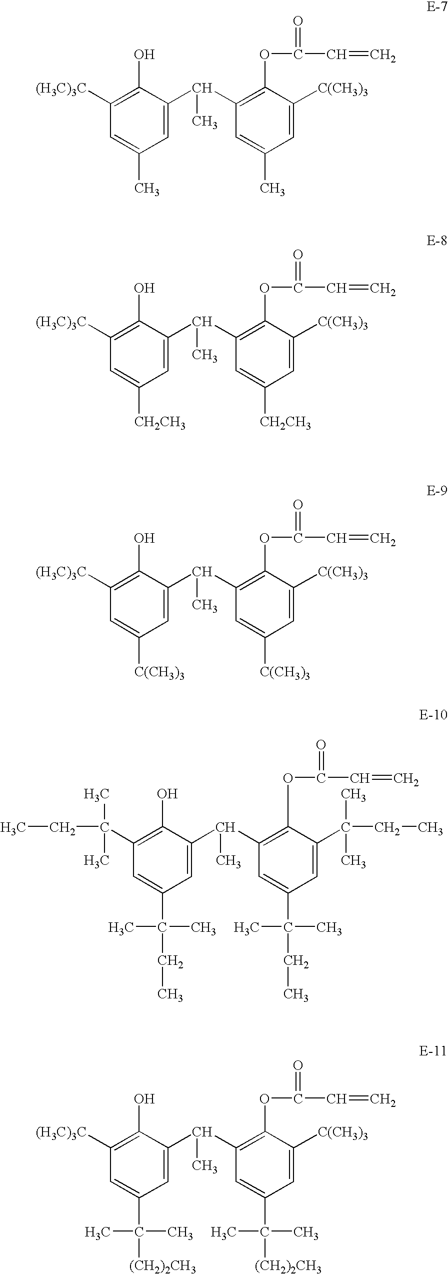

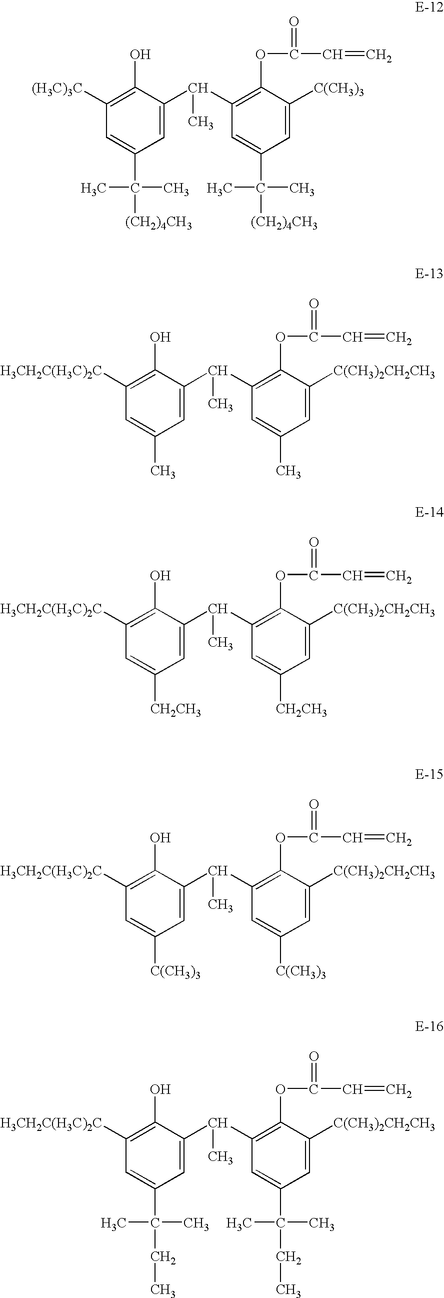

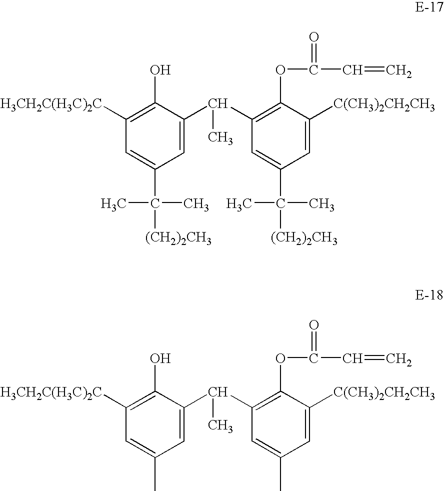

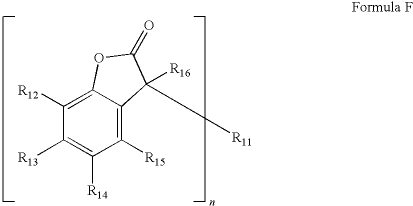

In formula F, R₁₂ through R₁₅ independently represent a hydrogen atom or a substituent.

Examples of the substituent represented by formula R₁₂ through R₁₅ are not particularly restricted and include an alkyl group (for example, a methyl group, an ethyl group, a propyl group, an isopropyl group, a t-butyl group, a pentyl group, a hexyl group, an octyl group, a dodecyl group, or a trifluoromethyl group), a cycloalkyl group (for example, a cyclopentyl group or a cyclohexyl group), an aryl group (for example, a phenyl group, or a naphthyl group), an acylamino group (for example, an acetylamino group, or a benzoylamino group), an alkylthio group (for example, a methylthio group, or an ethylthio group), an arylthio group (for example, a phenylthio group or a naphthylthio group), an alkenyl group (for example, a vinyl group, 2-propenyl group, a 3-butenyl group, a 1-methyl-3-propenyl group, a 3-pentenyl group, a 1-methyl-3-butenyl group, a 4-hexenyl group or a cyclohexenyl group), a halogen atom (for example, fluorine, chlorine, bromine, iodine), an alkinyl group (for example, a propargyl group), a heterocyclic group (for example, pyridyl group, a thiazolyl group, an oxazolyl group or an imidazolyl group), an alkylsulfonyl group (for example, a methylsulfonyl group or an ethylsulfonyl group), an arylsulfonyl group (for example, a phenylsulfonyl group or a naphthylsulfonyl group), an alkylsulfinyl group (for example, a methylsulfinyl group), an arylsulfonyl group (a phenylsulfinyl group), a phosphono group, an acyl group (for example, an acetyl group, a pivaloyl group or a benzoyl group), a carbamoyl group (for example, an aminocarbonyl group, a methylaminocarbonyl group, a dimethylaminocarbonyl group, a butylaminocarbonyl group, a cyclohexylaminocarbonyl group, a phenylaminocarbonyl group, or a 2-pyridylaminocarbonyl group), a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group or a 2-pyridylaminosulfonyl group), a sulfonamide group (for example, a methanesulfonamide group or a benzene sulfonamide group), a cyano group, an alkoxy group (for example, a methoxy group, an ethoxy group, or a propoxy group), an aryloxy group (for example, a phenoxy group or a naphthyloxy group), a heterocycle oxy group, a siloxy group, an acyloxy group (for example, an acetyloxy group, or a benzoyloxy group), a sulfonic acid group, a sulfonate group, an aminocarbonyloxy group, an amino group (for example, an amino group, an ethylamino group, a dimethylamino group, a butylaminocarbonyl group, a cyclopentylamino group, a 2-ethylhexylamino group, or a dodecylamino group), an anilino group (for example, a phenylamino group, a chlorophenylamino group, a toluidino group, an anisidino group, a naphthylamino group or a 2-pyridylamino group), an imino group, a ureido group (for example, a methylureido group, an ethylureido group, a pentylureido group, a cyclohexylureido group, an octylureido group, a dodecylureido group, a phenylureido group, a naphthylureido group, or a 2-pyridylureido group), an alkoxycarbonylamino group (for example, a methoxycarbonylamino group, or a phenoxycarbonylamino group), an alkoxycarbonyl group (for example, a methoxycarbonyl group an ethoxycarbonyl group, or a phenoxycarbonyl group), an aryloxycarbonyl group (for example, a phenoxycarbonyl group), a heterocyclicthio group, a thioureido group, a carboxyl group, a salt of carboxylic acid group, a hydroxyl group, a mercapto group, and a nitro group. These substituents may further have the substituent as described above.

In the formula F R₁₂ through R₁₅ are preferably a hydrogen atom or an alkyl group.

In the formula F, R₁₆ represents a hydrogen atom or a substituent; and the substituents represented by R₁₆ are those represented by R₁₂ through R₁₅ is preferably a hydrogen atom.

In the formula F, R₁₆ is preferably a hydrogen atom.

In the formula F, n is 1 or 2, provided that when n is 1, R₁₁ represents a monovalent substituent, and when n is 2, R₁₁ represents a divalent linkage group.

When R₁₁ represents a substituent, the same substituent as R₁₂ through R₁₅ are listed therefore. When R₁₁ represents a divalent bonding group, its example includes an alkylene group which may have a substituent, oxygen atom, nitrogen atom, sulfur atom or combination of these bonding groups.

In the formula F, n is preferably 1, and in this instance, R₁₁ is preferably a substituted or non-substituted phenyl group, more preferably a phenyl group substituted with an alkyl group, or acyloxy group.

Examples of compound represented by formula F are listed below, to which this invention is not restricted.

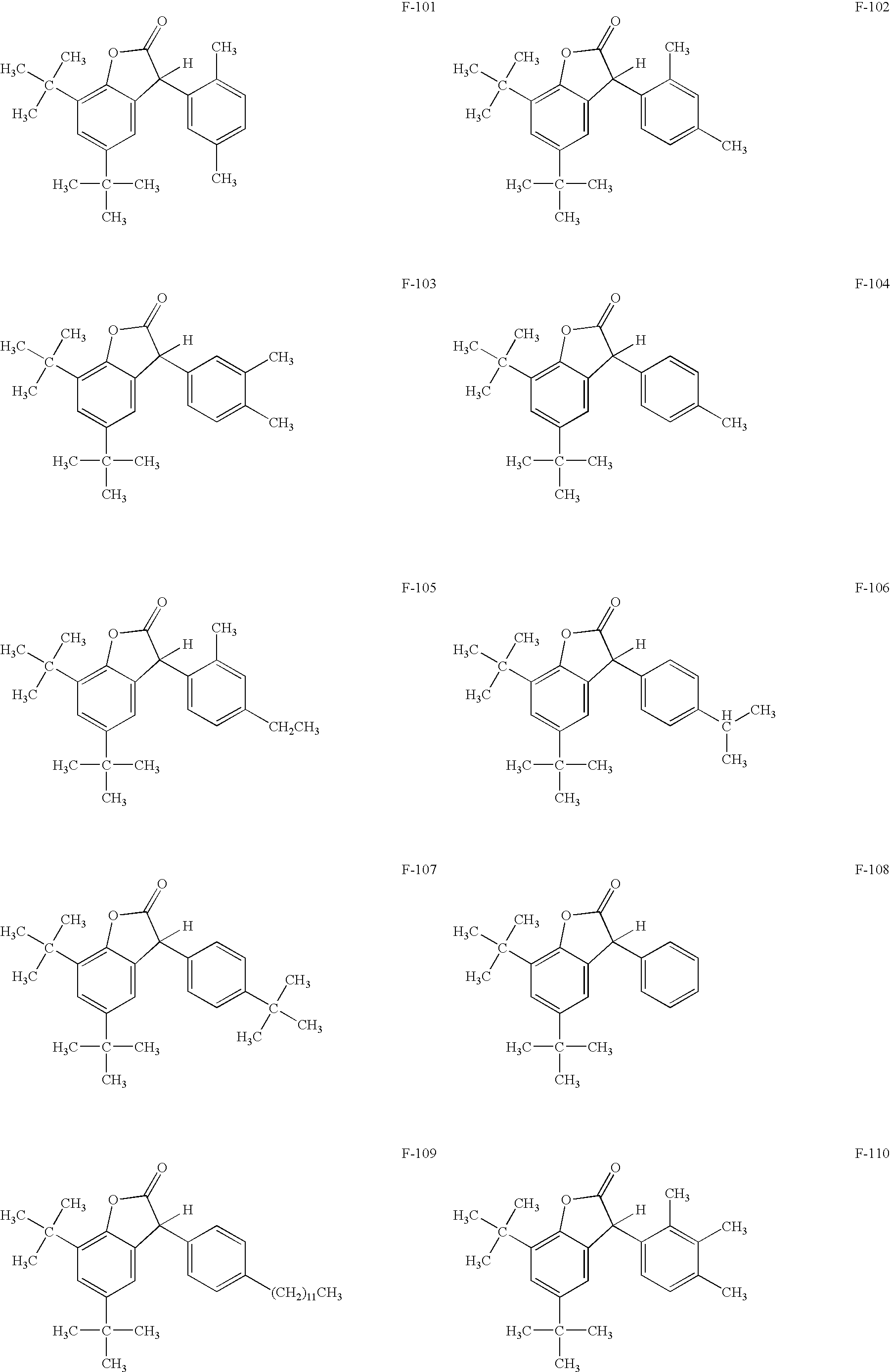

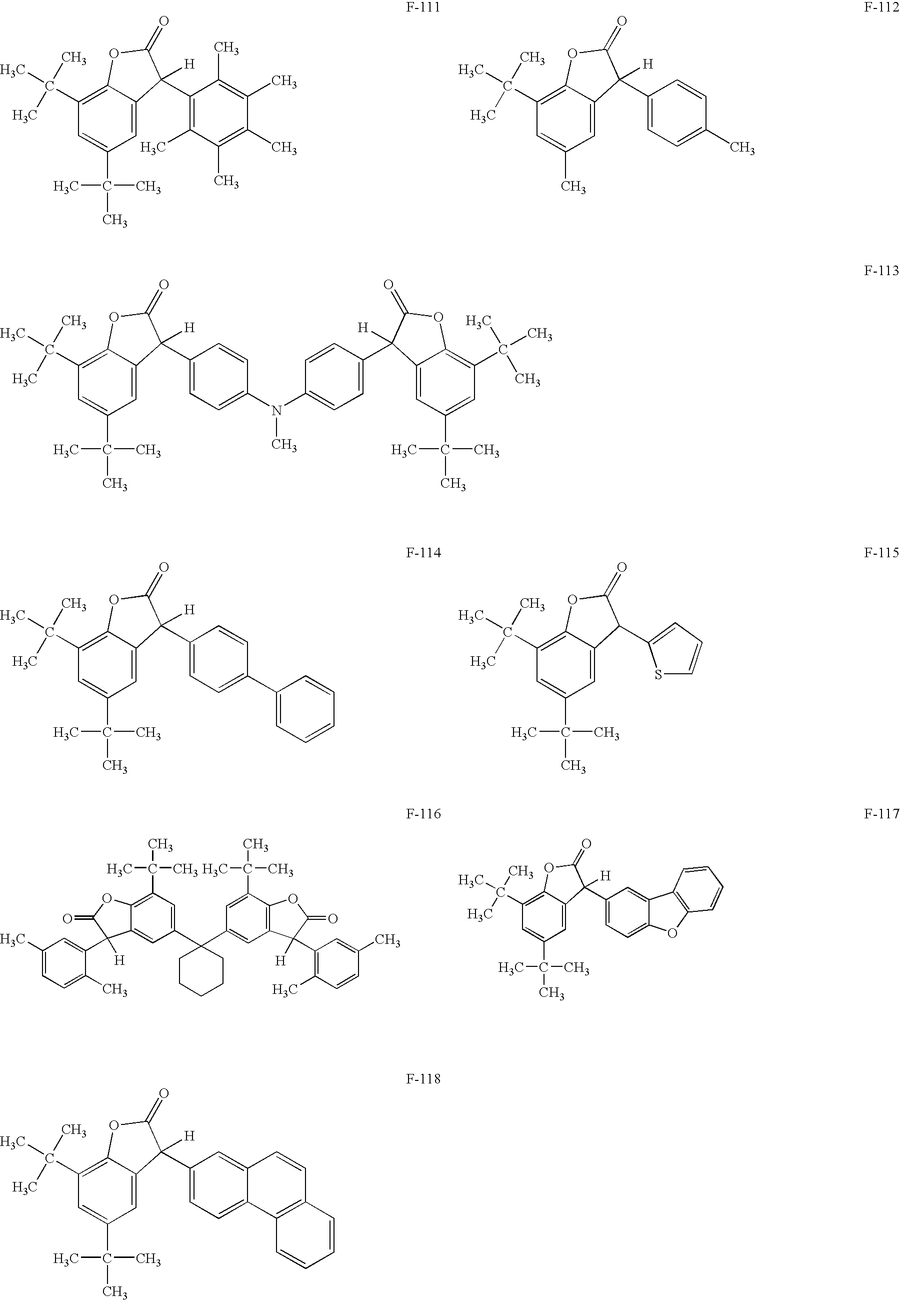

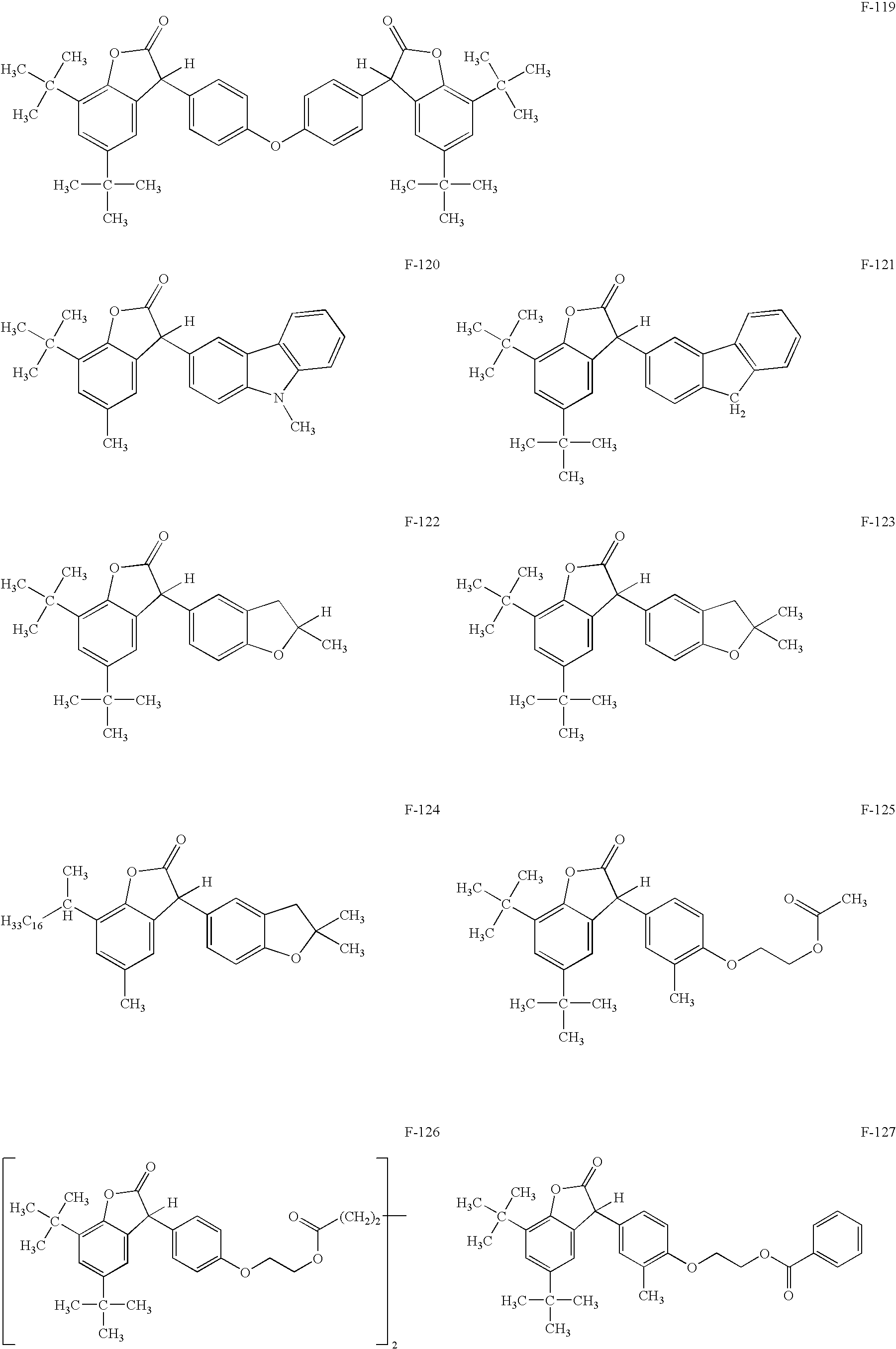

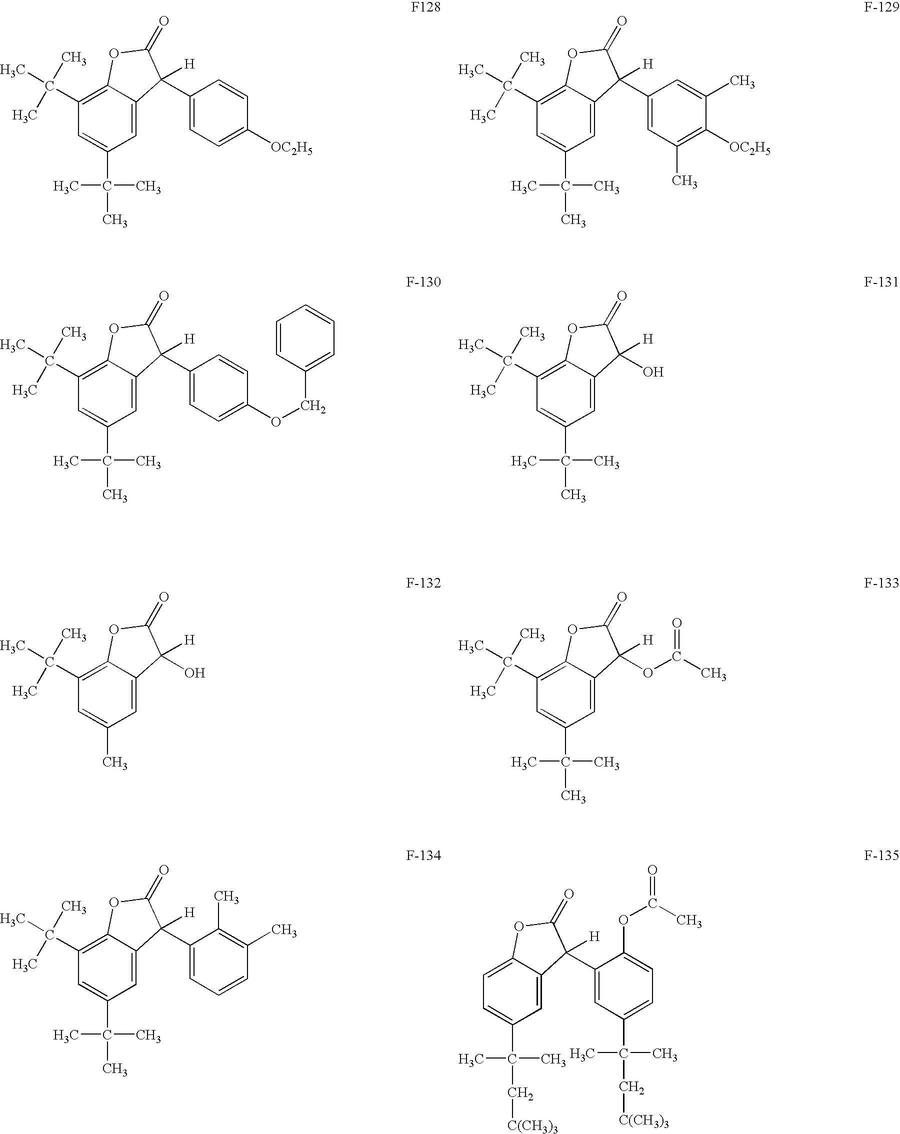

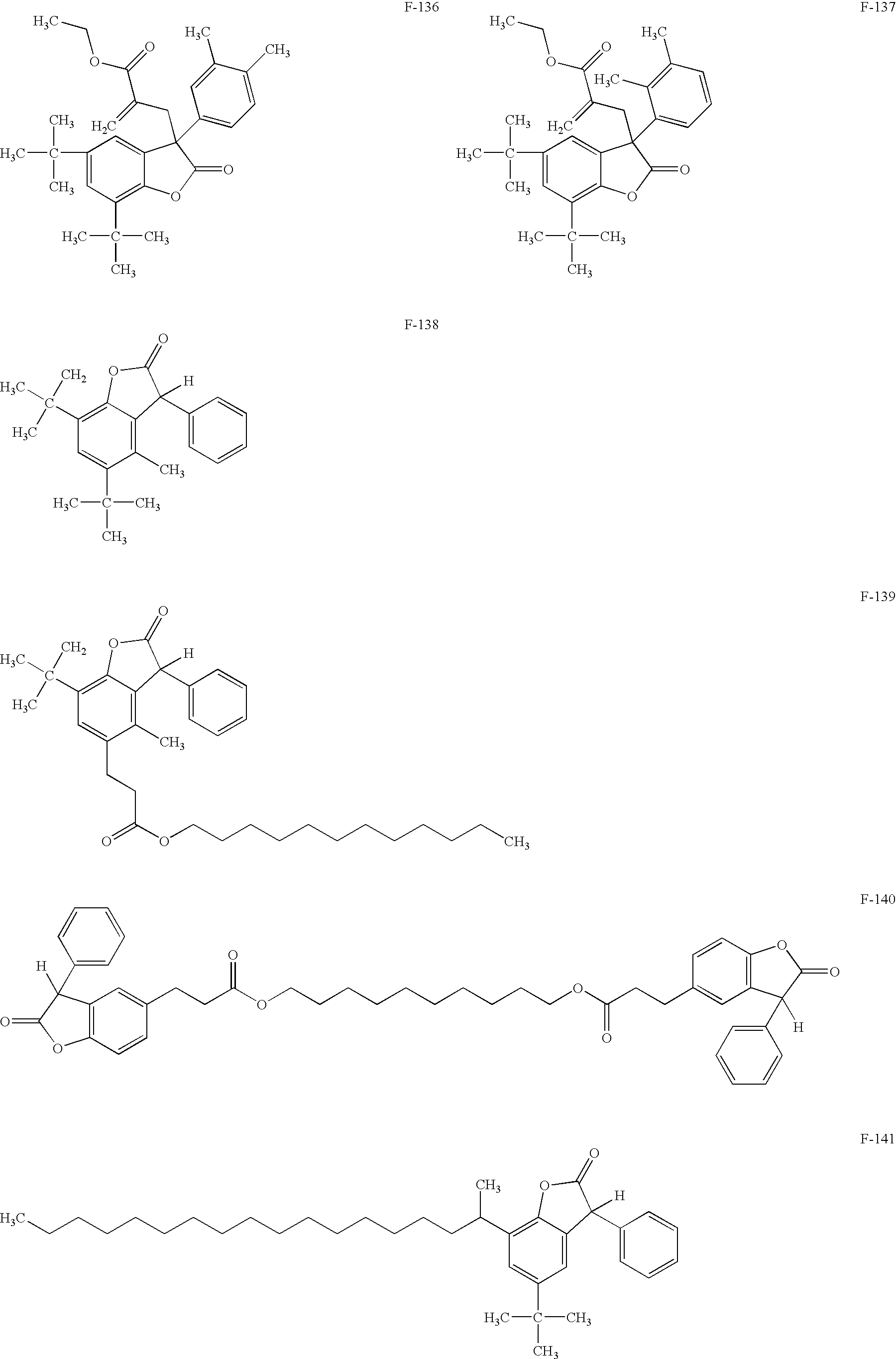

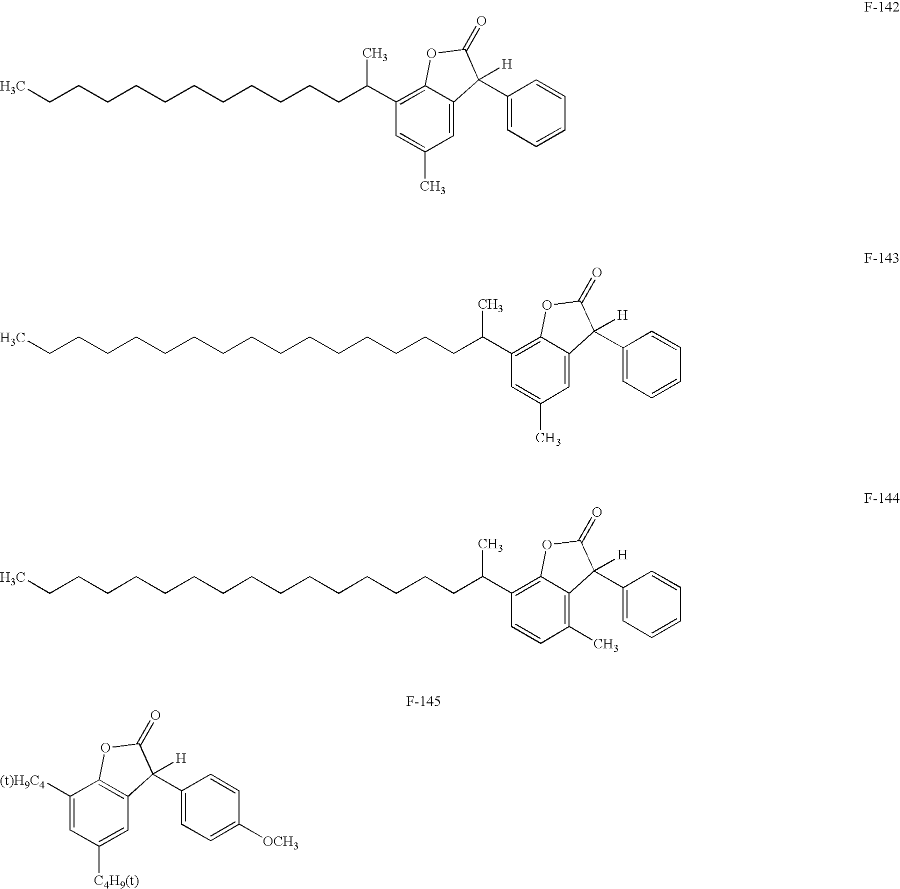

### (Hindered Amine Light-Stabilizer)

Hindered amine light-stabilizers have structure having a bulky organic group such as a bulky branched alkyl group, in the neighborhood of N-atom. These are known compounds, including 2,2,6,6-tetraalkylpiperidine compounds, or acid addition salts thereof or metal complexes thereof, as described, for example, in columns 5-11 of U.S. Pat. No. 4,619,956 as well as columns 3-5 of U.S. Pat. No. 4,839,405. The above compounds are included in the compounds represented by Formula (G) below.

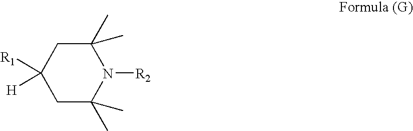

In the Formula (G) R₁ and R₂ each represents H or a substituent. Specific examples of hindered amine light-stabilizers include 4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, 1-(4-t-butyl-2-butenyl)-4-hydroxy-2,2,6,6-tetramethylpiperidine, 4-stearoyloxy-2,2,6,6-tetramethylpiperidine, 1-ethyl-4-salycloyloxy-2,2,6,6-tetramethylpiperidine, 4-methacroyloxy-1,2,2,6,6-pentamethylpiperidine, 1,2,2,6,6-pentamethylpiperidine-4-yl-β(3,5-di-t-butyl-4-hydroxyphenyl)-propionate, 1-benzyl-2,2,6,6-tetramethyl-4-pyperidinyl maleinate, (di-2,2,6,6-tetramethylpiperidine-4-yl)-adipate, 6,6-tetramethylpieridine-4-yl)-sebacate, (di-1,2,3,6-tetramethyl-2,6-diethyl-piperidine-4-yl)-sebacate, (di-1-allyl-2,2,6,6-tetramethylpiperidine-4-yl)-phthalate, 1-acetyl-2,2,6,6-tetramethylpiperidine-4-yl-acetate, trimellitic acid-tri-(2,2,6,6-tetramethylpiperidine-4-yl) ester, 1-acryloyl-4-benzyloxy-2,2,6,6-tetramethylpiperidine, dibutyl-malonic acid-di-(1,2,2,6,6-pentamethyl-piperidine-4-yl)-ester, dibenzyl-malonic acid-di-(1,2,3,6-tetramethyl-2,6-dethyl-piperidine-4-yl)-ester, dimethyl-bis-(2,2,6,6-tetramethylpiperidine-4-oxy)-silane, tris-(1-propyl-2,2,6,6-tetramethylpiperidine-4-yl)-phosphite, tris-(1-propyl-2,2,6,6-tetramethylpiperidine-4-yl)-phosphate, N,N′-bis-(2,2,6,6-tetramethylpiperidine-4-yl)-hexamethylene-1,6-diamine, N,N′-bis-(2,2,6,6-tetramethylpiperidine-4-yl)-hexamethylene-1,6-diacetamide, 1-acetyl-4-(N-cyclohexylacetamido)-2,2,6,6-tetramethyl-piperidine, 4-benzylamino-2,2,6,6-tetramethylpiperidine, N,N′-bis-(2,2,6,6-tetramethylpiperidone-4-yl)-N,N′-dibutyl-adipamide, N,N′-bis-(2,2,6,6-tetramethylpiperidine-4-yl)-N,N′-dicyclohexyl-(2-hydroxypropylene), N,N′-bis-(2,2,6,6-tetramethylpiperidine-4-yl)-p-xylene-diamine, 4-(bis-2-hydroxyethyl)-amino-1,2,2,6,6-pentamethylpiperidine, 4-methacrylamido-1,2,2,6,6-pentaethylpiperidine, and α-cyano-p-methyl-p-[N-(2,2,6,6-tetramethylpiperidine-4-yl)]-amino-acrylate ester.

The examples of preferred hindered amine light-stabilizers include, but are not limited to, HALS-1 and HALS-2 below.

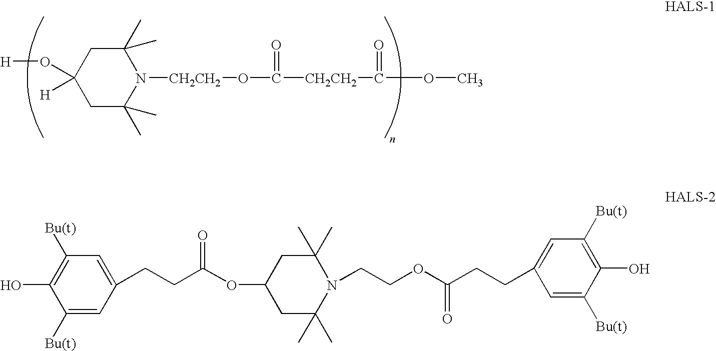

Similarly to the case of the aforementioned cellulose ester, the antioxidant preferably removes the impurities such as residual acid, inorganic salt and organic low-molecule compound that have been carried over from the process of manufacturing, or that have occurred during preservation. More preferable is to have a purity of 99% or more. The amount of residual acid and water is preferably 0.01 through 100 ppm. This reduces thermal deterioration in the melt-casting film formation of the cellulose ester, and improves the film formation stability, the optical property and the mechanical property of the film.

The anti-oxidants may be used one or more species in combination in each, and its content in the cellulose ester film is ordinarily from 0.001 to 10.0 parts by weight, preferably from 0.01 to 5.0 parts by weight, and more preferably 0.1 to 3.0 parts by weight, based on 100 parts by weight of cellulose ester.

It is not preferable, when the amount of the anti-oxidant is too small, effect is not obtained because of low stabilizing work, and when the amount of the anti-oxidant is too small, deterioration of transparency is induced in view of compatibility to cellulose ester and the film becomes fragile.

A partial structure of the anti-oxidant may be introduced in a part of a polymer or may be pendant on the polymer repeatedly, or in a part of a molecular structure of an additive such as a plasticizer, acid scavenger and UV ray absorber.

### (Acid Scavengers)

The acid scavenger is an agent that has the role of trapping the acid (proton acid) remaining in the cellulose ester that is brought in. Also when the cellulose ester is melted, the side chain hydrolysis is promoted due water in the polymer and the heat, and in the case of CAP, acetic acid or propionic acid is formed. It is sufficient that the acid scavenger is able to chemically bond with acid, and examples include but are not limited to compounds including epoxy, tertiary amines, and ether structures.

Examples thereof include epoxy compounds, which are acid trapping agents described in U.S. Pat. No. 4,137,201. The epoxy compounds which are trapping agents include those known in the technological field, and examples include polyglycols derived by condensation such as diglycidyl ethers of various polyglycols, especially those having approximately 8-40 moles of ethylene oxide per mole of polyglycol, diglycidyl ethers of glycerol and the like, metal epoxy compounds (such as those used in the past in vinyl chloride polymer compositions and those used together with vinyl chloride polymer compositions), epoxy ether condensation products, a diglycidyl ether of Bisphenol A (namely 4,4′-dihydroxydiphenyl dimethyl methane), epoxy unsaturated fatty acid esters (particularly alkyl esters having about 4-2 carbon atoms of fatty acids having 2-22 carbon atoms (such as butyl epoxy stearate) and the like, and various epoxy long-chain fatty acid triglycerides and the like (such as epoxy plant oils which are typically compositions of epoxy soy bean oil and the like and other unsaturated natural oils (these are sometimes called epoxidized natural glycerides or unsaturated fatty acids and these fatty acids generally have 12 to 22 carbon atoms)). Particularly preferable are commercially available epoxy resin compounds, which include an epoxy group such as EPON 815c, and other epoxidized ether oligomer condensates such as those represented by the general formula (H).

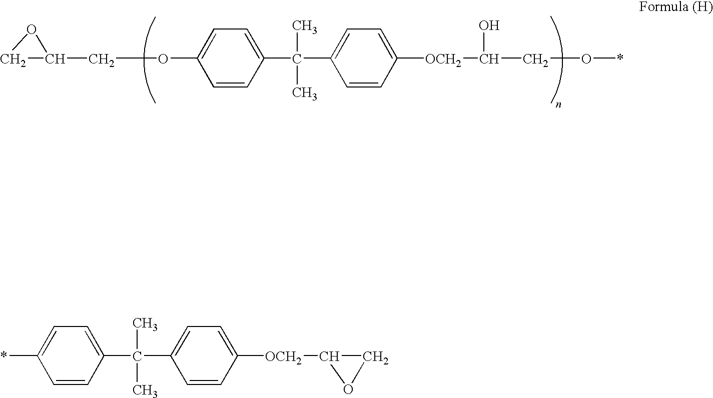

In the formula n is an integer of 0-12. Other examples of acid trapping agents that can be used include those described in paragraphs 87-105 in JP-A H05-194788.

### (Ultraviolet Absorbent)

The ultraviolet absorbent preferably has excellent ultraviolet light absorbance for wavelengths not greater than 370 nm in view of preventing deterioration of the polarizer or the display device due to ultraviolet light, and from the viewpoint of the liquid crystal display it is preferable that there is little absorbance of visible light which has wavelength of not less than 400 nm. Examples of the ultraviolet absorbents include oxybenzophenone compounds, benzotriazole compounds, salicylic acid ester compounds, benzophenone compounds, cyano acrylate compounds nickel complex compounds and the like and benzophenone compounds as well as benzotriazole compounds which have little coloration are preferable. In addition, the ultraviolet absorbents described in JP-A Nos. H10-182621 and H08-337574, and the polymer ultraviolet absorbents described in JP-A H06-148430 and JP-A 2003-113317 may also be used.

Examples of useful benzotriazole based ultraviolet absorbents include 2-(2′-hydroxy-5′-methylphenyl)benzotriazole, 2-(2′-hydroxy 3′,5′-di-tert-butyl phenyl)benzotriazole, 2-(2′-hydroxy 3′-tert-butyl-5′-methylphenyl)benzotriazole, 2-(2′-hydroxy 3′,5′-di-tert-butyl phenyl)-5-chlorobenzotriazole, 2-(2′-hydroxy 3′-(3″,4″,5″,6″-tetrahydrophthalimide methyl)-5′-methylphenyl)benzotriazole, 2,2-methyl bis(4-(1,1,3,3,-tetramethyl butyl)-6-(2H-benzotriazole-2-yl)phenol), 2-(2′-hydroxy-3′-tert-butyl-5′-methylphenyl)-5-chlorobenzotriazole, 2-(2H-benzotriazole-2-yl)-6-(straight chain or side chain dodecyl)-4-methylphenol, mixtures of octyl-3-[3-tert-butyl-4-hydroxy-5-(chloro-2H-benzotriazole-2-yl)phenyl]propionate and 2-ethylhexyl-3-[3-tert-butyl-4-hydroxy-5-(5-chloro-2H-benzotriazole-2-yl)phenyl]propionate, 2-(2H-1-benzotriazol-2-yl)-4,6′-bis(1-methyl-1-phenylethyl)phenol, and 2-(2′-hydroxy-3′-(1-methyl-1-phenylethyl)-5′ (1,1,3,3,-tetramethylbutyl)-phenyl)benzotriazole. It is not limited to these examples.

Commercially available TINUVIN 109, TINUVIN 171, TINUVIN 360, TINUVIN 900 and TINUVIN 928 (each being manufactured by Chiba Specialty Chemical Co., Ltd.), LA-31 (manufactured by Asahi Denka Co., Ltd.), and SUMISORB 250 (produced by Sumitomo Chemical Co., Ltd.) may also be used.

Examples of the benzophenone based compound include 2,4-hydroxy benzophenone, 2,2′-dihydroxy-4-methoxy benzophenone, 2-hydroxy-4-methoxy-5-sulfobenzophenone, bis (2-methoxy-4-hydroxy-5-benzoyl phenyl methane) and the like, but are not limited thereto.

The amount of the ultraviolet absorbent to add in the cellulose ester film is preferably from 0.1 to 20% by weight, more preferably from 0.5 to 10% by weight, and still more preferably from 1 to 5% by weight. Two or more kinds of the ultraviolet absorbent may be used together.

### (Matting Agent)

Fine particles such as a matting agent or the like may be added to the cellulose ester film of the invention in order to impart a matting effect, and fine particles of inorganic compounds as well as fine particles of organic compounds may be used. The particles of the matting agent are preferably as fine as possible and examples of the fine particle matting agent include inorganic fine particles such as those of silicon dioxide, titanium dioxide, aluminum oxide, zirconium oxide, calcium carbonate, kaolin, talc, burned calcium silicate, hydrated calcium silicate, aluminum silicate, magnesium silicate, and calcium phosphate or cross-linked fine particles of polymers. Of these, silicon dioxide is preferable in view of reduced haze in the film. The particles such as the silicon dioxide particles are often surface treated using an organic substance, and this is preferable because it reduces haze in the film.

Examples of the organic compound preferably used in the surface treatment include halosilanes, alkoxysilanes, silazanes, and siloxanes. Particles having a larger average particle diameter have a greater matting effect, while particles having a smaller average particle diameter have excellent transparency. The secondary particles have an average particle diameter in the range of 0.05 to 1.0 μm. The secondary particles preferably have an average particle diameter in the range of 5 to 50 nm, and more preferably 7 to 14 nm. These fine particles are preferable because they create unevenness of 0.01 to 1.0 m in the plane of the cellulose ester film. The amount of the fine particles included in the cellulose ester is preferably 0.005 to 0.3% by weight.

Examples of the silicon dioxide particles include Aerosil 200, 200V, 300, R972, R972V, R974, R202, R812, OX50, TT600, and NAX50, each manufactured by Nippon Aerosil Co., Ltd., and KE-P10, KE-P30, KE-P100, and KE-P150 each manufactured by Nippon Shokubai Co., Ltd., and of these, Aerosil 200V, R972, R972V, R974, R202, R812, NAX50, KE-P30, and KE-P100 are preferred. Two or more of these matting agents may be combined and used. In the case where 2 or more matting agents are used, they may be mixed in a suitably selected proportion. In this case, matting agents which have different particle diameter and quality such as Aerosil 200V and R972V may be used in weight proportions in the range from 0.1:99.9-99.9:0.1

The presence of the fine particles used as the matting agent in the film can also serve another purpose of improving the strength of the film. The presence of the fine particles in the film may also improve the orientation of the cellulose ester itself, which constitutes the optical film of this invention.

### (Retardation Adjusting Agent)

A liquid crystal layer is provided on the orientation film formed on the cellulose ester film of the invention to prepare an optical film with an optical compensation function, which is derived from a combination of the film and the liquid crystal layer with retardation. An optical film may be subjected to polarizing plate modification in order to improve display quality of the liquid crystal display. Aromatic compounds having two or more aromatic rings disclosed in European Patent No. 911,656 A2 can be used as a birefringence adjusting agent. Two or more kinds of the aromatic compounds may be used. The aromatic ring of the aromatic compound is an aromatic hydrocarbon ring or an aromatic heterocyclic ring. The aromatic heterocyclic ring is preferred. The aromatic heterocyclic ring is generally an unsaturated heterocyclic ring. Compounds having a 1,3,5-triazine ring are especially preferred.

### (Melt Cast Method)

The cellulose ester film of the invention is preferably manufactured according to a melt cast method. The melt cast method refers to a method which comprises the steps of heat-melting cellulose ester without using a solvent at temperature exhibiting its fluidity to obtain a fluid cellulose ester and then casting the fluid cellulose ester on a support. Methods for the heat-melting can be classified into a melt extrusion molding method, a press molding method, an inflation method, an ejection molding method, a blow molding method, and an stretch molding method. Of these, the melt extrusion method is excellent in obtaining a cellulose ester film with excellent mechanical strength and excellent surface accuracy.

A preparation method of the cellulose ester film of this invention is illustrated by an example of melt cast method.

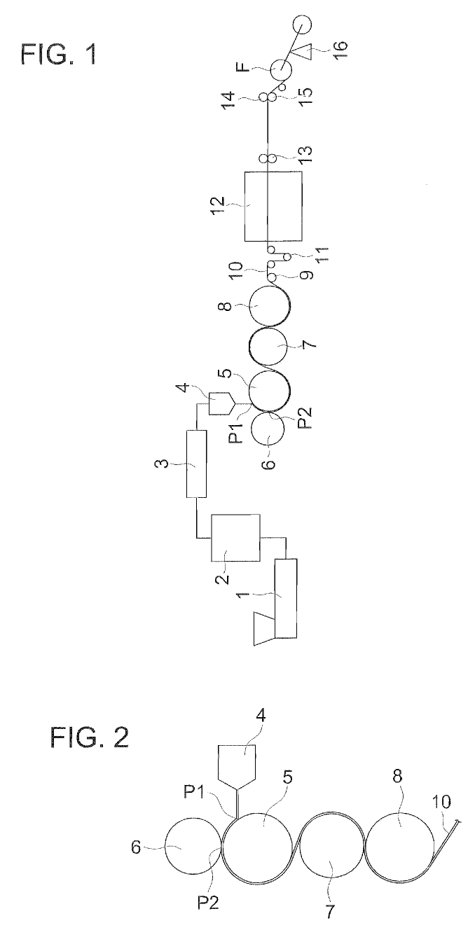

FIG. 1 is a schematic flow sheet showing the overall structure of the apparatus for manufacturing the cellulose acylate film preferably used in this invention. FIG. 2 is an enlarged view of the cooling roll portion from the flow casting die.

In the cellulose acylate film manufacturing method shown in FIG. 1 and FIG. 2, the film material such as cellulose resin is mixed, then melt extrusion is conducted on a first cooling roll 5 from the flow casting die 4 using the extruder 1. The material is be circumscribed on a first cooling roll 5, second cooling roll 7 and third cooling roll 8—a total of three cooling rolls—sequentially. Thus, the material is cooled, solidified and formed into a film 10. With both ends gripped by a stretching apparatus 12, the film separated by a separation roll 9 is stretched across the width and is wound by a winding apparatus 16. To correct flatness, a touch roll 6 is provided. This is used to press the film against the surface of the first cooling roll 5. This touch roll 6 has an elastic surface and forms a nip with the first cooling roll 5. The details of the touch roll 6 will be described later.

The conditions for the cellulose acylate film manufacturing method are the same as those for thermoplastic resins such as other polyesters. The material is preferably dried in advance. A vacuum or depressurized dryer, or dehumidified hot air dryer is used to dry the material until the moisture is reduced to 1000 ppm or less, preferably 200 ppm or less.

For example, the cellulose ester based resin having been dried under hot air, vacuum or depressurized atmosphere is extruded by the extruder 1 and is molten at a temperature of about 200 through 300° C. The leaf disk type filter 2 is used to filter the material to remove foreign substances.

The material is preferably placed in the vacuum, depressurized or insert gas atmosphere to prevent oxidation and decomposition when the material is fed from the feed hopper (not illustrated) to the extruder 1.

When additives such as plasticizer are not mixed in advance, they can be kneaded into the material during the process of extrusion. To ensure uniform mixing, a mixer such as a static mixer 3 is preferably utilized.

The cellulose resin and the additives such as a stabilizer to be added as required are preferably mixed before being molten in this invention. It is more preferred that the cellulose resin and stabilizer should be mixed first. A mixer may be used for mixing. Alternatively, mixing may be completed in the process of preparing the cellulose resin, as described above. It is possible to use a commonly used mixer such as a V-type mixer, conical screw type mixer, horizontal cylindrical type mixer, Henschel mixer and ribbon mixer.

As described above, subsequent to mixing of the film constituting material, the mixture can be directly molten by the extruder 1 to form a film. Alternatively, it is also possible to palletize the film constituting material, and the resultant pellets may be molten by the extruder 1, whereby a film is formed. The following arrangement can also be used: When the film constituting material contains a plurality of materials having different melting points, so-called patchy half-melts are produced at the temperature wherein only the material having a lower melting point is molten. The half-melts are put into the extruder 1, whereby a film is formed. Further, the following arrangement can also be used: If the film constituting material contains the material vulnerable thermal decomposition, a film is directly formed without producing pellets, thereby reducing the frequency of melting. Alternatively, a film is produced after patchy half-melts have been formed, as described above.

The content of the volatile ingredient on the occasion of meting the film constitution materials is not more than 1%, preferably not more than 0.5%, further preferably not more than 0.2%, and still more preferably not more than 0.1%, by weight. The content of the volatile ingredient is determined by the weight reducing caused by heating from 30 to 350° C. measured by using a differential thermogravimeter TG/DTA200, manufactured by Seiko Electronics Inc.

Various types of commercially available extruders can be used as the extruder 1. A melt-knead extruder is preferably utilized. Either a single-screw extruder or a twin-screw extruder can be used. When producing a film directly without pellets being formed from the film constituting material, an adequate degree of mixing is essential. In this sense, a twin-screw extruder is preferably used. A single-screw extruder can be used if the screw is changed into a kneading type screw such as a Madoc screw, Unimelt screw or Dulmadge screw, because a proper degree of mixing can be obtained by this modification. When pellets or patchy half-melts are used as film constituting materials, both the single screw extruder and twin screw extruder can be used.

In the cooling process inside the extruder 1 and after extrusion, oxygen density is preferably reduced by an inert gas such as nitrogen gas or by depressurization.

The preferred conditions for the melting temperature of the film constituting material inside the extruder 1 vary according to the viscosity and discharge rate of the film constituting material as well as the thickness of the sheet to be produced. Generally, it is Tg or more through Tg+130° C. or less with respect to the glass-transition temperature Tg of the film, preferably Tg+10° C. or more through Tg+120° C. or less. The melt viscosity at the time of extrusion is 10 through 100000 poises, preferably 100 through 10000 poises. The retention time of the film constituting material inside the extruder 1 should be as short as possible. It is within five minutes, preferably within three minutes, more preferably within two minutes. The retention time varies according to the type of the extruder and the conditions for extrusion. It can be reduced by adjusting the amount of the material to be supplied, the L/D, the speed of screw and the depth of screw groove.

The shape and speed of the screw of the extruder 1 are adequately selected in response to the viscosity and discharge rate of the film constituting material. In this invention, the shear rate of the extruder 1 is 1/sec. through 10000/sec., preferably 5/sec. through 1000/sec., more preferably 10/sec. through 100/sec.

The extruder 1 that can be used in this invention can be obtained as a plastic molding machine generally available on the market.

The film constituting material extruded from the extruder 1 is fed to the flow casting die 4, and the slit of the flow casting die 4 is extruded as a film. There is no restriction to the flow casting die 4 if it can be used to manufacture a sheet or film. The material of the flow casting die 4 are exemplified by hard chromium, chromium carbonate, chromium nitride, titanium carbide, titanium carbon nitride, titanium nitride, cemented carbide, ceramic (tungsten carbide, aluminum oxide, chromium oxide), which are sprayed or plated. Then they are subjected to surface processing, as exemplified by buffing and lapping by a grinder having a count of #1000 or later planar cutting (in the direction perpendicular to the resin flow) by a diamond wheel having a count of #1000 or more, electrolytic grinding, and electrolytic complex grinding. The preferred material of the lip of the flow casting die 4 is the same as that of the flow casting die 4. The surface accuracy of the lip is preferably 0.5 S or less, more preferably 0.2 S or less.

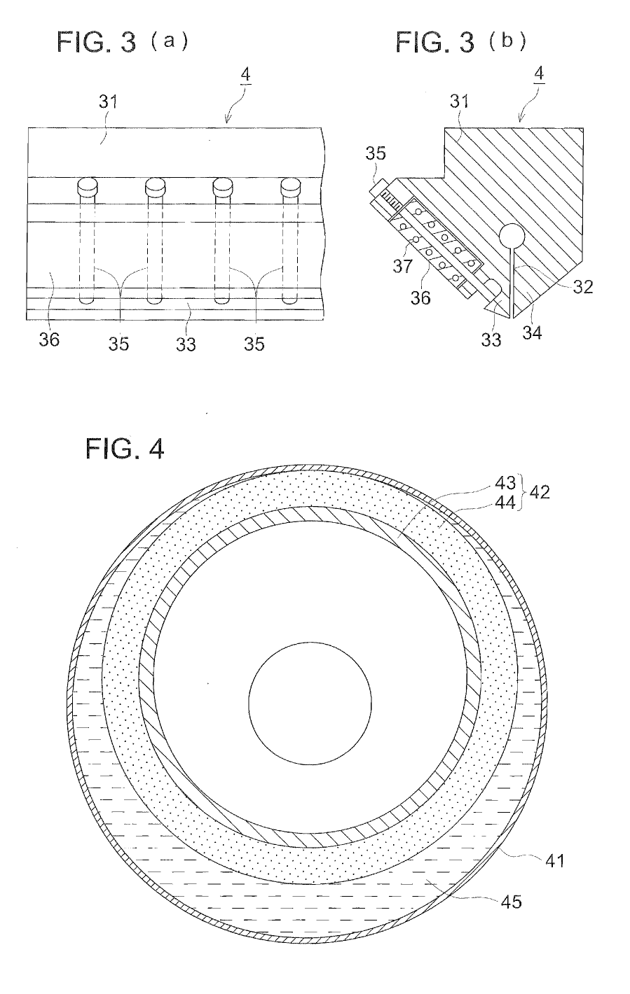

The slit of this flow casting die 4 is designed in such a way that the gap can be adjusted. This is shown in FIG. 3. Of a pair of lips forming the slit 32 of the flow casting die 4, one is the flexible lip 33 of lower rigidity easily to be deformed, and the other is a stationary lip 34. Many heat bolts 35 are arranged at a predetermined pitch across the flow casting die 4, namely, along the length of the slit 32. Each heat bolt 5 includes a block 36 containing a recessed type electric heater 37 and a cooling medium passage. Each heat bolt 35 penetrates the block 36 in the vertical direction. The base of the heat bolt 35 is fixed on the main body of the die 31, and the front end is held in engagement with the outer surface of the flexible lip 33. While the block 36 is constantly cooled, the input of the recessed type electric heater 37 is adjusted to increase or decrease the temperature of the block 36, this adjustment causes thermal extension and contraction of the heat bolt 35, and hence, displacement of the flexible lip 33, whereby the film thickness is adjusted. The following arrangement can also be used: A thickness gauge is provided at predetermined positions in the wake of the die. The web thickness information detected by this gauge is fed back to the control apparatus. This thickness information is compared with the preset thickness information of the control apparatus, whereby the power of the heat generating member of the heat bolt or the ON-rate thereof is controlled by the signal for correction control amount sent from this apparatus. The heat bolt preferably has a length of 20 through 40 cm, and a diameter of 7 through 14 mm. A plurality of heat bolts, for example, several tens of heat bolts are arranged preferably at a pitch of 20 through 40 mm. A gap adjusting member mainly made up of a bolt for adjusting the slit gap by manually movement in the axial direction can be provided, instead of a heat bolt. The slit gap adjusted by the gap adjusting member normally has a diameter of 200 through 1000 μm, preferably 300 through 800 μm, more preferably 400 through 600 μm.

The first through third cooling roll is made of a seamless steel pipe having a wall thickness of about 20 through 30 mm. The surface is mirror finished. It incorporates a tune for feeding a coolant. Heat is absorbed from the film on the roll by the coolant flowing through the tube. Of these first through third cooling rolls, the first cooling roll 5 corresponds to the rotary supporting member of this invention.

In the meantime, the touch roll 6 contact with the first cooling roll 5 has an elastic surface. It is deformed along the surface of the first cooling roll 5 by the pressure against the first cooling roll 5, and forms a nip between this roll and the first roll 5. To be more specific, the touch roll 6 corresponds to the pressure rotary member of this invention.

FIG. 4 is a schematic cross section of the touch roll 6 as an embodiment of this invention (hereinafter referred to as “touch roll A”). As illustrated, the touch roll A is made up of an elastic roller 42 arranged inside the flexible metallic sleeve 41.

The metallic sleeve 41 is made of a stainless steel having a thickness of 0.3 mm, and is characterized by a high degree of flexibility. If the metallic sleeve 41 is too thin, strength will be insufficient. If it is too thick, elasticity will be insufficient. Thus, the thickness of the metallic sleeve 41 is preferably 0.1 through 1.5 mm. The elastic roller 42 is a roll formed by installing a rubber 44 on the surface of the metallic inner sleeve 43 freely rotatable through a bearing. When the touch roll A is pressed against the first cooling roll 5, the elastic roller 42 presses the metallic sleeve 41 against the first cooling roll 5, and the metallic sleeve 41 and elastic roller 42 is deformed, conforming to the shape of the first cooling roll 5, whereby a nip is formed between this roll and the first cooling roll. The cooling water 45 is fed into the space formed inside the metallic sleeve 41 with the elastic roller 42.

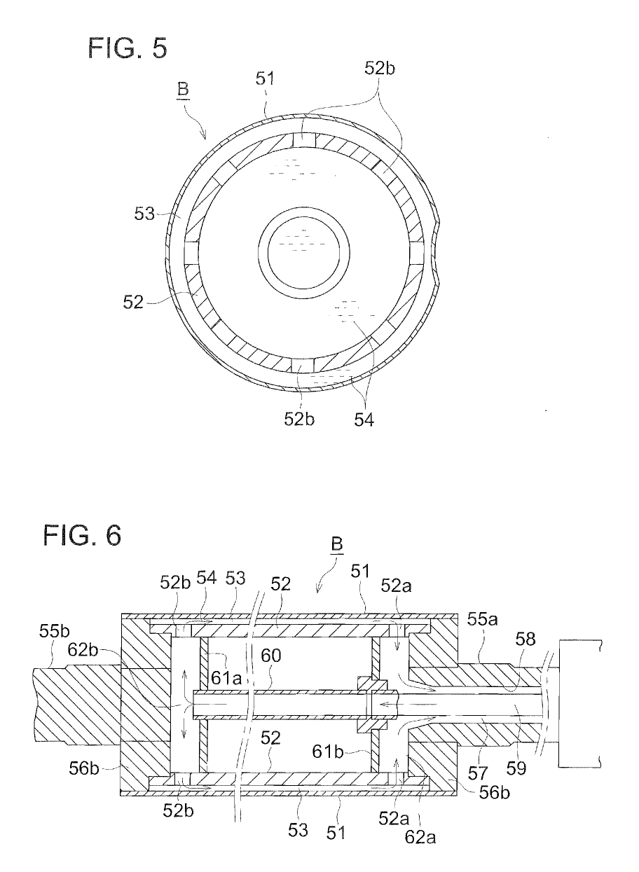

FIG. 5 and FIG. 6 show a touch roll B as another embodiment of the pressure rotary member. The touch roll B is formed of an outer sleeve 51 of flexible seamless stainless steel tube (having a thickness of 4 mm), and metallic inner sleeve 52 of high rigidity arranged coaxially inside this outer sleeve 51. Coolant 54 is led into the space 53 formed between the outer sleeve 51 and inner sleeve 52. To put it in greater details, the touch roll B is formed in such a way that the outer sleeve supporting flanges 56a and 56b are mounted on the rotary shafts 55a and 55b on both ends, and a thin-walled metallic outer sleeve 51 is mounted between the outer peripheral portions of these outer sleeve supporting flanges 56a and 56b. The fluid supply tube 59 is arranged coaxially inside the fluid outlet port 58 which is formed on the shaft center of the rotary shaft 55a and constitutes a fluid return passage 57. This fluid supply tube 59 is connected and fixed to the fluid shaft sleeve 60 arranged on the shaft center which is arranged inside the thin-walled metallic outer sleeve 51. Inner sleeve supporting flanges 61a and 61b are mounted on both ends of this fluid shaft sleeve 60, respectively. A metallic inner sleeve 52 having a wall thickness of about 15 through 20 mm is mounted in the range from the position between the outer peripheral portions of these inner sleeve supporting flanges 61a and 61b to the outer sleeve supporting flange 56b on the other end. For example, a coolant flow space 53 of about 10 mm is formed between this metallic inner sleeve 52 and thin-walled metallic outer sleeve 51. An outlet 52a and an inlet 52b communicating between the flow space 53 and intermediate passages 62a and 62b outside the inner sleeve supporting flanges 61a and 61b are formed on the metallic inner sleeves 52 close to both ends, respectively.

The outer sleeve 51 is designed thin within the range permitted by the thin cylinder theory of elastic mechanics to provide pliability, flexibility and restoring force close to those of the rubber. The flexibility evaluated by the thin cylinder theory is expressed by wall thickness t/roll radium r. The smaller the t/r, the higher the flexibility becomes. The flexibility of this touch roll B meets the optimum condition when t/r≦0.03. Normally, the commonly used touch roll has a roll diameter R=200 through 500 mm (roll radius r=R/2), a roll effective width L=500 through 1600 mm, and an oblong shape of r/L<1. As shown in FIG. 8, for example, when roll diameter R=300 mm and the roll effective width L=1200 mm, the suitable range of wall thickness t is 150×0.03=4.5 mm or less. When pressure is applied to the molten sheet width of 1300 mm at the average linear pressure of 98 N/cm, the wall thickness of the outer sleeve 51 is 3 mm. Then the corresponding spring constant becomes the same as that of the rubber roll of the same shape. The width k of the nip between the outer sleeve 51 and cooling roll in the direction of roll rotation is about 9 mm. This gives a value approximately close to the nip width of this rubber roll is about 12 mm, showing that pressure can be applied under the similar conditions. The amount of deflection in the nip width k is about 0.05 through 0.1 mm.

Though t/r is put t/r≦0.03 in the above, in the case of that roller diameter R is 200 to 500 mm, the range of 2 mm≦t≦5 mm is considerably suitable for practical use since sufficient flexibility can be obtained and thinning of the cylinder can be easily carried out by machine processing. When the thickness is less than 2 mm, highly precise treatment cannot be performed by the elastic deformation on the occasion of processing.

The equivalent value given by the formula 2 mm≦t≦5 mm can be converted by 0.008≦t/r≦0.05 for the general roll diameter. In practice, under the conditions of t/r being nearly equal to 0.03, wall thickness is preferably increased in proportion to the roll diameter. For example, selection is made within the range of t=2 through 3 mm for the roll diameter: R=200; and t=4 through 5 mm for the roll diameter: R=500.

The touch roller A or B is pressed to the first cooling roller 1 by a pressing means not shown in the drawing. The value of F/W (line pressure) is set at a value within the range of from 9.8 to 147 N/cm, wherein F is the pressing force of the pressing means and W is the width of the film in the direction along the rotating axis of the first cooling roller 5. According to the present embodiment, a nip is formed between the touch rolls A and B, and the first cooling roll 5. Flatness should be corrected while the film passes through this nip. Thus, as compared to the cases where the touch roll is made of a rigid body, and no nip is formed between the touch roll and the first cooling roll, the film is sandwiched and pressed at a smaller linear pressure for a longer time. This arrangement ensures more reliable correction of flatness. To be more specific, if the linear pressure is smaller than 10 N/cm, the die line cannot be removed sufficiently. Conversely, if the linear pressure is greater than 147 N/cm, the film cannot easily pass through the nip. This will cause uneven thickness of the film.

The surfaces of the touch rolls A and B are made of metal. This provides smooth surfaces of the touch rolls A and B, as compared to the case where touch rolls have rubber surfaces. The elastic body 44 of the elastic roller 42 can be made of ethylene propylene rubber, neoprene rubber, silicone rubber or the like.

It is important that the film viscosity should lie within the appropriate range when the film is sandwiched and pressed by the touch roll 6 to ensure that the die line is removed sufficiently by the touch roll 6. Further, cellulose ester is known to be affected by temperature to a comparatively high degree. Thus, to set the viscosity within an appropriate range when the cellulose ester film is sandwiched and pressed by the touch roll 6, it is important to set the film temperature within an appropriate range when the cellulose ester film is sandwiched and pressed by the touch roll 6. When the glass-transition temperature of the cellulose acylate film is assumed as Tg, the temperature T of the film immediately before the film is sandwiched and pressed by the touch roll 6 is preferably set in such a way that Tg<T<Tg+110° C. can be met. If the film temperature T is lower than T, the viscosity of the film will be too high to correct the die line. Conversely, if the film temperature T is higher than Tg+110° C., uniform adhesion between the film surface and roll cannot be achieved, and the die line cannot be corrected. This temperature is preferably Tg+10° C.<T<Tg+90° C., more preferably Tg+20° C.<T<Tg+70° C. To set the film temperature within the appropriate range when the cellulose acylate film is sandwiched and pressed by the touch roll 6, one has only to adjust the length L of the nip between the first cooling roll 5 and touch roll 6 along the rotating direction of the first cooling roll 5, from the position P1 wherein the melt pressed out of the flow casting die 4 comes in contact with the first cooling roll 5.

The material preferably used for the first roll 5 and second roll 6 is exemplified by carbon steel, stainless steel and resin in this invention. The surface accuracy is preferably set at a higher level. In terms of surface roughness, it is preferably set to 0.3 S or less, more preferably 0.01 S or less.

The portion from the opening (lip) of the flow casting die 4 to the first roll 5 is reduced to 70 kPa or less in this invention. This procedure has been found out to correct the die line effectively. Pressure reduction is preferably 50 through 70 kPa. There is no restriction to the method of ensuring that the pressure in the portion from the opening (lip) of the flow casting die 4 to the first roll 5 is kept at 70 kPa or less. One of the methods is to reduce the pressure by using a pressure-resistant member to cover the portion from the flow casting die 4 to the periphery of the roll. In this case, the vacuum suction machine is preferably heated by a heater or the like to ensure that a sublimate will be deposited on the vacuum suction machine. In this invention, if the suction pressure is too small, the sublimate cannot be sucked effectively. To prevent this, adequate suction pressure must be utilized.

The film-like cellulose ester based resin in the molten state from the T-die 4 is conveyed in contact with the first roll (the first cooling roll) 5, second cooling roll 7, and third cooling roll 8 sequentially, and is cooled and solidified, whereby an unoriented cellulose ester based resin film 10 is produced in this invention.

The unoriented film 10 cooled, solidified and separated from the third cooling roll 8 by the separation roll 9 is passed through a dancer roll (film tension adjusting roll) 11, and is led to the stretching machine 12, wherein the film is stretched in the lateral direction (across the width) in the embodiment of this invention shown in FIG. 1. This stretching operation orients the molecules in the film.

A known tender or the like can be preferably used to draw the film across the width. Especially when the film is stretched across the width, the lamination with the polarized film can be preferably realized in the form of a roll. The stretching across the width ensures that the low axis of the cellulose acylate film made up of a cellulose ester based resin film is found across the width.

In the meantime, the transmission axis of the polarized film also lies across the width normally. If the polarizing plate wherein the transmission axis of the polarized film and the low axis of the optical film will be parallel to each other is incorporated in the liquid crystal display apparatus, the display contrast of the liquid crystal display apparatus can be increased and an excellent angle of view field is obtained.

The glass transition temperature Tg of the film constituting material can be controlled when the types of the materials constituting the film and the proportion of the constituent materials are made different. When the retardation film is manufactured as a cellulose film, Tg is 120° C. or more, preferably 135° C. or more. In the liquid crystal display apparatus, the film temperature environment is changed in the image display mode by the temperature rise of the apparatus per se, for example, by the temperature rise caused by a light source. In this case, if the Tg of the film is lower than the film working environment temperature, a big change will occur to the retardation value and film geometry resulting from the orientation status of the molecules fixed in the film by stretching. If the Tg of the film is too high, temperature is raised when the film constituting material is formed into a film. This will increase the amount of energy consumed for heating. Further, the material may be decomposed at the time of forming a film, and this may cause coloring. Thus, Tg is preferably kept at 250° C. or less.

The process of cooling and relaxation under known thermal setting conditions can be applied in the stretching process. Appropriate adjustment should be made to obtain the characteristics required for the intended optical film.

The fluctuation in the thickness of the cellulose resin film is preferably kept within the range of ±3%, preferably ±1%. To achieve the aforementioned object, it is effective to use the method of stretching in the biaxial directions perpendicular to each other. The magnification rate of stretching in the biaxial directions perpendicular to each other is preferably 1.0 through 2.0 times in the casting direction, and 1.01 through 2.5 times across the width. Stretching in the range of 1.01 through 1.5 times in the casting direction and in the range of 1.05 through 2.0 times across the width will be more preferred to get a retardation value.

After stretching, the end of the film is trimmed off by a slitter 13 to a width predetermined for the product. Then both ends of the film are knurled (embossed) by a knurling apparatus made up of an emboss ring 14 and back roll 15, and the film is wound by a winder 16. This arrangement prevents sticking in the cellulose acylate film F (master winding) or scratch. Knurling can be provided by heating and pressing a metallic ring having a pattern of projections and depressions on the lateral surface. The gripping portions of the clips on both ends of the film are normally deformed and cannot be used as a film product. They are therefore cut out and are recycled as a material.

At the time of manufacturing the phase difference film of this invention, such a functional layer as an antistatic layer, hard coated layer, lubricating layer, adhesive layer, antiglare layer or barrier layer can be coated before and/or after drawing. In this case, various forms of surface treatment such as corona discharging, plasma treatment and medical fluid treatment can be provided wherever required.

The compositions including the cellulose resin with additives having different concentration such as the aforementioned plasticizer, ultraviolet absorber, and matting agent can be extruded together to manufacture the optical film of lamination structure. For example, it is possible to manufacture an optical film having a structure of a skin layer core layer/skin layer. For example, a large amount of matting agent can be put into the skin layer, or the matting agent can be put into the skin layer alone. A greater amount of plasticizer and ultraviolet absorber can be put into the core layer than into the skin layer. Alternatively, they can be put into the core layer alone. Further, different types of the plasticizer and ultraviolet absorber can be put into the core layer and skin layer. For example, the skin layer can be impregnated with a plasticizer and/or ultraviolet absorber of low volatility, and the core layer can be impregnated with the plasticizer of excellent plasticity, or with an ultraviolet absorber of superb ultraviolet absorbency. The glass transition temperature of the skin layer can be different from that of the core layer. The glass transition temperature of the core layer is preferably lower than that of the skin layer. In this case, the glass transition temperatures of the scanning and core layers are measured and the average value calculated from these volume fractions can be defined as the aforementioned glass transition temperature Tg, whereby the same procedure is used for handling. Further, the viscosity of the melt including the cellulose ester at the time of melt casting can be different between the skin layer and core layer. The viscosity of the skin layer can be greater than that of the core layer, or the viscosity of the core layer can be equal to or greater than that of the skin layer.

When the cellulose ester film of the invention is used as a polarizing plate protecting film, the thickness of the polarizing plate protecting film is preferably from 10 to 500 μm, more preferably from 20 to 150 μm, still more preferably from 35 to 120 μm, and most preferably from 25 to 90 μm.

In the cellulose ester film of the invention, variation of the film dimension is preferably within the range of ±1.0%, more preferably within the range of +0.5%, and still more preferably within the range of +0.1%, at 80° C. and at 90% RH for 24 hours, based on the film dimension after the film has been allowed to stand at 23° C. and at 55% RH for 24 hours.

When a delayed or advanced phase axis of cellulose ester film is present in a plane of the film and the angle between the delayed or advanced phase axis and the mechanical direction of the film is defined as θ1, θ1 is preferably from −1 to +10, and more preferably from −0.5 to +0.50° This θ1 can be defined as an orientation angle, and determined employing an automatic birefringence meter KOBRA-21ADH (produced by Oji Scientific Instruments)

The above range of θ1 provides high luminance, minimized light leakage, and high color reproduction of displayed images in a color liquid crystal display. <<Polarization Plate>>

When the cellulose ester film relating to the invention is used as a polarization plate protection film, the polarization plate can be produced by a usual method without any limitation. It is preferable that the cellulose ester film of the invention is saponified by alkaline treatment on the backside thereof and the treated film is pasted on at least one side of a polarization membrane, which is prepared by immersing and stretching in an iodine solution, using a completely saponified poly(vinyl alcohol). On the other side of the membrane, the cellulose ester film or another polarization plate protection film may be either used. As the polarization plate protection film to be used on the side other than that on which the cellulose ester film of the invention is used, films available on the market can be used. For instance, KC8UX2M, KC4UX, KC5UX, KC4UY, KC8UY, KC12UR, KC8UCR-3, KC8UCR-4, KC4FR-1, KC8UY-HA and KC8UX-RHA, each manufactured by Konica Minolta Inc., are preferably usable as the cellulose ester film available on the market. Optical compensation film serving also as the polarization plate protection film which has an optical anisotropic layer formed by orientating a liquid crystal compound such as discotic liquid crystals, rod-shaped liquid crystals and cholesteric liquid crystals is also preferably used. For example, the optical anisotropic layer can be formed by the method described in JP A 2003-98348. A polarization plate having excellent flatness and stably viewing angle expanding effect can be obtained by combination use of such the optical compensation film with the cellulose ester film of the invention. Furthermore, a film other than the cellulose ester such a cyclic olefin resin, an acryl resin a polyester may be used as the polarization plate protection film on the other side of the polarization plate.

Treatments for easily pasting such as those described in JP A H06-94915 and JP A H06-118232 may be applied instead of the alkali treatment for producing the polarization plate.

The polarization membrane as the principal constitution element of the polarization plate is an element through which light polarized in a certain direction only can be passed. Present known typical polarization membrane is a poly(vinyl alcohol) type polarization film which includes a poly(vinyl alcohol) type film dyed by iodine and that dyed by a dichromatic dye. As the polarization membrane, one prepared by forming a film from an aqueous solution of poly(vinyl alcohol) and mono-axially stretching and dying the film or one prepared by mono-axially stretching after dying and then treating by a boron compound for giving durability are used. The thickness of the polarization membrane is from 5 to 40 μm, preferably from 5 to 30 μm, and particularly preferably from 5 to 20 μm. The one side of the cellulose ester film of the invention is pasted onto the surface of the polarization membrane to prepare the polarization plate. The pasting is preferably carried out by using an aqueous adhesive mainly composed of completely saponified poly(vinyl alcohol).

The polarization membrane is stretched in mono-axial direction (usually in the length direction). Consequently, the membrane is shrunken in the stretched direction (usually in the length direction) and elongated in the direction perpendicular to the stretched direction (usually in the width direction) when the film is placed under a high temperature and high humidity condition. The elongation and shrinking of the polarization plate is increased accompanied with decreasing of the thickness of the polarization plate protection film and the shrinking in the stretched direction of the polarization membrane is particularly remarkable. The stretching direction of the polarization membrane is usually pasted so as to agree the stretching direction thereof with the casting direction (MD direction) of the protection film. Therefore, it is important to inhibit the shrinkage in the casting direction when the thickness of the protection film is decreased. The cellulose ester film of the invention is suitable for such the polarization plate protection film since the film is excellent in the dimensional stability.

Wave-shaped ununiformity is not increased even after the aging test at 60° C. and 90% RH, and the viewing angle is not varied and high visibility can be provided after the aging test even when the polarization plate has the optical compensation film on the backside.

The polarization plate is constituted by the polarization membrane and the protection film for protecting the both surfaces of the membrane. The polarization plate can be constituted by pasting the protection film on one side and a separation film on the other side of the membrane. The protection film and the separation film are used for protecting the polarization plate in the course of forwarding and inspection process. In such the case, the separation film is pasted on the side of the polarization plate opposite to the side to be pasted to the liquid crystal plate for protecting the surface of the polarization plate. The separate film is used on the side of the polarization plate to be pasted to the liquid crystal plate to cover the adhesive layer for pasting polarization plate to the liquid crystal plate.

### <<Liquid Crystal Display>>

Various kinds of liquid crystal display of the invention can be produced by applying the polarization plate using the cellulose ester film of the invention to liquid crystal displays. The polarization plate can be applied for liquid crystal displays having various driving systems such as STN, TN, OCB, HAN, VA (MVA, PVA) and IPS, and preferably VA (MVA, PVA) type liquid crystal display. Particularly, the liquid crystal display reduced in the variation depending on the environmental condition and in the light leaking at the circumference of the displaying screen can be obtained even when the display is a large screen display of 30-type or more. Moreover, effects that the unevenness in the color and the wave-like unevenness are reduced and eyestrain is not caused even after watching for long time are obtained.

### EXAMPLES

The best mode for carrying out the invention is described in detail below but the invention is not limited to that. In the followings, “part” is “part by weight”.

Materials to be used are described below.

### Synthesis Example 1

### Synthesis of Cellulose Ester C-1

Synthesis was carried out referring Example B described in JP A H06-501040.

The following mixed solutions A to E were prepared.

A: Propionic acid/Concentrated sulfuric acid=5/3 (in weight)

B: Acetic acid/Purified water=3/1 (in weight)

C: Acetic acid/Purified water=1/1 (in weight)

D: Acetic acid/Purified water/Magnesium carbonate=12/11/1 (in weight)

E: An aqueous solution prepared by dissolving 0.5 moles of potassium carbonate and 1.0 mole of citric acid in 14.6 kg of purified water

Into a reaction vessel having a mechanical stirrer, 100 parts by weight of cellulose purified from cotton, 317 parts by weight of acetic acid and 67 parts by weight of propionic acid were charged and stirred for 30 minutes at 55° C. The temperature in the reaction vessel was cooled by 30° C. and 2.3 parts by weight of Solution A was added and stirred for minutes. The temperature in the reaction vessel was cooled by −20° C. and 100 parts by weight of acetic anhydride and 25 parts by weight of propionic acid anhydride were added and stirred for 1 hour. The temperature in the reaction vessel was raised by 10° C. and 45 parts by weight of Solution A was added and then the temperature was raised by 60° C. and the content of the vessel was stirred for 3 hours. After that, 533 parts by weight of Solution B was added and stirred for 17 hours. Furthermore, 333 parts by weight of Solution C and 730 parts by weight of Solution D were added and stirred for 15 minutes. Then impurity was eliminated by filtration and water was added to the contents of the vessel until completion of formation of precipitation while stirring and the formed white precipitation was filtered. Thus obtained white solid substance was washed by purified water until the washing water becomes neutral. To thus obtained wet substance, 1.8 parts by weight of Solution E was added. Then the substance was dried at 70° C. for 3 hours to prepare cellulose acetate propionate.

The substitution degree of thus obtained was calculated according to ASTM-D817-96. The substitution degree of acetyl group and that of propionyl group were each 1.9 and 0.7, respectively. The weight average molecular weight measured by GPC under the following conditions was 200,000.

### [GPC Measuring Condition]

Solvent: Tetrahydrofuran

Apparatus: HLC-8220 (manufactured by Tosoh Corp.)

Column: TSK-GEL SuperHM-M (manufactured by Tosoh Corp.)

Column temperature: 40° C.

Sample temperature: 0.1% by weight

Injection amount: 10 μl

Flowing amount: 0.6 ml/min

Calibration curve: A calibration curve was used which was prepared by using nine samples within the range of Mw of from 2,560,000 to 580 of standard polyethylene PS-1 (manufactured by Polymer Laboratories).

### Synthesizing Example 2

### Synthesis of Example Compound

### Exemplified Ester Compound 1-7

Seventy six parts by weight of triethylene glycol, 535 parts by weight of phenyl salicylate and 1 part by weight of potassium carbonate were mixed and heated at 155° C. for 3 hours under a pressure of 1.33×10⁴ Pa for distilling out 188 parts by weight of phenol. The pressure in the vessel was restored to atmosphere pressure and the temperature was cooled by 100° C., and then 0.5 parts by weight of concentrated sulfuric acid and 225 parts by weight of acetic anhydride was added and stirred for 1 hour at 100° C. After completion of the reaction, 100 parts by weight of toluene was added and cooled by ice. Thus white crystals were formed. The crystals were filtered and washed twice by purified water and dried at 30° C. under reduced pressure to obtain 244 parts by weight of white crystals with a yield of 56%. The molecular weight of the compound was 400.

### Synthesis Example 3

### Synthesis of Example Compound

### Exemplified Ester Compound 1-40

One hundred and eighty parts by weight of monomethyl phthalate, 180 parts by weight of toluene, 1 part by weight of dimethylformamide and 130 parts by weight of thionyl chloride were mixed and stirred for 30 minutes at 60° C. The mixture was cooled after completion of reaction and pale yellow liquid was obtained.

The above obtained pale yellow liquid was dropped into a solution composed of 31 parts by weight of glycerol, 101 parts by weight of triethylamine and 200 parts by weight of ethyl acetate spending 30 minutes at room temperature and stirred for 1 hour. White crystals thus formed were filtered and the filtrate was washed by adding purified water. Then the organic phase was separated and the organic solvent was distilled out under reduced pressure to obtain 116 parts by weight of white crystals with a yield of 60%. The molecular weight of this compound was 579.

### Synthesis Example 4

### Synthesis of Example Ester Compound

### Exemplified Compound 1-45

A mixed solution of 45 parts by weight of 2-ethyl-2-hydroxymethyl-1,3-propanediol, 190 parts by weight of pyridine and 450 parts by weight ethyl acetate was held at 80° C. and 330 parts by weight of acetylsalicyloyl chloride was dropped into the solution spending 30 minutes while stirring and then further stirred for 3 hours. After completion of reaction, the reacting liquid was cooled by room temperature and precipitation was eliminated by filtration and the filtrate was washed by adding ethyl acetate and purified water. After that, the organic phase was separated and ethyl acetate was removed by distillation to obtain the objective compound. The molecular weight of this compound was 606.

### Synthesis Example 5

### Synthesis of Example Ester Compound

### Exemplified Compound 1-47

A mixed solution of 45 parts by weight of 2-ethyl-2-hydroxymethyl-1,3-propanediol, 190 parts by weight of pyridine and 450 parts by weight ethyl acetate was held at 80° C. and 290 parts by weight of methoxybenzoyl chloride was dropped into the solution spending 30 minutes while stirring and then further stirred for 3 hours. After completion of reaction, the reacting liquid was cooled by room temperature and precipitation was eliminated by filtration and the filtrate was washed by adding ethyl acetate and purified water. After that, the organic phase was separated and ethyl acetate was removed by distillation to obtain the objective compound. The molecular weight of this compound was 537.

### Synthesis Example 6

### Synthesis of Example Ester Compound

### 1-Exemplified Compound 60

One hundred and thirty six parts by weight of pentaerythritol, 1070 parts by weight of phenyl salicylate and 2 parts by weight of potassium carbonate were mixed and heated at 155° C. under a pressure of 1.333×10⁻² MPa for 3 hours for distilling out 375 parts by weight of phenol. The pressure in the reaction vessel was returned to ordinary pressure and the content was cooled by 100° C. and then 1 part by weight of concentrated sulfuric acid and 450 parts by weight of acetic anhydride were added and stirred for 1 hour at 100° C. After completion of reaction, 2,000 parts by weight of toluene was added and cooled by ice. Thus white crystals were formed. The white crystals were filtered and washed twice by purified water and dried at 30° C. under reduced pressure to obtain 667 parts by weight of the white crystals with a yield of 85%. The molecular weight of this compound was 785.

### Synthesis Example 7

### Synthesis of Example Ester Compound

### Exemplified Compound 1-81

The objective compound was obtained by the same manner as in Synthesis Example 4 except that 360 parts by weight of 3,4,5-trimethoxybenzoyl chloride was used in place of acetylsalicyloyl chloride. The molecular weight of this compound was 717.

### Synthesis Example 8

### Synthesis of Example Ester Compound

### Exemplified Compound 1-83

A mixture solution of 45 parts by weight of trimethylolpropane and 101 parts by weight of triethylamine was held at 100° C. and 71 parts by weight of benzoyl chloride was dropped spending 30 minutes while stirring and the solution was further stirred for 1 hour. After completion of reaction, the solution was cooled by room temperature and precipitated matter was removed by filtration. The filtrate was washed by adding ethyl acetate and purified water and the organic phase was separated. Ethyl acetate was distilled out from the organic phase to obtain the objective compound. The molecular weight of this compound was 446.

### Synthesis Example 9

### Synthesis of Example Ester Compound

### Exemplified Compound 1-87

To a mixture solution of 30 parts by weight of glycerol, 101 parts by weight of triethylamine and 2,000 parts by weight of ethyl acetate, 157 parts by weight of phenyl chloroformate was dropped spending 30 minutes at room temperature and further stirred for 1 hour. After completion of reaction, the solution was cooled by room temperature and precipitated matter was removed by filtration. The filtrate was washed by adding ethyl acetate and purified water and organic phase was separated. Ethyl acetate was removed by distillation under reduced pressure to obtain the objective compound. The molecular weight of this compound was 452.

### Synthesis Example 10

### Synthesis of Example Ester Compound

### Exemplified Compound 1-88

To a mixture solution of 45 parts by weight of 2-ethyl-2-hydroxymethyl-1,3-propanediol, 101 parts by weight of triethylamine and 2,000 parts by weight of ethyl acetate, 157 parts by weight of phenol chloroformate was dropped spending minutes at room temperature and further stirred for 1 hour. After completion of reaction, the solution was cooled by room temperature and precipitated matter was removed by filtration. The filtrate was washed by adding ethyl acetate and purified water and organic phase was separated. Ethyl acetate was removed by distillation under reduced pressure to obtain the objective compound. The molecular weight of this compound was 494.

### Synthesis Example 11

### Synthesis of Example Ester Compound

### Exemplified Compound 1-89

To a mixture solution of 30 parts by weight of ethylene glycol, 101 parts by weight of triethylamine and 2,000 parts by weight of ethyl acetate, 270 parts by weight of 3,5-diacetoxybenzoyl chloride was dropped spending 30 minutes at room temperature and further stirred for 1 hour. After completion of reaction, the solution was cooled by room temperature and precipitated matter was removed by filtration. The filtrate was washed by adding ethyl acetate and purified water and organic phase was separated. Ethyl acetate was removed by distillation under reduced pressure to obtain the objective compound. The molecular weight of this compound was 502.

### Synthesis Example 12

### Synthesis of Example Polyester Compound

### Compound A1

Into a reaction vessel on which a condenser was attached, 236 parts by weight of ethylene glycol, 683 parts by weight of 1,4-butylene glycol, 1,180 parts by weight of succinic acid and 0.03 parts by weight of tetrabutyltitanate were charged and dehydrating condensation reaction was carried out at 140° C. for 2 hours, 220° C. for 2 hours and 200° C. for 20 hours without the condenser to obtain aliphatic polyester compound A1 having a acid number average molecular weight of 2,000. The average carbon number of the diol used in the above was 3.33 and that of the dicarboxylic acid was 4.

### Synthesis Example 13

### Synthesis of Example Polyester Compound

### Compound A2

Into a reaction vessel on which a condenser was attached, 699 parts by weight of ethylene glycol, 1,180 parts by weight of succinic acid and 0.03 parts by weight of tetrabutyltitanate were charged and the same operation as in Synthesis example 1 was carried out to obtain aliphatic polyester compound A2 having a number average molecular weight of 2,000. The average carbon number of the diol used in the above was 2 and that of the dicarboxylic acid was 4.

### Synthesis Example 14

### Synthesis of Example Polyester Compound

### Compound A3

Into a reaction vessel on which a condenser was attached, 702 parts by weight of ethylene glycol, 885 parts by weight of succinic acid, 365 parts by weight of adipic acid and 0.03 parts by weight of tetrabutyltitanate were charged and the same operation as in Synthesis example 1 was carried out to obtain aliphatic polyester compound A3 having a number average molecular weight of 2,000. The average carbon number of the diol used in the above was 2 and that of the dicarboxylic acid was 5.

### Synthesis Example 15

### Synthesis of Example Polyester Compound

### Compound A4

Into a reaction vessel on which a condenser was attached, 631 parts by weight of ethylene glycol, 1,062 parts by weight of succinic acid, 146 parts by weight of adipic acid and 0.03 parts by weight of tetrabutyltitanate were charged and the same operation as in Synthesis example 1 was carried out to obtain aliphatic polyester compound A4 having a number average molecular weight of 2,000. The average carbon number of the diol used in the above was 2.2 and that of the dicarboxylic acid was 4.2.

### Synthesis Example 16

### Synthesis of Example Polyester Compound

### Compound A5

Into a reaction vessel on which a condenser was attached, 226 parts by weight of ethylene glycol, 656 parts by weight of 1,4-butylene glycol, 1,180 parts by weight of succinic acid and 0.03 parts by weight of tetrabutyltitanate were charged and the same operation as in Synthesis example 1 was carried out to obtain aliphatic polyester compound AS having a number average molecular weight of 4,000. The average carbon number of the diol used in the above was 3.33 and that of the dicarboxylic acid was 4.

### Synthesis Example 17

### Synthesis of Example Polyester Compound

### Compound A6

Into a reaction vessel on which a condenser was attached, 246 parts by weight of ethylene glycol, 721 parts by weight of 1,4-butylene glycol, 1,180 parts by weight of succinic acid and 0.03 parts by weight of tetrabutyltitanate were charged and the same operation as in Synthesis example 1 was carried out to obtain aliphatic polyester compound AG having a number average molecular weight of 1,200. The average carbon number of the diol used in the above was 3.33 and that of the dicarboxylic acid was 4.

### Synthesis Example 18

### Synthesis of Example Polyester Compound

### Compound A7

Into a reaction vessel on which a condenser was attached, 648 parts by weight of ethylene glycol, 58 parts by weight of diethylene glycol, 1,121 parts by weight of succinic acid, 83 parts by weight of terephthalic acid and 0.03 parts by weight of tetrabutyltitanate were charged and the same operation as in Synthesis example 1 was carried out to obtain aromatic copolyester compound A7 having a number average molecular weight of 1,500. The average carbon number of the diol used in the above was 2.1 and that of the dicarboxylic acid was 4.

### Example 1

One hundred parts by weight of cellulose ester C-1 was dried in air under atmosphere pressure at 130° C. for 2 hours. To the cellulose ester resin, 15 parts by weight of the inventive ester compound 1-89, 5 parts by weight of the polyester compound A7 and 1 part by weight of antioxidant compound 1 were added and the mixture was melted and mixed at 230° C. and pelletized by a biaxial extruder. Thus obtained pellets were melted in nitrogen atmosphere and extruded through the T-type extrusion die 4 onto the first cooling roller 5 in FIG. 1, and formed into a film by nipping between the first cooling roller 5 and the touching roller 6. The length L from the position P1 where the resin extruded from the die 4 was touched to the first cooling roller 5 to the end position P2 of nipping in the upper stream direction of the first cooling roller 5 and the touching roller 6 along the circumference of the cooling roller 5 was set at 20 mm. The line pressure of the touching roller 6 to the first cooling roller 5 was 14.7 N/cm.

The extruding amount and receiving speed were controlled so that the thickness of the film was made to 80 μm. The width and the length of the finished film were each 1,800 mm and 3,200 m, respectively. Knurling having a width of 10 mm and a height of 5 μm was applied on both side edges of the film. The film was winded up onto a winding core at a winding tension of 220 N/m and a taper of 40%. Thus Sample 1-1 of the invention was prepared.

Samples 1-2 to 1-25 and Comparative Samples 1-20 to 1-were prepared in the same manner as above except that the kind and the amount of the ester compound, polyester compound, antioxidant and acid scavenger as the additive were changed as described in Table 1.

Moreover, Comparative cellulose ester optical film 1-31 was prepared by a solution-casting method using the following dope containing solvents.

| | | |
|---|---|---|
| Cellulose ester C-1 | 100 | parts |
| Methylene chloride | 400 | parts |
| Ethanol | 75 | parts |
| Ester compound 1-45 | 15 | parts |
| Compound 1 | 1 | part |

The above composition was charged into a closed vessel and completely dissolved at 80° C. while stirring and applying pressure to prepare a dope composition.

The above dope composition was filtered and cooled for holding at 33° C. and uniformly cast on a stainless steel band. The solvent was evaporated until the dope composition could be peeled from the stainless steel band. The film was peeled off from the stainless steel band and dried while transferring by many rollers and winded up after applying knurling having a height of 10 μm. Thus comparative cellulose ester film sample 1-31 having a thickness of 80 μm, a width of 1.8 m and a length of 3,200 m was obtained.

Materials used in Example were as follows.

PFR was bought from Asahi Denka Kogyo CO., Ltd. IRGANOX 1010 was bought from Ciba Specialty Chemicals Inc. La-52 and LA-63P were bought from Asahi Denka Kogyo Co., Ltd. SUMILIZER GP was bought from Sumitomo Chemical Co., Ltd.

TABLE 1

| | | | | Polyester | | | | |
|---|---|---|---|---|---|---|---|---|
| | Ester compound | | | compound | | Additive 1 | | |
| | | Adding | | | Adding | | Adding | |
| | | amount | | | amount | | amount | |
| | | (Part | Distribution | | (Part | | (Part | |
| Sample | | by | co- | | by | | by | Re- |
| No. | Kind | weight) | efficient | Kind | weight) | Kind | weight) | marks |
| 1-1 | 1-89 | 15 | 1.81 | A7 | 5 | Compound 1 | 1 | Inv. |
| 1-2 | 1-7 | 15 | 2.74 | A1 | 5 | Compound 10 | 1 | Inv. |
| 1-3 | 1-41 | 15 | 3.81 | A7 | 5 | Compound 1 | 1 | Inv. |
| 1-4 | 1-40 | 15 | 4.51 | A3 | 5 | Compound 1 | 1 | Inv. |
| 1-5 | 1-45 | 15 | 4.92 | A2 | 5 | Compound 1 | 1 | Inv. |
| 1-6 | 1-45 | 15 | 4.92 | — | — | Compound 1 | 1 | Inv. |
| 1-7 | 1-47 | 15 | 5.79 | A4 | 5 | Compound 15 | 1 | Inv. |
| 1-8 | 1-47 | 15 | 5.79 | A5 | 5 | Compound 30 | 1 | Inv. |
| 1-9 | 1-60 | 15 | 5.16 | A6 | 5 | Compound 1 | 1 | Inv. |
| 1-10 | 1-81 | 15 | 5.03 | A7 | 5 | Compound 1 | 1 | Inv. |
| 1-11 | 1-81 | 15 | 5.03 | A2 | 5 | Compound 1 | 1 | Inv. |
| 1-12 | 1-81 | 15 | 5.03 | — | — | Compound 1 | 1 | Inv. |
| 1-13 | 1-81 | 15 | 5.03 | A7 | 5 | Compound 1 | 0.5 | Inv. |
| 1-14 | 1-81 | 15 | 5.03 | A7 | 5 | Compound 1 | 0.5 | Inv. |
| 1-15 | 1-81 | 15 | 5.03 | A2 | 5 | Compound 1 | 0.5 | Inv. |
| 1-16 | 1-81 | 15 | 5.03 | A7 | 5 | LA-52 | 0.5 | Inv. |
| 1-17 | 1-81 | 15 | 5.03 | A7 | 5 | LA-52 | 0.5 | Inv. |
| 1-18 | 1-81 | 15 | 5.03 | A2 | 5 | LA-52 | 0.5 | Inv. |
| 1-19 | 1-81 | 15 | 5.03 | A2 | 5 | LA-63P | 0.5 | Inv. |
| 1-20 | 1-81 | 15 | 5.03 | A2 | 5 | Compound 1 | 0.5 | Inv. |
| 1-21 | 1-81 | 15 | 5.03 | A2 | 5 | Compound 1 | 0.5 | Inv. |
| 1-22 | 1-83 | 15 | 6.16 | A7 | 5 | Compound 1 | 1 | Inv. |
| 1-23 | 1-88 | 15 | 7.22 | A7 | 5 | Compound 1 | 1 | Inv. |
| 1-24 | 1-45 | 15 | 4.92 | A2 | 5 | Comparative | 1 | Inv. |
| | | | | | | Compound 2 | | |
| 1-25 | 1-45 | 15 | 4.92 | A2 | 5 | Comparative | 0.5 | Inv. |
| | | | | | | Compound 2 | | |
| 1-26 | Comparative | 15 | 7.63 | — | — | Comparative | 1 | Comp. |
| | compound 1 | | | | | Compound 2 | | |
| 1-27 | Comparative | 15 | 7.63 | A2 | 5 | Compound 1 | 0.5 | Comp. |
| | compound 1 | | | | | | | |
| 1-28 | Comparative | 15 | −0.9 | A7 | 5 | Compound 1 | 1 | Comp. |
| | compound 3 | | | | | | | |
| 1-29 | Comparative | 15 | 9.16 | A7 | 5 | Compound 1 | 1 | Comp. |
| | compound 4 | | | | | | | |
| 1-30 | PFR | 15 | 9.15 | A2 | 5 | Comparative | 0.5 | Comp. |
| | | | | | | Compound 2 | | |

Inv.: Inventive
Comp.: Comparative

TABLE 2

| | Additive 2 | | Additive 3 | | Additive 4 | | |
|---|---|---|---|---|---|---|---|
| | | Adding | | Adding | | Adding | |
| | | amount | | amount | | amount | |
| Sample | | (Part by | | (Part by | | (Part by | |
| No. | Kind | weight) | Kind | weight) | Kind | weight) | Remarks |
| 1-1 | — | — | — | — | — | — | Inv. |
| 1-2 | — | — | — | — | — | — | Inv. |
| 1-3 | — | — | — | — | — | — | Inv. |
| 1-4 | — | — | — | — | — | — | Inv. |
| 1-5 | — | — | — | — | — | — | Inv. |
| 1-6 | — | — | — | — | — | — | Inv. |
| 1-7 | — | — | — | — | — | — | Inv. |
| 1-8 | — | — | — | — | — | — | Inv. |
| 1-9 | — | — | — | — | — | — | Inv. |
| 1-10 | — | — | — | — | — | — | Inv. |
| 1-11 | — | — | — | — | — | — | Inv. |
| 1-12 | — | — | — | — | — | — | Inv. |
| 1-13 | IRGANOX | 0.5 | — | — | — | — | Inv. |
| | 1010 | | | | | | |
| 1-14 | IRGANOX | 0.5 | Sumilizer | 3 | — | — | Inv. |
| | 1010 | | GP | | | | |
| 1-15 | IRGANOX | 0.5 | Sumilizer | 3 | — | — | Inv. |
| | 1010 | | GP | | | | |
| 1-16 | IRGANOX | 0.5 | — | — | — | — | Inv. |
| | 1010 | | | | | | |
| 1-17 | IRGANOX | 0.5 | Sumilizer | 3 | — | — | Inv. |
| | 1010 | | GP | | | | |
| 1-18 | IRGANOX | 0.5 | Sumilizer | 3 | — | — | Inv. |
| | 1010 | | GP | | | | |
| 1-19 | IRGANOX | 0.5 | Sumilizer | 3 | — | — | Inv. |
| | 1010 | | GP | | | | |
| 1-20 | IRGANOX | 0.5 | Sumilizer | 3 | EPON | 3 | Inv. |
| | 1010 | | GP | | 815C | | |
| 1-21 | IRGANOX | 0.5 | Sumilizer | 3 | Formula H | 3 | Inv. |
| | 1010 | | GP | | | | |
| 1-22 | — | — | — | — | — | — | Inv. |
| 1-23 | — | — | — | — | — | — | Inv. |
| 1-24 | — | — | — | — | — | — | Inv. |
| 1-25 | IRGANOX | 0.5 | Sumilizer | 3 | — | — | Inv. |
| | 1010 | | GP | | | | |
| 1-26 | — | — | — | — | — | — | Comp. |
| 1-27 | IRGANOX | 0.5 | Sumilizer | 3 | — | — | Comp. |
| | 1010 | | GP | | | | |
| 1-28 | — | — | — | — | — | — | Comp. |
| 1-29 | — | — | — | — | — | — | Comp. |
| 1-30 | IRGANOX | 0.5 | Sumilizer | 3 | — | — | Comp. |
| | 1010 | | GP | | | | |

Inv.: Inventive
Comp.: Comparative

### (Synthesis of Comparative Compound 1)

Comparative compound 1 was obtained in the same manner as in Synthesis example 4 except that acetylsalicyloyl chloride was replaced by p-toluoyl chloride. The molecular weight of this compound was 489.

### (Synthesis of Comparative Compound 3)

Into a mixture solution of 30 parts by weight of ethylene glycol, 101 parts by weight of triethylamine and 2,000 parts by weight of ethyl acetate, 270 parts by weight of 3,4-diacetoamidobenzoyl chloride was dropped spending 30 minutes at room temperature and then further stirred for 1 hour. The system was cooled by room temperature after completion of reaction and precipitated matter was removed by filtration. The filtrate was washed by adding ethyl acetate and purified water and the organic phase was separated and the ethyl acetate was distillated out under reduced pressure to obtain the objective compound. The molecular weight of this compound was 499.

### (Synthesis of Comparative Compound 4)

Into a mixture solution of 45 parts by weight of trimethylolpropane, 101 parts by weight of triethylamine and 2,000 parts by weight of ethyl acetate, 210 parts by weight of chloronaphthoic acid was dropped spending 30 minutes at room temperature and then further stirred for 1 hour. The system was cooled by room temperature after completion of reaction and precipitated matter was removed by filtration. The filtrate was washed by adding ethyl acetate and purified water and the organic phase was separated and the ethyl acetate was distillated out under reduced pressure to obtain the objective compound. The molecular weight of this compound was 597.

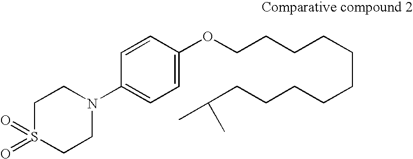

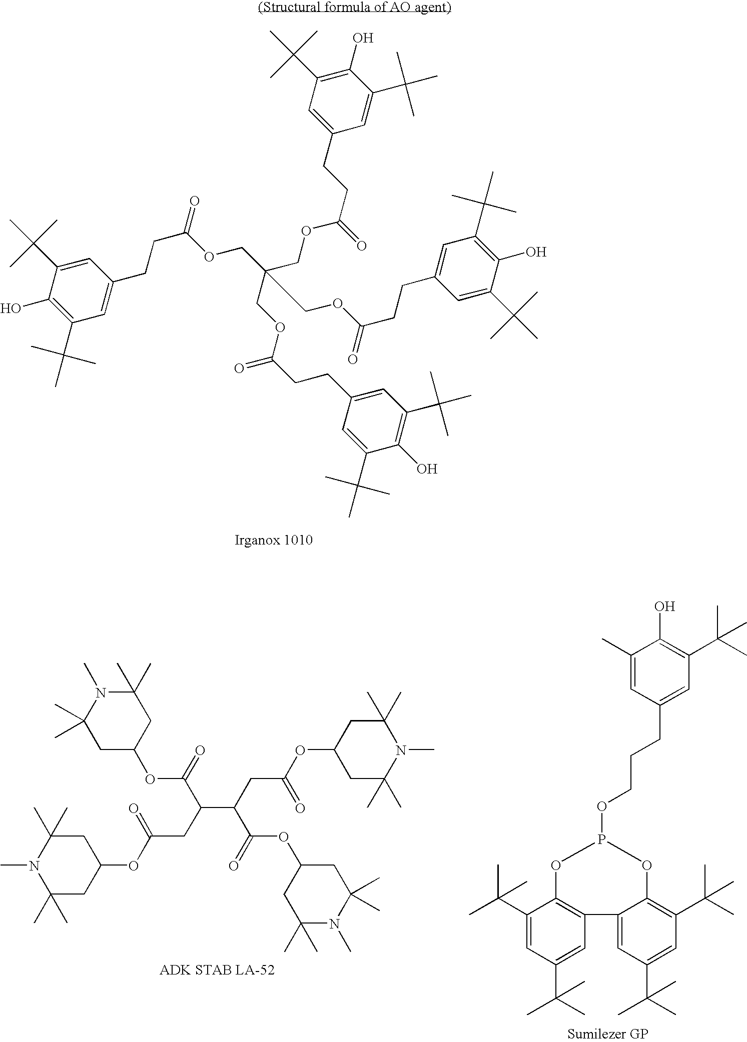

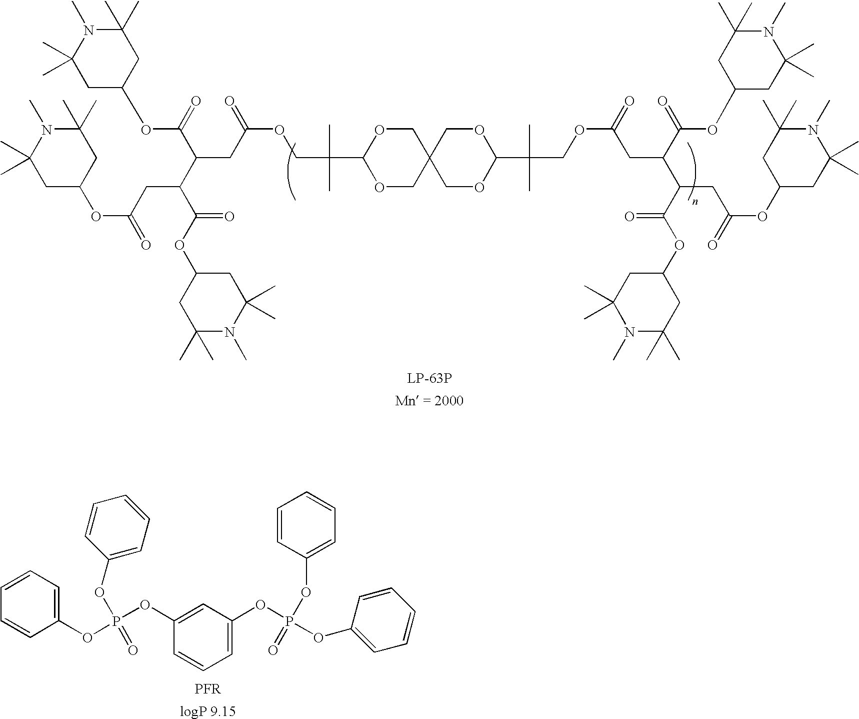

The obtained films were subjected to the following evaluations. Results are shown in Table 3.

### (Measurement of Yellowing Degree YI)

The spectral adsorption of the obtained cellulose ester film was measured by a spectral photometer U-3310, manufactured by Hitachi High-Technologies Corp., and trichromatic excitation coefficients X, Y and Z were calculated. The yellowing degree YI was calculated based on the trichromatic excitation coefficients X and Y and Z according to JIS-K7103 and the sample was ranked according to the following norms.

A: less than 0.8

B: 0.8 to 1.0

C, 1.0 to less than 1.3

D: not less than 1.3

### (Bright Spot Foreign Matter)

Two polarization plates were arranged in cross Nicols state so as to cut the penetration light and the sample was placed between the polarization plates. As the polarization plates, ones having a glass protection plate were used. Light was irradiated from one side of the above system and number of bright spot having a diameter of not less than 0.01 mm pre square centimeter was counted by an optical microscope (×50) observation from the other side.

Ranking was carried out according to the following norms.

A: 0 to 30

B: 31 to 60

C: 61 to 90

D: 91 or more

### (Evaluation of Flatness)

A sample having a length of 100 cm and a width of 40 cm was cut out at the time of 1 hour after starting of the melt-casting film formation.

A sheet of black paper was fixed on a flat desk and the above sample was places and irradiated by three fluorescent light tubes arranged in oblique upward direction. The flatness of the sample was evaluated according to the curved situation of the image of the fluorescent light tubes mirrored on the sample surface and ranked according to the following norms.

A: The three fluorescent tubes were seen straight.

B: The fluorescent tubes were seen in curved somewhere in some degree.

C: The fluorescent tubes were seen in curved state.

D: The fluorescent tubes were seen in largely wavy.

### (Dimensional Stability)

The dimensional stability was expressed by thermal shrinkage ratio. Three test pieces of having a width of 120 mm and a length of 30 mm were sampled in the casting direction and the direction crossing at right angle with the casting direction. Holes having a diameter of 6 mm were punched at the both end portions of the test piece so that the distance of the holes was 100 mm. The test piece was conditioned in a room at a temperature of 23±3° C. and a relative humidity of 65±5% for 3 hours or more. The original distance L1 between the punched holes was measured by an automatic pin gage, manufactured by Shinto Scientific Co., Ltd., by the minimum division of 1/1000 mm. Then the test piece was hung in a hydro-thermostat at 80° C. and 90% RH for 300 hour. After that the test piece was conditioned in was conditioned in a room at a temperature of 23±3° C. and a relative humidity of 65±5% for 3 hors or more and then the distance between the punched holes after the hydrothermal treatment L2 was measured by the automatic pin gage. The shrinkage ratio by the hydrothermal was calculated by the following expression.

Shrinkage ratio=|(L1−L2/L1)×100

Evaluation was carried out according to the following norms.

A: Thermal shrinkage was less than 0.5%.

B: 0.5 to 0.8%

C: 0.8 to 1.0%

D: More than 1.0%

TABLE 3

| | | Bright | | | |
|---|---|---|---|---|---|
| | | spot | | | |
| Sample | | foreign | | Dimensional | |
| No. | YI | matter | Flatness | stability | Remarks |
| 1-1 | B | B | B | B | Inv. |
| 1-2 | B | A | A | B | Inv. |
| 1-3 | B | A | A | B | Inv. |
| 1-4 | B | A | A | B | Inv. |
| 1-5 | B | A | A | B | Inv. |
| 1-6 | B | B | B | B | Inv. |
| 1-7 | B | A | A | B | Inv. |
| 1-8 | B | A | A | B | Inv. |
| 1-9 | B | A | A | B | Inv. |
| 1-10 | B | A | A | B | Inv. |
| 1-11 | B | A | A | B | Inv. |
| 1-12 | B | B | B | B | Inv. |
| 1-13 | B | A | A | B | Inv. |
| 1-14 | A | A | A | A | Inv. |
| 1-15 | A | A | A | A | Inv. |
| 1-16 | B | A | A | B | Inv. |
| 1-17 | A | A | A | B | Inv. |
| 1-18 | A | A | A | B | Inv. |
| 1-19 | A | A | A | B | Inv. |
| 1-20 | A | A | A | B | Inv. |
| 1-21 | A | A | A | B | Inv. |
| 1-22 | B | B | A | B | Inv. |
| 1-23 | B | B | B | B | Inv. |
| 1-24 | B | B | C | C | Inv. |
| 1-25 | B | B | B | C | Inv. |
| 1-26 | D | D | D | D | Comp. |
| 1-27 | C | D | D | D | Comp. |
| 1-28 | D | D | D | D | Comp. |
| 1-29 | D | D | D | D | Comp. |
| 1-30 | D | D | D | D | Comp. |
| 1-31 | B | B | B | D | Comp. |

Inv.: Inventive
Comp.: Comparative

As shown in the above, it was cleared that the inventive samples 1-1 to 1-25 are lower in the Y1, less in the bright spot defect, superior in the flatness and the dimensional stability compared with the comparative samples 1-26 to 1-31.

### (Preparation of Polarization Plate)

Poly(vinyl alcohol) having a thickness Of 120 μm was immersed in an aqueous solution containing 1 part by weight of iodine, 2 parts by weight of potassium iodide and 4 parts by weight of boric acid and stretched for 4 times at 50° C. to prepare a polarization element.

The samples 1-1 to 1-25 of the invention and the comparative samples 1-26 to 1-31 were alkaline surface treated at 40° C. for 60 sec by a 2.5M sodium hydroxide aqueous solution, and washed by water and dried.

The alkaline treated surface of each of the samples 1-1 to 1-25 of the invention and the comparative samples 1-26 to 1-31 were pasted on the both sided of the above obtained polarization element by using a 5% aqueous solution of completely saponified poly(vinyl alcohol) as adhesive to prepare polarization plates 1-1 to 1-25 of the invention and comparative samples 1-26 to 1-31 each having the protective film. The polarization plates 1-1 to 1-25 of the invention were suitable polarization palates which were optically and physically superior to those of the comparative samples 1-26 to 1-31.

### (Evaluation in Liquid Crystal Display State)

The polarization plate of a 15-type TFT type color liquid crystal display LA-1529, manufactured by NEC Corp., was peeled off and the above prepared polarization plates were each cut in a size meeting with the size of the liquid crystal cell. Two of the above polarization plates were each pasted on both sides of the liquid crystal cell so that the polarization axes are crossed at right angle the same as in the original state to prepare a 15-type TFT color liquid crystal display and the property of the cellulose ester film as the polarization plate. As the results of the evaluation, it was cleared that the polarization plates 1-1 to 1-25 of the invention were higher in the contrast and superior displaying ability compared with the comparative polarization plates 1-26 to 1-31. Consequently, it was confirmed that the polarization plates of the invention were excellent as the polarization plate for the image displaying apparatus such as the liquid crystal display.

### Example 2

Cellulose ester films were prepared in the same manner as in Example 1 except that the kind of the cellulose ester and the kind and adding amount of the additives were changed as described in Tables 4 and 5. Thus obtained samples were referred to as inventive samples 2-1 to 2-22 and comparative samples 2-23 to 2-25. The Y1, luminescent spot foreign material, flatness and dimensional stability were evaluated. Results are shown in table 6.

TABLE 4

| | | | Weight | |
|---|---|---|---|---|
| Kind of | | | average | |
| cellulose | Acetylation | Propionylation | molecular | |
| ester | degree | degree | weight | Mw/Mn |
| C-2 | 1.4 | 1.3 | 220,000 | 2.5 |
| C-3 | 1.3 | 1.2 | 180,000 | 3.0 |
| C-4 | 1.7 | 1.0 | 210,000 | 2.9 |
| C-5 | 1.2 | 1.1 | 210,000 | 2.5 |

TABLE 5

| | | Ester compound | | | Additive 1 | | Additive 2 | | Additive 3 | | |
|---|---|---|---|---|---|---|---|---|---|---|---|
| | | | Adding | | | Adding | | Adding | | Adding | |
| | | | amount | | | amount | | amount | | amount | |
| | Kind of | | (parts | Distribution | | (parts | | (parts | | (parts | |
| Sample | cellulose | | by | co- | | by | | by | | by | Re- |
| No. | ester | Kind | weight) | efficient | Kind | weight) | Kind | weight) | Kind | weight) | marks |
| 2-1 | C-2 | 1-83 | 8 | 6.16 | Irganox 1010 | 0.5 | GSY-P101 | 0.25 | — | — | Inv. |
| 2-2 | C-2 | 1-83 | 8 | 6.16 | Irganox 1010 | 0.5 | Sumilizer | 0.25 | F-108 | 0.3 | Inv. |
| | | | | | | | GP | | | | |
| 2-3 | C-2 | 1-83 | 8 | 6.16 | Irganox 1010 | 0.5 | GSY-P101 | 0.25 | F-103 | 0.3 | Inv. |
| 2-4 | C-2 | 1-83 | 8 | 6.16 | Irganox 1010 | 0.5 | GSY-P101 | 0.25 | F-108 | 0.3 | Inv. |
| 2-5 | C-2 | 1-83 | 8 | 6.16 | Irganox 1010 | 0.5 | GSY-P101 | 0.25 | F-138 | 0.3 | Inv. |
| 2-6 | C-2 | 1-83 | 8 | 6.16 | Irganox 1010 | 0.5 | GSY-P101 | 0.25 | F-145 | 0.3 | Inv. |
| 2-7 | C-2 | 1-83 | 8 | 6.16 | Irganox 1010 | 0.5 | Irgafos | 0.25 | F-108 | 0.3 | Inv. |
| | | | | | | | P-EPQ | | | | |
| 2-8 | C-2 | 1-83 | 8 | 6.16 | Irganox 1010 | 0.5 | GSY-P101 | 0.25 | E-16 | 0.3 | Inv. |
| 2-9 | C-2 | 1-83 | 8 | 6.16 | Irganox 1010 | 0.5 | GSY-P101 | 0.25 | E-1 | 0.3 | Inv. |
| 2-10 | C-2 | 1-83 | 8 | 6.16 | Irganox 1010 | 0.5 | GSY-P101 | 0.25 | E-7 | 0.3 | Inv. |
| 2-11 | C-2 | 1-81 | 8 | 5.03 | Irganox 1010 | 0.5 | GSY-P101 | 0.25 | F-108 | 0.3 | Inv. |
| 2-12 | C-2 | 1-81 | 8 | 5.03 | Irganox 1010 | 0.5 | GSY-P101 | 0.25 | E-16 | 0.3 | Inv. |
| 2-13 | C-2 | 1-85 | 8 | 4.68 | Irganox 1010 | 0.5 | GSY-P101 | 0.25 | F-108 | 0.3 | Inv. |
| 2-14 | C-2 | 1-85 | 8 | 4.68 | Irganox 1010 | 0.5 | GSY-P101 | 0.25 | E-16 | 0.3 | Inv. |
| 2-15 | C-2 | 1-87 | 8 | 6.11 | Irganox 1010 | 0.5 | GSY-P101 | 0.25 | E-16 | 0.3 | Inv. |
| 2-16 | C-3 | 1-81 | 8 | 5.03 | Irganox 1010 | 0.5 | GSY-P101 | 0.25 | F-108 | 0.3 | Inv. |
| 2-17 | C-3 | 1-81 | 8 | 5.03 | Irganox 1010 | 0.5 | GSY-P101 | 0.25 | E-16 | 0.3 | Inv. |
| 2-18 | C-4 | 1-81 | 8 | 5.03 | Irganox 1010 | 0.5 | GSY-P101 | 0.25 | F-108 | 0.3 | Inv. |
| 2-19 | C-4 | 1-81 | 8 | 5.03 | Irganox 1010 | 0.5 | GSY-P101 | 0.25 | E-16 | 0.3 | Inv. |
| 2-20 | C-5 | 1-81 | 8 | 5.03 | Irganox 1010 | 0.5 | GSY-P101 | 0.25 | F-103 | 0.3 | Inv. |
| 2-21 | C-1 | 1-83 | 8 | 6.16 | Irganox 1010 | 0.5 | GSY-P101 | 0.25 | F-108 | 0.3 | Inv. |
| 2-22 | C-1 | 1-83 | 8 | 6.16 | Irganox 1010 | 0.5 | GSY-P101 | 0.25 | E-16 | 0.3 | Inv. |
| 2-23 | C-2 | Comparative | 8 | 7.63 | Irganox 1010 | 0.5 | GSY-P101 | 0.25 | F-108 | 0.3 | Comp. |
| | | compound 1 | | | | | | | | | |
| 2-24 | C-2 | Comparative | 8 | −0.9 | Irganox 1010 | 0.5 | GSY-P101 | 0.25 | F-108 | 0.3 | Comp. |
| | | compound 3 | | | | | | | | | |
| 2-25 | C-2 | Comparative | 8 | 9.16 | Irganox 1010 | 0.5 | GSY-P101 | 0.25 | F-108 | 0.3 | Comp. |
| | | compound 4 | | | | | | | | | |

TABLE 6

| | | Bright | | | |
|---|---|---|---|---|---|
| | | spot | | | |
| Sample | | foreign | | Dimensional | |
| No. | YI | matter | Flatness | stability | Remarks |
| 2-1 | B | A | A | B | Inv. |
| 2-2 | A | A | B | B | Inv. |
| 2-3 | B | A | A | A | Inv. |
| 2-4 | A | A | A | A | Inv. |
| 2-5 | B | A | A | A | Inv. |
| 2-6 | B | A | A | A | Inv. |
| 2-7 | B | A | A | A | Inv. |
| 2-8 | A | A | A | A | Inv. |
| 2-9 | A | A | A | B | Inv. |
| 2-10 | A | A | A | B | Inv. |
| 2-11 | A | A | A | B | Inv. |
| 2-12 | A | A | A | A | Inv. |
| 2-13 | A | A | A | A | Inv. |
| 2-14 | A | A | A | A | Inv. |
| 2-15 | A | A | B | B | Inv. |
| 2-16 | A | A | A | A | Inv. |
| 2-17 | A | A | A | A | Inv. |
| 2-18 | A | A | A | A | Inv. |
| 2-19 | A | A | A | A | Inv. |
| 2-20 | A | B | B | B | Inv. |
| 2-21 | A | A | B | A | Inv. |
| 2-22 | A | A | B | A | Inv. |
| 2-23 | C | D | D | D | Comp. |
| 2-24 | D | D | D | D | Comp. |
| 2-25 | D | D | D | D | Comp. |

Inv.: Inventive
Comp.: Comparative

As is shown in the above table the results of Example 1 were reproduced, namely the samples 2-1 to 2-22 of the invention were low in Y1, reduced in the luminescent spot foreign material, excellent in the flatness and dimensional stability compared with the comparative samples 2-23 to 2-25.

Polarization plates were prepared in the same manner as in Example 1 and evaluated as the liquid crystal displaying apparatus.

The liquid crystal displays using the sample 2-1 to 2-22 of the invention were high in the contrast and excellent in the displaying properties. Thus it is confirmed that the samples were excellent as the polarization plate for the displaying apparatus such as the liquid crystal display.

1. A process for producing cellulose ester film comprising steps of;
melting a film forming material containing a cellulose ester and an ester compound which is formed by condensation of an organic acid represented by Formula 1 and a polyhydric alcohol and has a distribution coefficient of from 1 to 7.5, 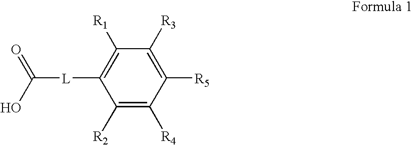
wherein R₁ to R₅ are each a hydrogen atom, an alkyl group, a cycloalkyl group, an aryl group, an aralkyl group, an alkoxy group, a cycloalkoxy group, an aryloxy group, an aralkyloxy group, an acyl group, a carbonyloxy group, an oxycarbonyl group or an oxycarbonyloxy group, which may further have a substituent; L is a bonding group of an unsubstituted or unsubstituted alkylene group, an oxygen atom or a direct bond; and
casting the film forming material into a state of film.

2. The process for producing cellulose ester film of claim 1, wherein the bonding group L is a direct bond.

3. The process for producing cellulose ester film of claim 1, wherein the polyhydric alcohol has 2 to 4 hydroxyl groups.

4. The process for producing cellulose ester film of claim 1, wherein a molecular weight of the ester compound formed by condensation of the organic acid represented by Formula 1 and the polyhydric alcohol is from 300 to 1500.

5. The process for producing cellulose ester film of claim 1, wherein at least one of R₁, R₂ and R₅ of the organic acid represented by Formula 1 is an alkoxy group, an acyl group, an oxycarbonyl group, a carbonyloxy group or an oxycarbonyl group.

6. The process for producing cellulose ester film of claim 1, wherein the film forming material contains at least one kind of polyester selected from aliphatic polyester and aliphatic-aromatic copolyester.

7. The process for producing cellulose ester film of claim 5, wherein the aliphatic polyester has at least one repeating unit selected from Repeating Unit (a) and Repeating Unit (b), 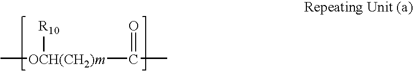
wherein m is an integer of from 0 to 10, R₁₀ is a hydrogen atom, at least one group selected from the group consisting of an unsubstituted alkyl group having 1 to 12 carbon atoms, an aryl group having 1 to 12 carbon atoms substituted by at least one substituent selected from an aryl group having 6 to 10 carbon atoms and an alkoxy group having 1 to 4 carbon atoms, an unsubstituted cycloalkyl group having 5 to 10 carbon atoms, and a cycloalkyl group having 5 to 10 carbon atoms substituted by at least one substituent selected from an aryl group having 6 to 10 carbon atoms and an alkoxy group having 1 to 4 carbon atoms, 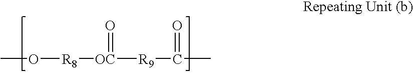
wherein R₈ is at least one group selected from the group consisting of an unsubstituted alkylene group having 2 to 12 carbon atoms, an alkylene group having 2 to 12 carbon atoms substituted by at least on substituent selected from an alkyl group having i to 4 carbon atoms and an alkoxy group having 1 to 4 carbon atoms, an unsubstituted oxyalkylene group, an oxyalkylene group substituted by at least one substituent selected from an aryl group having 6 to 10 carbon group and an alkoxy group having 1 to 4 carbon atoms, an unsubstituted cycloalkylene group having 5 to 10 carbon atoms, and a cycloalkylene group having 5 to 10 carbon atoms substituted by at least one substituent selected from an aryl group having 6 to 10 carbon atoms and an alkoxy group having 1 to 4 carbon atoms; R₉ is at least one group selected from the group consisting of an unsubstituted alkylene group having 2 to 12 carbon atoms, an alkylene group having 2 to 12 carbon atoms substituted by at least one substituent selected from an aryl group having 6 to 10 carbon atoms and an alkoxy group having 1 to 4 carbon atoms, an unsubstituted oxyalkylene group having 2 to 12 carbon atoms, an oxyalkylene group having 2 to 12 carbon atoms substituted by at least one substituent selected from an aryl group having 6 to 10 carbon atoms and an alkoxy group having 1 to 4 carbon atoms, an unsubstituted cycloalkylene group having 5 to 10 carbon atoms, and an cycloalkylene group having 5 to 10 carbon atoms substituted by at least one substituent selected from an aryl group having 6 to 10 carbon atoms and an alkoxy group having 1 to 4 carbon atoms.

8. The process for producing cellulose ester film of claim 6, wherein the aliphatic polyester is prepared from at least one kind of polyester formable substance selected from (i) a hydroxyl acid and a polyester formable derivative thereof, (ii) a dicarboxylic acid and a derivative thereof and (iii) a diol.

9. The process for producing cellulose ester film of claim 6, wherein the aliphatic-aromatic copolyester has Repeating Unit (c), 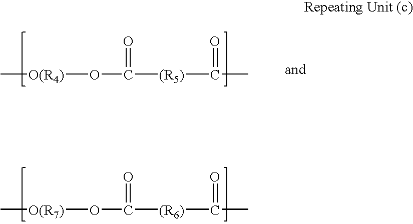
wherein R₄ and R₇ are each at least one group selected from the group consisting of an unsubstituted alkylene group having 2 to 12 carbon atoms, an alkylene group having 2 to 12 carbon atoms substituted by at least one substituent selected from an aryl group having 6 to 10 carbon atoms, an alkyl group having 1 to 4 carbon atoms and an alkoxy group having 1 to 4 carbon atoms, an unsubstituted oxyalkylene group having 2 to 12 carbon atoms, an oxyalkylene group having 1 to 4 carbon atoms substituted by at least one substituent selected from an aryl group having 6 to 10 carbon atoms and an alkoxy group having 1 to 4 carbon atoms, an unsubstituted cycloalkylene group having 5 to 10 carbon atoms, and a cycloalkylene group having 5 to 10 carbon atoms substituted by at least one substituent selected from an aryl group having 6 to 10 carbon atoms and an alkoxy group having 1 to 4 carbon atoms; R₅ is a group selected from the group consisting of an unsubstituted alkylene group having 1 to 12 carbon atoms, an alkylene group having 1 to 12 carbon atoms substituted by at least one substituent selected from an aryl group having 6 to 10 carbon atoms, an alkyl group having 1 to 4 carbon atoms and an alkoxy group having 1 to 4 carbon atoms, an unsubstituted oxyalkylene group having 2 to 12 carbon atoms, an oxyalkylene group having 2 to 12 carbon atoms substituted by at least one substituent selected from an aryl group having 6 to 10 carbon atoms and an alkoxy group having 1 to 4 carbon atoms, an unsubstituted cycloalkylene group having 5 to 10 carbon atoms, and a cycloalkylene group having 5 to 10 carbon atoms substituted by at least one substituent selected from an aryl group having 6 to 10 carbon atoms and an alkoxy group having 1 to 4 carbon atoms; and R₆ is at least one group selected from the group consisting of an unsubstituted arylene group having 6 to 10 carbon atoms and an arylene group having 6 to 10 carbon atoms substituted by at least one substituent selected from an alkyl group having 1 to 4 carbon atoms and an alkoxy group having 1 to 4 carbon atoms.

10. The process for producing cellulose ester film of claim 6, wherein the aliphatic-aromatic copolyester is prepared from at least one polyester formable compound selected from (i) dicarboxylic acid and its derivative and (ii) a diol.

11. The process for producing cellulose ester film of claim 1, wherein the film forming material contains at least one kind of antioxidant.

12. The process for producing cellulose ester film of claim 11, wherein at least one kind of hindered phenol type antioxidant or at least one kind of phosphor type antioxidant is contained.

13. The process for producing cellulose ester film of claim 12, wherein the phosphor type antioxidant is phosphonite type.

14. The process for producing cellulose ester film claim 11, wherein at least one kind of anti-thermal processing stabilizer.

15. The process for producing cellulose ester film of claim 14, wherein the anti-thermal processing stabilizer is a compound represented by Formula E or F, 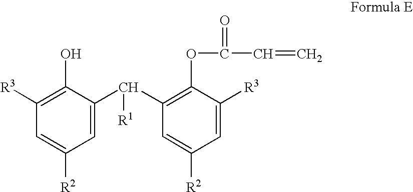
wherein R¹ is an alkyl group having 1 to 100 carbon atoms and R² and R³ are each independently an alkyl group having 1 to 8 carbon atoms, 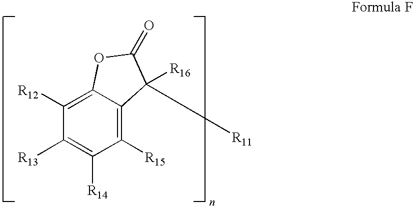
wherein R₁₂ to R₁₅ are each independently a hydrogen atom or a substituent, R₁₆ is a hydrogen atom or a substituent and n is an integer of 1 or 2, and R₁₁ is a substituent when n is 1, and R₁₁ is a di-valent bonding group when n is 2.

16. The process for producing cellulose ester film of claim 11, wherein at least one kind of the hindered phenol type antioxidant, at least one kind of the phosphor type antioxidant and at least one kind of the anti-thermal processing stabilizer are contained.

17. The process for producing cellulose ester film of claim 11, wherein the antioxidant is an antioxidant having a hindered phenol moiety and a hindered amine moiety.

18. The process for producing cellulose ester film of claim 11, wherein the compound having the phenol moiety and the hindered amine moiety is a hydroxybenzylmalonate derivative represented by the following Formula I or its acid additional salt, 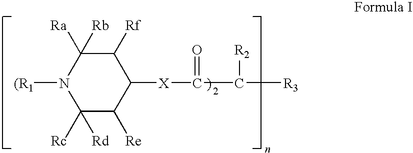
wherein n is an integer of 1 or 2, Ra, Rb and Rd are each an alkyl group having 1 to 6 carbon atoms, Rc is an alkyl group having 1 to 9 carbon atoms, Re is a hydrogen atom or an alkyl group having 1 to 5 carbon atoms and Rf is a hydrogen atom or an alkyl group having 1 to 5 carbon atoms, provided that Re and Rf are exchangeable each other, X is an —O— or an —NR— group in which R is a hydrogen atom or an alkyl group and R₁ is a hydrogen atom, an alkyl group having 1 to 12 carbon atoms, an alkenyl group having 3 or 4 carbon atoms or an A-CO— group in which A is an alkyl group having 1 to 12 carbon atoms;
R₂ is a hydroxybenzyl group represented by Formula II; 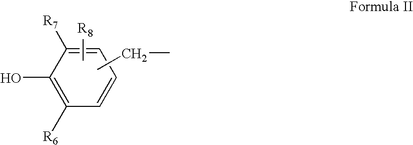
wherein R₆ and R₇ are each an alkyl group having 1 to 9 carbon atoms and R₈ is a hydrogen atom or a methyl group; when n is 1, R₃ is an unsubstituted alkyl group having 1 to carbon atoms, a —COOR₁₂ group, an —OCOR₁₃ or a —P(O)(R₁₄)₂ group, in which R₁₂ is an alkyl group having 1 to 18 carbon atoms or an alkyl group having 1 to 10 carbon atoms substituted by a group represented by Formula III and R₃ is an alkenyl group having 3 to 18 carbon atoms, an aralkyl group having 7 to 19 carbon atoms or a phenyl group, R₁₃ is a phenyl group which may be substituted by an unsubstituted alkyl group having 1 to 4 carbon atoms or a hydroxyl group and R₁₄ is an alkyl group having 1 to 8 carbon atoms, 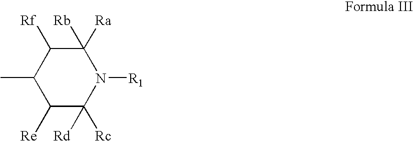
wherein R₁, Ra, Rb, Rc, Rd, Re and Rf are each the same as those in Formula I, respectively; and
R₃ is an —OCOR₁₆ group, in which R₁₆ is a phenyl group which may be substituted by an alkyl group having 1 to 12 carbon atoms, two alkyl groups each having 1 to 4 carbon atoms or a hydroxyl group, or an —NHCOR₁₆—, in which R₇₆ is an alkyl group having 1 to 12 carbon atoms, and R₃ is a bonding hand or an alkylene group having 1 to 20 carbon atoms when n is 2.

19. A cellulose ester film which is produced by the process for producing cellulose ester film of claim 1.

20. A polarization plate having the cellulose ester film described in claim 19.

21. A liquid crystal display using a polarization plate described in claim 20.
